(19) United States
(12) Patent Application Publication
(10) Pub. No.: US 2015/0244849 A1
(43) Pub. Date: Aug. 27, 2015

(54) APPARATUS AND METHOD FOR SCREENING, IDENTIFYING, REJECTING, AND/OR REPORTING, UNWANTED TELEPHONE CALLS, UNWANTED FACSIMILE TRANSMISSIONS, UNWANTED TEXT MESSAGES, UNWANTED SMS MESSAGES, UNWANTED MMS MESSAGES, AND/OR UNWANTED ELECTRONIC MAIL MESSAGES OR UNWANTED INSTANT MESSAGES, AND/OR OTHER UNWANTED COMMUNICATIONS

(71) Applicant: RAYMOND ANTHONY JOAO, YONKERS, NY (US)

(72) Inventor: RAYMOND ANTHONY JOAO, YONKERS, NY (US)

(21) Appl. No.: 14/606,859

(22) Filed: Jan. 27, 2015

Related U.S. Application Data
(60) Provisional application No. 61/943,688, filed on Feb. 24, 2014.

(51) Int. Cl. H04M 1/663; H04M 3/436; H04W 4/14; H04W 4/16

(52) U.S. Cl. CPC H04M 1/663; H04W 4/16; H04M 3/436; H04W 4/14

(57) ABSTRACT

An apparatus, including a receiver which receives information regarding an incoming telephone call, cellular call, fax transmission, text message, or e-mail message, and a processing device which processes information regarding the telephone call, cellular call, fax transmission, text message, or e-mail message, and identifies a telephone number associated with the telephone call, cellular call, fax transmission, or text message, as being allowed or rejected, or identifies an e-mail address associated with the e-mail message as being allowed or rejected. The apparatus allows the telephone call, cellular call, fax transmission, or text message, if the number is allowed, rejects same if the number is rejected, allows the e-mail message if the e-mail address is allowed, or rejects same if the e-mail address is rejected, and records or stores information regarding the telephone call, cellular call, fax transmission, text message, or e-mail message.

### RELATED APPLICATIONS

This application claims the benefit of the priority of U.S. Provisional Patent Application Ser. No. 61/943,688, filed Feb. 24, 2014, and entitled “APPARATUS AND METHOD FOR SCREENING, IDENTIFYING, REJECTING, AND/OR REPORTING, UNWANTED TELEPHONE CALLS, UNWANTED FACSIMILE TRANSMISSIONS, UNWANTED TEXT MESSAGES, UNWANTED SMS MESSAGES, UNWANTED MMS MESSAGES, AND/OR UNWANTED ELECTRONIC MAIL MESSAGES OR UNWANTED INSTANT MESSAGES, AND/OR OTHER UNWANTED COMMUNICATIONS”, the subject matter and teachings of which are hereby incorporated by reference herein in their entirety.

### FIELD OF THE INVENTION

The present invention pertains to an apparatus and method for screening, identifying, rejecting, and/or reporting, unwanted telephone calls, unwanted facsimile (fax) transmissions, unwanted text messages, unwanted SMS messages, unwanted MMS messages, and/or unwanted electronic mail (e-mail) messages or unwanted instant messages, and/or other unwanted communications, and, in particular, to an apparatus and method for screening, identifying, rejecting, and/or reporting, unwanted telephone calls, unwanted facsimile (fax) transmissions, unwanted text messages, unwanted SMS messages, unwanted MMS messages, and/or unwanted electronic mail (e-mail) messages or unwanted instant messages, which can also provide for enhanced features and devices for screening, identifying, rejecting, and/or reporting, unwanted telephone calls, unwanted facsimile (fax) transmissions, unwanted text messages, unwanted SMS messages, unwanted MMS messages, and/or unwanted electronic mail (e-mail) messages or unwanted instant messages, and/or other unwanted communications, and/or which can also provide a user, an individual, or an account holder, or any service provider or entity providing any type or kind of communications service to the user, individual, or account holder, with the ability to control, monitor, screen, identify, reject, or report, unwanted telephone calls, unwanted facsimile (fax) transmissions, unwanted text messages, unwanted SMS messages, unwanted MMS messages, and/or unwanted electronic mail (e-mail) messages or unwanted instant messages, and/or other unwanted communications.

### BACKGROUND OF THE INVENTION

Many individuals enjoy the conveniences of having a home telephone, a home facsimile (fax) machine, a cellular telephone, and/or a home computer. Along with the conveniences of having these devices and the services associated with same, and along with the costs for or associated with these devices and/or the services relating to same, many individuals experience the annoyances and disturbances of, and associated with, unwanted telephone calls, unwanted telemarketing calls, unwanted cellular telephone calls, unwanted and unsolicited fax transmissions, unwanted text messages, unwanted SMS messages, unwanted MMS messages, and/or unwanted e-mail messages or unwanted instant messages, which have come to be associated with these devices and services.

Along with being an annoyance, a disturbance, an inconvenience, and/or an unwelcome intrusion, at any time of day or night, unwanted telephone calls, unwanted telemarketing calls, unwanted cellular telephone calls, and/or unwanted and unsolicited fax transmissions, in addition to be a waste of an individual's time, can also tie up an individual's home telephone, telephone answering machine, or telephone answering service, or cellular telephone, or can also tie up, or deprive, an individual of the use of his or her home telephone, telephone answering machine, or telephone answering service, or cellular telephone, or fax machine. In the case of fax machines, unwanted fax transmissions can also tie up, or the deprive, an individual of the use of his or her fax machine as well as to deplete, or waste, the paper supply, ink supply, or toner supply, of the fax machine.

Along with being an annoyance, a disturbance, an inconvenience, and/or an unwelcome intrusion, at any time of day or night, unwanted cellular telephone calls, unwanted text messages, and/or unwanted SMS messages or unwanted MMS messages, to a cellular telephone or on or involving a cellular telephone account, can also be costly to an individual as these unwanted cellular telephone calls and messaging calls or communications can utilize costly cellular telephone call minutes, can incur text message charges or other messaging charges or costs, or SMS message charges or costs, or MMS message charges or costs, data usage charges or costs, or otherwise deplete an individual's calling minutes quotas, or deplete an individual's text message, SMS message, or MMS message quotas or data usage amounts.

Along with being an annoyance, a disturbance, an inconvenience, and/or an unwelcome intrusion, at any time of day or night, unwanted e-mail messages can also use up valuable memory or storage space in, or allocated to, an individual's e-mail account, can use up valuable storage space allocated to an individual's e-mail storage capacity, can cause the bouncing of e-mail messages when an individual's e-mail memory storage quota has been reached or is about to be reached, can cause clutter in an individual's e-mail In Box, and/or can result in a waste of an individual's time spent in sifting through, and deleting, unwanted e-mail messages.

As many individuals have learned, the so-called Do Not Call Lists simply have not worked in preventing unwanted telephone calls, unwanted telemarketing calls, unwanted cellular telephone calls, unwanted fax transmissions, and/or unwanted text messages, unwanted SMS messages, or unwanted MMS messages. Reporting violations is time consuming and simply does not work to free an individual of such unwanted calls and messaging. As many individuals have also learned, reporting e-mail messages as SPAM also does little to stop unwanted e-mail messages, even from e-mail messages previously identified and reported as SPAM.

Since various efforts like the so-called Do Not Call Lists and various anti-SPAM efforts have, for the large part, been unsuccessful in ridding individuals from these respective unwanted telephone calls, unwanted telemarketing calls, unwanted cellular telephone calls, unwanted and unsolicited fax transmissions, unwanted text messages, unwanted SMS messages, unwanted MMS messages, and/or unwanted e-mail messages or unwanted instant messages, there is a need for an apparatus and method which can allow an individual to screen, reject, and/or report, unwanted telephone calls, unwanted telemarketing calls, unwanted cellular telephone calls unwanted and unsolicited fax transmissions, unwanted text messages, unwanted SMS messages, unwanted MMS messages, and/or unwanted e-mail messages or unwanted instant messages, and/or any other unwanted communications.

### SUMMARY OF THE INVENTION

The present invention pertains to an apparatus and method for screening, identifying, rejecting, and/or reporting, unwanted telephone calls, unwanted facsimile (fax) transmissions, unwanted text messages, unwanted SMS messages, unwanted MMS messages, and/or unwanted electronic mail (e-mail) messages or unwanted instant messages, and/or other unwanted communications, and, in particular, to an apparatus and method for screening, identifying, rejecting, and/or reporting, unwanted telephone calls, unwanted facsimile (fax) transmissions, unwanted text messages, unwanted SMS messages, unwanted MMS messages, and/or unwanted electronic mail (e-mail) messages or unwanted instant messages, which can also provide for enhanced features and devices for screening, identifying, rejecting, and/or reporting, unwanted telephone calls, unwanted facsimile (fax) transmissions, unwanted text messages, unwanted SMS messages, unwanted MMS messages, and/or unwanted electronic mail (e-mail) messages or unwanted instant messages, and/or other unwanted communications, and/or which can also provide a user, an individual, or an account holder, or any service provider or entity providing any type or kind of communications service to the user, individual, or account holder, with the ability to control, monitor, screen, identify, reject, or report, unwanted telephone calls, unwanted facsimile (fax) transmissions, unwanted text messages, unwanted SMS messages, unwanted MMS messages, and/or unwanted electronic mail (e-mail) messages or unwanted instant messages, and/or other unwanted communications., which overcomes the shortcomings of the prior art.

The apparatus and method of the present invention can be utilized to control, monitor, screen, identify, reject, or report, unwanted telephone calls, unwanted facsimile (fax) transmissions, unwanted text messages, unwanted SMS messages, unwanted MMS messages, and/or unwanted electronic mail (e-mail) messages or unwanted instant messages, and/or other unwanted communications.

The apparatus and method of the present invention can be, or can provide, a telephone, a line-connected telephone, a home telephone or residential telephone, an office telephone or a telephone used for business purposes or commercial purposes, a cordless telephone, a cellular telephone, a wireless telephone, a smart phone, a Smartphone, a mobile telephone, a personal communications services (PCS) telephone, a personal digital assistant, a video telephone, a videophone, a digital telephone, a facsimile machine, a personal computer, a laptop computer, a notebook computer, a tablet, or a tablet computer, or a wearable communication device, a wearable computer, or any other type or kind of communication device, wireless communication device, cellular communication device, or mobile communication device, which can be utilized in order to, and/or which can process information regarding, and/or which can be designed, configured, adapted, and/or programmed, to control, monitor, screen, identify, reject, or report, unwanted telephone calls, unwanted facsimile (fax) transmissions, unwanted text messages, unwanted SMS messages, unwanted MMS messages, and/or unwanted electronic mail (e-mail) messages or unwanted instant messages, and/or other unwanted communications.

The apparatus and method of the present invention can be, or can provide, a central processing computer or any other type or kind of centralized processing computer system which can be utilized in order to, and/or which can process information regarding, and/or which can be designed, configured, adapted, and/or programmed, to control, monitor, screen, identify, reject, or report, unwanted telephone calls, unwanted facsimile (fax) transmissions, unwanted text messages, unwanted SMS messages, unwanted MMS messages, and/or unwanted electronic mail (e-mail) messages or unwanted instant messages, and/or other unwanted communications.

The apparatus and method of the present invention can also be, or can also provide, a telephone service provider computer or computer system, or a cellular communication service provider computer or computer system, or a wireless communication service provider computer or computer system, or a mobile communication service provider computer or computer system, or an Internet service provider computer or computer system, or an electronic mail or e-mail service provider computer, server computer, or computer system, or a cable television service provider computer or computer system, a cable television Internet service provider computer or computer system, or a cable television telephone service provider computer or computer system, or a satellite television service provider computer or computer system, a satellite television Internet service provider computer or computer system, or a satellite television telephone service provider computer or computer system, which can be utilized in order to, and/or which can process information regarding, and/or which can be designed, configured, adapted, and/or programmed, to control, monitor, screen, identify, reject, or report, unwanted telephone calls, unwanted facsimile (fax) transmissions, unwanted text messages, unwanted SMS messages, unwanted MMS messages, and/or unwanted electronic mail (e-mail) messages or unwanted instant messages, and/or other unwanted communications.

The apparatus of the present invention includes a central processing computer or central processing computer system. The central processing computer can be, or can include, any computer or system of computers, or a network computer or a server computer or any number of network computers or server computers. The central processing computer can provide control over the apparatus and can perform any of the various processing functions and/or functionality described herein. The central processing computer may be a single computer or a system of computers and/or may be or may include a plurality of computers or computer systems which are utilized in conjunction with one another. The central processing computer can provide or perform processing functionality for any of the other computers, computer systems, and/or communication devices, described herein as being used by or associated with any of the herein-described users, individuals, or account holders, who or which utilize the apparatus and method of the present invention, or any of the telephone service providers, cellular communication service providers, wireless communication service providers, e-mail service providers, cable television service providers, or satellite television services providers, who or which utilize the apparatus and method of the present invention.

The apparatus also includes a communication device which is, or can be, used by, or which is, or can be, associated with, any user, individual, or account holder, described herein who or which utilizes the apparatus and method of the present invention. The communication device can be a telephone, a line-connected telephone, a home telephone or residential telephone, an office telephone or a telephone used for business purposes or commercial purposes, a cordless telephone, a cellular telephone, a wireless telephone, a smart phone, a Smartphone, a mobile telephone, a personal communication device, a personal communications services (PCS) telephone, a personal digital assistant, a video telephone, a videophone, a digital telephone, a facsimile machine, a personal computer, a home computer, a laptop computer, a notebook computer, a hand-held computer, a palmtop computer, a tablet, or a tablet computer, a television, a digital television, an interactive television, a beeper, a pager, or a watch, or a wearable communication device, a wearable computer, or any other type or kind of communication device, wireless communication device, cellular communication device, mobile communication device, or any other device which can be utilized to allow any user, individual, or account holder, to engage in any type or kind of communication. The communication device can also be a server computer or a network computer.

Any number or amount of communication devices can be utilized by, or can be associated with, any user, individual, or account holder, who or which utilizes the apparatus and method of the present invention. The communication device(s) can communicate with, and can operate in conjunction with, the central processing computer and/or any of the other communication devices computers, and/or computer systems, described herein which can be associated with, or which can be used by, any of the users, individuals, account holders, or any of the telephone service providers, cellular communication service providers, wireless communication service providers, e-mail service providers, cable television service providers, or satellite television services providers, who or which utilize the apparatus and method of the present invention.

Any telephone service provider, cellular communication service provider, wireless communication service provider, e-mail service provider, cable television service provider, or satellite television services provider, or any agent or employee of same, can also be a user, an individual, or an account holder, as described herein.

The apparatus of the present invention can also include a telephone service provider computer or computer system which can be utilized by, or which can be associated with, any telephone service provider who or which utilizes the apparatus and method of the present invention. Any number or amount of telephone service provider computers can be used by, or can be associated with, any telephone service provider who or which utilizes the apparatus and method of the present invention. Any number of telephone service providers can utilize the apparatus and method of the present invention. The telephone service provider computer can be any computer or computer system, any server computer or server computer system, or any network computer or network computer system. The telephone service provider computer can also be, or can include, any of the herein-described communication devices described herein.

Any number or amount of telephone service provider computers can be utilized in connection with the apparatus of the present invention. Any number or amount of telephone service provider computers can also be utilized by, or can be associated with, any telephone service provider. The telephone service provider computer can communicate with, and can operate in conjunction with, the central processing computer and/or any of the communication devices, and/or any of the computers, and/or computer systems, described herein which can be associated with, or which can be used by, any of the users, individuals, and/or account holders, who or which utilize the apparatus and method of the present invention, and/or can communicate with, and can operate in conjunction with, any of the communication devices, computers, and/or computer systems, described herein which can be associated with, or which can be used by, any of the telephone service providers, cellular communication service providers, wireless communication service providers, Internet service providers, e-mail service providers, cable television service providers, or satellite television services providers, who or which utilize the apparatus and method of the present invention.

The apparatus of the present invention can also include a cellular or wireless communication service provider computer or computer system which can be utilized by, or which can be associated with, any cellular communication service provider or any wireless communication service provider who or which utilizes the apparatus and method of the present invention. Any number or amount of cellular/wireless service provider computers can be used by, or can be associated with, any cellular communication service provider or any wireless communication service provider who or which utilizes the apparatus and method of the present invention. Any number of cellular communication service providers or any number of wireless communication service providers can utilize the apparatus and method of the present invention. The cellular/wireless service provider computer can be any computer or computer system, any server computer or server computer system, or any network computer or network computer system. The cellular/wireless service provider computer can also be, or can include, any of the herein-described communication devices.

Any number or amount of cellular/wireless service provider computers can be utilized in connection with the apparatus of the present invention. Any number or amount of cellular/wireless service provider computers can also be utilized by, or can be associated with, any cellular communication service provider or any wireless communication service provider. The cellular/wireless service provider computer can communicate with, and can operate in conjunction with, the central processing computer and/or any of the communication devices, and/or any of the computers, and/or computer systems, described herein which can be associated with, or which can be used by, any of the users, individuals, and/or account holders, who or which utilize the apparatus and method of the present invention, and/or can communicate with, and can operate in conjunction with, any of the communication devices, computers, and/or computer systems, described herein which can be associated with, or which can be used by, any of the telephone service providers, cellular communication service providers, wireless communication service providers, Internet service providers, e-mail service providers, cable television service providers, or satellite television services providers, who or which utilize the apparatus and method of the present invention.

The apparatus can also include an Internet service provider or e-mail service provider computer or computer system which can be utilized by, or which can be associated with, any Internet service provider or e-mail service provider who or which utilizes the apparatus and method of the present invention. Any number or amount of e-mail service provider computers can be used by, or can be associated with, any Internet service provider or e-mail service provider who or which utilizes the apparatus and method of the present invention. Any number of Internet service providers or any number of e-mail service providers can utilize the apparatus and method of the present invention. The e-mail service provider computer can be any computer or computer system, any server computer or server computer system, or any network computer or network computer system. The e-mail service provider computer can also be, or can include, any of the herein-described communication devices.

Any number or amount of e-mail service provider computers can be utilized in connection with the apparatus of the present invention. Any number or amount of e-mail service provider computers can also be utilized by, or can be associated with, any Internet service provide or any e-mail service provider. The e-mail service provider computer can communicate with, and can operate in conjunction with, the central processing computer and/or any of the communication devices, and/or any of the computers, and/or computer systems, described herein which can be associated with, or which can be used by, any of the users, individuals, and/or account holders, who or which utilize the apparatus and method of the present invention, and/or can communicate with, and can operate in conjunction with, any of the communication devices, computers, and/or computer systems, described herein which can be associated with, or which can be used by, any of the telephone service providers, cellular communication service providers, wireless communication service providers, Internet service providers, e-mail service providers, cable television service providers, or satellite television services providers, who or which utilize the apparatus and method of the present invention.

The apparatus can also include a cable television service provider or satellite television service provider computer or computer system which can be utilized by, or which can be associated with, any cable television service provider or satellite television service provider who or which utilizes the apparatus and method of the present invention. Any number or amount of cable/satellite service provider computers can be used by, or can be associated with, any cable television service provider or satellite television service provider who or which utilizes the apparatus and method of the present invention. Any number of cable television service providers or satellite television service providers can utilize the apparatus and method of the present invention. The cable/satellite service provider computer can be any computer or computer system, any server computer or server computer system, or any network computer or network computer system. The cable/satellite service provider computer can also be, or can include, any of the herein-described communication devices.

Any number or amount of cable/satellite service provider computers can be utilized in connection with the apparatus of the present invention. Any number or amount of cable/satellite service provider computers can also be utilized by, or can be associated with, any cable television service provider or satellite television service provider. The cable/satellite service provider computer can communicate with, and can operate in conjunction with, the central processing computer and/or any of the communication devices, and/or any of the computers, and/or computer systems, described herein which can be associated with, or which can be used by, any of the users, individuals, and/or account holders, who or which utilize the apparatus and method of the present invention, and/or can communicate with, and can operate in conjunction with, any of the communication devices, computers, and/or computer systems, described herein which can be associated with, or which can be used by, any of the telephone service providers, cellular communication service providers, wireless communication service providers, Internet service providers, e-mail service providers, cable television service providers, or satellite television services providers, who or which utilize the apparatus and method of the present invention.

The apparatus can also include a governmental agency or law enforcement agency computer which can be associated with any governmental agency or law enforcement agency responsible for enforcing laws and/or regulations which prohibit or seek to prevent individuals or entities from making or sending unwanted calls, unwanted telephone calls, unwanted cellular telephone calls, unwanted fax transmissions, unwanted text messages, unwanted SMS messages, unwanted MMS messages, unwanted e-mail messages, unwanted instant messages, or any other unwanted communications, to users, individuals, or account holders, who do not want to receive same. For example, a governmental agency computer can be responsible for handing violations or prosecuting violations of a Federal or other political subdivision Do Not Call List(s), or any Do Not Fax List(s), Do Not Text List(s), and/or Do Not E-Mail List(s), or any other list(s) or listing(s) meant to protect users, individuals, or account holders, from being targets of, or from receiving, any of the herein-described unwanted calls, unwanted telephone calls, unwanted cellular telephone calls, unwanted fax transmissions, unwanted text messages, unwanted SMS messages, unwanted MMS messages, unwanted e-mail messages, unwanted instant messages, or any other unwanted communications. The governmental agency computer can be any computer, computer system, server computer, or network computer and can be connected to, or linked with, any of the central processing computers, communication devices, telephone service provider computers, cellular/wireless service provider computers, e-mail service provider computers, and/or cable/satellite service provider computers, described herein.

Each of the central processing computer(s), the communication device(s), the telephone service provider computer(s), the cellular/wireless service provider computer(s), the e-mail service provider computer(s), and/or the cable/satellite service provider computer(s), and/or the governmental agency computer(s), can transmit information to, as well as receive information from, any of the computers or communications devices described herein. In this regard, each of the computers or communications devices described herein can communicate with, process information from, and/or share data and/or information with, each other and/or any other computers or communications devices described herein and/or utilized in conjunction with the present invention. In this manner, data and/or information transfer between any of the computers or communications devices described herein, can be performed or effectuated with any other computers or communications devices in a bi-directional manner.

The central processing computer(s), the communication device(s), the telephone service provider computer(s), the cellular/wireless service provider computer(s), the e-mail service provider computer(s), and/or the cable/satellite service provider computer(s), and/or the governmental agency computer(s), can communicate with one another, and/or can be linked to one another, over a communication network, a telecommunication network, a telephone network, a line-connected network, a public switched telephone network, or the Internet and/or the World Wide Web, and/or a wireless communication network or a wireless Internet communication network. Each of the computers or communication devices described herein can be linked with any other computer or computers or communication device or communication devices directly or indirectly so as to facilitate a direct or indirect bi-directional communication with and between said respective computers or communication devices.

Communications between each of the computers or communication devices described herein can also involve an e-mail server or e-mail servers in those instances when e-mail messages are described as being used to transmit or to send any of the information, communications, signals, messages, reports, notification messages, alert messages, or any other communications, described herein, by or between any of the computers or communication devices described herein or when any of the information, communications, signals, messages, reports, notification messages, alert messages, or any other communications, described herein, are transmitted by and/or between any of the users, individuals, or account holders, or parties described herein and/or by or between any of the computers or communication devices or any other computers or communication devices, computer systems, communication network equipment, or server computers, or any other devices used or needed in order to facilitate communications or the transmission of any of the herein-described information, communications, signals, messages, reports, notification messages, alert messages, or any other communications.

Each of the central processing computer(s), the communication device(s), the telephone service provider computer(s), the cellular/wireless service provider computer(s), the e-mail service provider computer(s), and/or the cable/satellite service provider computer(s), and/or the governmental agency computer(s), can communicate in a bi-directional manner with, and/or can send and/or receive signals, messages, reports, notification messages, alert messages, or any other communications or electronic communication transmissions, to, from and/or between, any other, or any number of, other central processing computer(s), communication device(s), telephone service provider computer(s), the cellular/wireless service provider computer(s), the e-mail service provider computer(s), and/or the cable/satellite service provider computer(s), and/or the governmental agency computer(s).

Each of the central processing computer(s), the communication device(s), the telephone service provider computer(s), the cellular/wireless service provider computer(s), the e-mail service provider computer(s), and/or the cable/satellite service provider computer(s), and/or the governmental agency computer(s), can be linked to or with any other central processing computer(s), communication device(s), telephone service provider computer(s), cellular/wireless service provider computer(s), e-mail service provider computer(s), and/or cable/satellite service provider computer(s), and/or governmental agency computer(s), via a wired link or line or a wireless link.

Each of the communication device(s), telephone service provider computer(s), the cellular/wireless service provider computer(s), the e-mail service provider computer(s), and/or the cable/satellite service provider computer(s), and/or the governmental agency computer(s), can be connected with or linked with the central processing computer.

Any and/or all of the signals, communications, messages, reports, notification messages, alert messages, or any other communications, can be, or can be included in, or can be attached to, an e-mail message, a text message, an SMS message, an instant messaging message, an electronic transmission, or an electronic data transmission or electronic data interchange, or can be transmitted in, with, or via, any other data or information transmission, and/or can be transmitted via or using any appropriate or necessary computer(s) or device(s).

The present invention can be utilized on, and/or over, a telephone network, a public switched telephone network, a wireless communication network, the Internet and/or the World Wide Web, or a wireless Internet and/or World Wide Web network, or any combination of same. The present invention can also utilize wireless Internet and/or World Wide Web services, equipment and/or devices. The central processing computer(s) can have a web site or web sites associated therewith. Each of the other computers or communication devices described herein can also have a web site or web sites associated with same.

Although a telephone network, a public switched telephone network, a wireless communication network, the Internet and/or the World Wide Web, or a wireless Internet and/or World Wide Web network, or any combination of same, is a preferred communication system and/or medium, or combination of same, utilized, the present invention, in any and/or all of the embodiments described herein, can also be utilized with any appropriate communication network or system including, but not limited to, a communication network or system, a telecommunication network or system, a telephone communication network or system, a cellular communication network or system, a wireless communication network or system, a line or wired communication network or system, a wireless Internet network or system, a wireless World Wide Web network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, a cable television network or system, and/or any other communication network or system, and/or any combination of the above communication networks or systems.

Each of the central processing computer(s), the communication device(s), the telephone service provider computer(s), the cellular/wireless service provider computer(s), the e-mail service provider computer(s), or the cable/satellite service provider computer(s), and/or the governmental agency computer, can include a central processing unit or CPU, a random access memory device(s) (RAM), a read only memory device(s) (ROM), a user input device, a display device, a transmitter(s), a receiver(s), a database(s), an output device, a video and/or audio recording device(s), and, if needed or if applicable, any other device equipment or device equipment systems which are typically associated with the respective central processing computer, communication device, or the respective cellular/wireless service provider computer, the e-mail service provider computer, or the cable/satellite service provider computer(s).

The apparatus of the present invention can also utilize electronic commerce technologies and security methods, techniques and technologies, in any and/or all of the instances of data and/or information processing, and/or data and/or information transmission, described herein.

The apparatus and method of the present invention can be utilized to provide a communication device, which can be any type or kind of any of the communication devices described herein, or any other type or kind of communication device, which can be programmed to accept telephone calls or cellular telephone calls from allowed or accepted telephone numbers or from allowed or accepted cellular telephone numbers, or can be programmed to reject telephone calls or cellular telephone calls from unaccepted or rejected telephone numbers or from unaccepted or rejected cellular telephone numbers, or from unknown telephone numbers or unknown cellular telephone numbers, from unidentifiable telephone numbers or unidentifiable cellular telephone numbers, from private telephone numbers or private cellular telephone numbers, or from concealed, hidden, or disguised, telephone numbers or cellular telephone numbers, or can be programmed to receive, screen, and/or record, telephone calls or cellular telephone calls and associated messages from certain telephone numbers or cellular telephone numbers while suppressing or preventing the communication device from ringing, or can be programmed to generate a screened telephone call message playback report which can be provided or played back to a user, individual, or account holder, or can be programmed to generate a screened telephone call playback report notification message or alert message which can, but need not, contain information, a link, or a hyperlink, to the screened telephone call playback report, and can transmit same to any communication device used by or associated with the user, individual, or account holder, or can be programmed to allow a user, individual, or account holder, to select or designate certain of the telephone numbers or cellular telephone numbers from which messages are recorded which can or should be allowed or accepted or rejected in the future, or which can be programmed to allow a user, individual, or account holder, to revise, on the fly, and/or while listening to or reviewing the screened telephone call message playback report, the list of allowed or accepted telephone numbers or allowed or accepted cellular telephone number, or rejected telephone numbers or rejected cellular telephone numbers, from and via the screened telephone call message playback report.

The communication device can also be programmed to provide a listing of allowed or accepted telephone numbers or allowed or accepted cellular telephone numbers, and/or a list of rejected telephone numbers or rejected cellular telephone numbers, to the central processing computer, to any other communication device(s) of the user, individual, or account holder, and/or to any respective telephone service provider computer(s), cellular/wireless service provider computer(s), e-mail service provider computer(s), or cable/satellite service provider computer(s), or governmental agency computer(s). The communication device can also be programmed to generate respective complaint messages containing information for reporting Do Not Call List violations by calling parties and to transmit same to the central processing computer and/or to any respective telephone service provider computer(s), cellular/wireless service provider computer(s), e-mail service provider computer(s), or cable/satellite service provider computer(s), or governmental agency computer(s).

In another preferred embodiment, the apparatus and method of the present invention can be utilized to provide a communication device which can be programmed to accept fax calls and/or fax transmissions from allowed or accepted telephone numbers or allowed or accepted cellular telephone numbers, or can be programmed to reject fax calls and/or fax transmissions from unaccepted or rejected telephone numbers or from unaccepted or rejected cellular telephone numbers, from unknown fax telephone numbers, from unidentifiable fax telephone numbers, from private fax telephone numbers, or from concealed, hidden, or disguised, fax telephone numbers or cellular fax telephone numbers (“fax telephone numbers”), or can be programmed to receive, screen, and/or record, fax calls and/or fax transmissions and associated fax messages from certain fax telephone numbers while suppressing the communication device from ringing, or can be programmed to generate a screened fax transmission report which can be provided to a user, individual, or account holder, or can be programmed to generate a screened fax transmission report notification message or alert message which can, but need not, contain information, a link, or a hyperlink, to the screened fax transmission report, and can transmit same to any communication device used by or associated with the user, individual, or account holder, or can be programmed to allow a user, individual, or account holder, to select or designate fax telephone numbers from which fax transmissions can or should be allowed or accepted or rejected in the future, or which can be programmed to allow a user, individual, or account holder, to revise, on the fly, and/or while reviewing the screened fax transmission message report, the list of allowed or accepted fax telephone numbers or rejected fax telephone numbers from and via the screened fax transmission message report.

The communication device can also be programmed to provide a listing of allowed or accepted fax telephone numbers, and/or a list of rejected fax telephone numbers, to the central processing computer, to any other communication device(s) of the user, individual, or account holder, and/or to any respective telephone service provider computer(s), cellular/wireless service provider computer(s), e-mail service provider computer(s), or cable/satellite service provider computer(s), or governmental agency computer(s). The communication device can also be programmed to generate respective complaint messages containing information for reporting any Do Not Fax List violations by fax transmitting parties and to transmit same to the central processing computer and/or to any respective telephone service provider computer(s), cellular/wireless service provider computer(s), e-mail service provider computer(s), or cable/satellite service provider computer(s), or governmental agency computer(s).

In another preferred embodiment, the apparatus and method of the present invention can be utilized to provide a communication device which can be programmed to accept text messages, SMS messages, or MMS messages, or any other messages (also collectively referred to herein as a “text message” or “text messages”), from allowed or accepted telephone numbers or allowed or accepted cellular telephone numbers, or can be programmed to reject text messages from unaccepted or rejected telephone numbers, from unknown telephone numbers, from unidentifiable telephone numbers, from private telephone numbers, or from concealed, hidden, or disguised, telephone numbers, or can be programmed to receive, screen, and/or record, text messages from certain telephone numbers while suppressing the communication device from emitting a sound or from ringing, or can be programmed to generate a screened text message report which can be provided to a user, individual, or account holder, or can be programmed to generate a screened text message report notification message or alert message, which can, but need not, contain information, a link, or a hyperlink, to the screened text message report, and can transmit same to any communication device used by or associated with the user, individual, or account holder, or can be programmed to allow a user, individual, or account holder, to select or designate telephone numbers from which text messages can or should be allowed or accepted or rejected in the future, or which can be programmed to allow a user, individual, or account holder, to revise, on the fly, and/or while reviewing the screened text message report, the list of allowed or accepted telephone numbers or rejected telephone numbers from and via the screened text message report.

The communication device can also be programmed to provide a listing of allowed or accepted telephone numbers, and/or a list of rejected telephone numbers, to the central processing computer, to any other communication device(s) of the user, individual, or account holder, and/or to any respective telephone service provider computer(s), cellular/wireless service provider computer(s), e-mail service provider computer(s), or cable/satellite service provider computer(s), or governmental agency computer(s). The communication device can also be programmed to generate respective complaint messages containing information for reporting Do Not Text List violations by text message transmitting parties and to transmit same to the central processing computer and/or to any respective telephone service provider computer(s), cellular/wireless service provider computer(s), e-mail service provider computer(s), or cable/satellite service provider computer(s), or governmental agency computer(s).

The apparatus and method of the present invention can be utilized to provide a communication device which can be programmed to accept e-mail messages, instant messages, or messages transmitted from an IP address from allowed or accepted e-mail addresses or IP addresses, or can be programmed to reject, or automatically delete, e-mail messages from unaccepted or rejected e-mail addresses, from unknown e-mail addresses, from unidentifiable e-mail addresses, from private e-mail addresses, or from concealed, hidden, or disguised, e-mail addresses, or can be programmed to receive, screen, and/or record, e-mail addresses from certain e-mail addresses while suppressing same from entering the user's, the individual's, or the account holder's, e-mail In Box or while suppressing the communication device from emitting any sound or from proving any visual, audible, or other, indication, or can be programmed to generate a screened e-mail message report which can be provided to a user, individual, or account holder, or can be programmed to generate a screened e-mail message report notification message or alert message which can, but need not, contain information, a link, or a hyperlink, to the screened e-mail message report, and can transmit same to any communication device used by or associated with the user, individual, or account holder, or can be programmed to allow a user, individual, or account holder, to select or designate e-mail addresses or IP addresses from which e-mail messages can or should be allowed or accepted or rejected in the future, or which can be programmed to allow a user, individual, or account holder, to revise, on the fly, and/or while reviewing the screened e-mail message report, the list of allowed or accepted e-mail addresses or rejected e-mail addresses from and via the screened e-mail message report.

The communication device can also be programmed to provide a listing of allowed or accepted e-mail addresses and/or a list of rejected e-mail addresses or IP addresses, to the central processing computer, to any other communication device(s) of the user, individual, or account holder, and/or to any respective telephone service provider computer(s), cellular/wireless service provider computer(s), e-mail service provider computer(s), or cable/satellite service provider computer(s), or governmental agency computer(s). The communication device can also be programmed to generate respective complaint messages containing information for reporting Do Not E-Mail List violations by e-mail transmitting parties and to transmit same to the central processing computer and/or to any respective telephone service provider computer(s), cellular/wireless service provider computer(s), e-mail service provider computer(s), or cable/satellite service provider computer(s), or governmental agency computer(s).

The communication device can also be programmed to provide a listing of allowed or accepted telephone numbers, and/or a list of rejected telephone numbers, to the central processing computer, to any other communication device(s) of the user, individual, or account holder, and/or to any respective telephone service provider computer(s), cellular/wireless service provider computer(s), e-mail service provider computer(s), or cable/satellite service provider computer(s), or governmental agency computer(s). The communication device can also be programmed to generate respective complaint messages containing information for reporting Do Not Text List violations by text message transmitting parties and to transmit same to the central processing computer and/or to any respective telephone service provider computer(s), cellular/wireless service provider computer(s), e-mail service provider computer(s), or cable/satellite service provider computer(s), or governmental agency computer(s).

The apparatus and method of the present invention can be utilized to provide a communication device which can be programmed to accept e-mail messages, instant messages, or messages transmitted from an IP address from allowed or accepted e-mail addresses or IP addresses, or can be programmed to reject, or automatically delete, e-mail messages from unaccepted or rejected e-mail addresses, from unknown e-mail addresses, from unidentifiable e-mail addresses, from private e-mail addresses, or from concealed, hidden, or disguised, e-mail addresses, or can be programmed to receive, screen, and/or record, e-mail addresses from certain e-mail addresses while suppressing same from entering the user's, the individual's, or the account holder's, e-mail In Box or while suppressing the communication device from emitting any sound or from proving any visual, audible, or other, indication, or can be programmed to generate a screened e-mail message report which can be provided to a user, individual, or account holder, or can be programmed to generate a screened e-mail message report notification message or alert message which can, but need not, contain information, a link, or a hyperlink, to the screened e-mail message report, and can transmit same to any communication device used by or associated with the user, individual, or account holder, or can be programmed to allow a user, individual, or account holder, to select or designate e-mail addresses or IP addresses from which e-mail messages can or should be allowed or accepted or rejected in the future, or which can be programmed to allow a user, individual, or account holder, to revise, on the fly, and/or while reviewing the screened e-mail message report, the list of allowed or accepted e-mail addresses or rejected e-mail addresses from and via the screened e-mail message report.

The communication device can also be programmed to provide a listing of allowed or accepted e-mail addresses and/or a list of rejected e-mail addresses or IP addresses, to the central processing computer, to any other communication device(s) of the user, individual, or account holder, and/or to any respective telephone service provider computer(s), cellular/wireless service provider computer(s), e-mail service provider computer(s), or cable/satellite service provider computer(s), or governmental agency computer(s). The communication device can also be programmed to generate respective complaint messages containing information for reporting Do Not E-Mail List violations by e-mail transmitting parties and to transmit same to the central processing computer and/or to any respective telephone service provider computer(s), cellular/wireless service provider computer(s), e-mail service provider computer(s), or cable/satellite service provider computer(s), or governmental agency computer(s).

Any of the central processing computer(s), the telephone service provider computer(s), the cellular/wireless service provider computer(s), the e-mail service provider computer(s), and/or the cable/satellite service provider computer(s), can also be equipped, programmed, configured, or adapted, to operate to process information regarding, and/or to perform, any of the herein-described functions and/or functionality for or regarding, telephone calls, cellular telephone calls, wireless telephone calls, cellular communications, wireless communications, fax transmissions, text messages, SMS messages, MMS messages, e-mail messages or instant messages, or any other type or kind of messages or messaging or communications.

The central processing computer, or any respective telephone service provider computer(s), cellular/wireless service provider computer(s), e-mail service provider computer(s), or cable/satellite service provider computer(s), can also be programmed, by the user, the individual, the account holder, or any other authorized person, to allow telephone calls or cellular telephone calls from allowed or accepted telephone numbers or from allowed or accepted cellular telephone numbers, or can be programmed to reject telephone calls or cellular telephone calls from unaccepted or rejected telephone numbers or from unaccepted or rejected cellular telephone numbers, or from unknown telephone numbers or unknown cellular telephone numbers, from unidentifiable telephone numbers or unidentifiable cellular telephone numbers, from private telephone numbers or private cellular telephone numbers, or from concealed, hidden, or disguised, telephone numbers or cellular telephone numbers, or can be programmed to receive, screen, and/or record, telephone calls or cellular telephone calls and associated messages from certain telephone numbers or cellular telephone numbers while suppressing or preventing the telephone or the cellular telephone from ringing, or can be programmed to generate a screened telephone call message playback report which can be provided or played back to a user, individual, or account holder, or can be programmed to generate a screened telephone call playback report notification message or alert message which can, but need not, contain information, a link, or a hyperlink, to the screened telephone call playback report, and can transmit same to any communication device used by or associated with the user, individual, or account holder, or can be programmed to allow a user, individual, or account holder, to select or designate certain of the telephone numbers or cellular telephone numbers from which messages are recorded which can or should be allowed or accepted or rejected in the future, or which can be programmed to allow a user, individual, or account holder, to revise, on the fly, and/or while listening to or reviewing the screened telephone call message playback report, the list of allowed or accepted telephone numbers or allowed or accepted cellular telephone number, or rejected telephone numbers or rejected cellular telephone numbers, from and via the screened telephone call message playback report.

The central processing computer, or any respective telephone service provider computer(s), cellular/wireless service provider computer(s), e-mail service provider computer(s), or cable/satellite service provider computer(s), can also be programmed, by the user, the individual, the account holder, or any other authorized person, to maintain and/or provide a listing of allowed or accepted telephone numbers or allowed or accepted cellular telephone numbers, and/or a list of rejected telephone numbers or rejected cellular telephone numbers, for and/or to any central processing computer, any communication device(s) of the user, individual, or account holder, and/or any respective telephone service provider computer(s), cellular/wireless service provider computer(s), e-mail service provider computer(s), or cable/satellite service provider computer(s), or governmental agency computer(s).

The central processing computer, or any respective telephone service provider computer(s), cellular/wireless service provider computer(s), e-mail service provider computer(s), or cable/satellite service provider computer(s), can also be programmed, by the user, the individual, the account holder, or any other authorized person, to generate respective complaint messages containing information for reporting Do Not Call List violations by calling parties and to transmit same to any central processing computer, and/or to any respective telephone service provider computer(s), cellular/wireless service provider computer(s), e-mail service provider computer(s), or cable/satellite service provider computer(s), or governmental agency computer(s).

The central processing computer, or any respective telephone service provider computer(s), cellular/wireless service provider computer(s), e-mail service provider computer(s), or cable/satellite service provider computer(s), can be programmed, by the user, the individual, the account holder, or any other authorized person, to allow fax calls and/or fax transmissions from allowed or accepted telephone numbers or allowed or accepted cellular telephone numbers, or can be programmed to reject fax calls and/or fax transmissions from unaccepted or rejected telephone numbers or from unaccepted or rejected cellular telephone numbers, from unknown fax telephone numbers, from unidentifiable fax telephone numbers, from private fax telephone numbers, or from concealed, hidden, or disguised, fax telephone numbers or cellular fax telephone numbers, or can be programmed to receive, screen, and/or record, fax calls and/or fax transmissions and associated fax messages from certain fax telephone numbers while suppressing the fax machine from ringing, or can be programmed to generate a screened fax transmission report which can be provided to a user, individual, or account holder, or can be programmed to generate a screened fax transmission report notification message or alert message which can, but need not, contain information, a link, or a hyperlink, to the screened fax transmission report, and can transmit same to any communication device used by or associated with the user, individual, or account holder, or can be programmed to allow a user, individual, or account holder, to select or designate fax telephone numbers from which fax transmissions can or should be allowed or accepted or rejected in the future, or which can be programmed to allow a user, individual, or account holder, to revise, on the fly, and/or while reviewing the screened fax transmission message report, the list of allowed or accepted fax telephone numbers or rejected fax telephone numbers from and via the screened fax transmission message report.

The central processing computer, or any respective telephone service provider computer(s), cellular/wireless service provider computer(s), e-mail service provider computer(s), or cable/satellite service provider computer(s), can also be programmed, by the user, the individual, the account holder, or any other authorized person, to maintain or provide a listing of allowed or accepted fax telephone numbers, and/or a list of rejected fax telephone numbers, for and/or to the central processing computer, to any communication device(s) of the user, individual, or account holder, and/or to any respective telephone service provider computer(s), cellular/wireless service provider computer(s), e-mail service provider computer(s), or cable/satellite service provider computer(s), or governmental agency computer(s). The central processing computer, or any respective telephone service provider computer(s), cellular/wireless service provider computer(s), e-mail service provider computer(s), or cable/satellite service provider computer(s), can also be programmed to generate respective complaint messages containing information for reporting any Do Not Fax List violations by fax transmitting parties and to transmit same to any central processing computer and/or to any respective telephone service provider computer(s), cellular/wireless service provider computer(s), e-mail service provider computer(s), or cable/satellite service provider computer(s), or governmental agency computer(s).

The central processing computer, or any respective telephone service provider computer(s), cellular/wireless service provider computer(s), e-mail service provider computer(s), or cable/satellite service provider computer(s), can also be programmed to allow text messages or SMS messages, or MMS messages, or other messages (also collectively referred to a “text messages”), from allowed or accepted telephone numbers or allowed or accepted cellular telephone numbers, or can be programmed to reject text messages from unaccepted or rejected telephone numbers, from unknown telephone numbers, from unidentifiable telephone numbers, from private telephone numbers, or from concealed, hidden, or disguised, telephone numbers, or can be programmed to receive, screen, and/or record, text messages from certain telephone numbers while suppressing the cellular telephone, the wireless telephone, the smart phone, the Smartphone, the respective cellular communication device, wireless communication device, or personal digital assistant, from emitting a sound or from ringing, or can be programmed to generate a screened text message report which can be provided to a user, individual, or account holder, or can be programmed to generate a screened text message report notification message or alert message, which can, but need not, contain information, a link, or a hyperlink, to the screened text message report, and can transmit same to any communication device used by or associated with the user, individual, or account holder, or can be programmed to allow a user, individual, or account holder, to select or designate telephone numbers from which text messages can or should be allowed or accepted or rejected in the future, or which can be programmed to allow a user, individual, or account holder, to revise, on the fly, and/or while reviewing the screened text message report, the list of allowed or accepted telephone numbers or rejected telephone numbers from and via the screened text message report.

The central processing computer, or any respective telephone service provider computer(s), cellular/wireless service provider computer(s), e-mail service provider computer(s), or cable/satellite service provider computer(s), can also be programmed to provide a listing of allowed or accepted telephone numbers, and/or a list of rejected telephone numbers, to any central processing computer, to any other communication device(s) of the user, individual, or account holder, and/or to any respective telephone service provider computer(s), cellular/wireless service provider computer(s), e-mail service provider computer(s), or cable/satellite service provider computer(s), or governmental agency computer(s). The central processing computer, or any respective telephone service provider computer(s), cellular/wireless service provider computer(s), e-mail service provider computer(s), or cable/satellite service provider computer(s), can also be programmed to generate respective complaint messages containing information for reporting Do Not Text List violations by text message transmitting parties and to transmit same to any central processing computer and/or to any respective telephone service provider computer(s), cellular/wireless service provider computer(s), e-mail service provider computer(s), or cable/satellite service provider computer(s), or governmental agency computer(s).

The central processing computer or any respective telephone service provider computer(s), cellular/wireless service provider computer(s), e-mail service provider computer(s), or cable/satellite service provider computer(s), can also be programmed to allow e-mail messages or messages transmitted from an IP address from allowed or accepted e-mail addresses or IP addresses, or can be programmed to reject, or automatically delete, e-mail messages from unaccepted or rejected e-mail addresses, from unknown e-mail addresses, from unidentifiable e-mail addresses, from private e-mail addresses, or from concealed, hidden, or disguised, e-mail addresses, or can be programmed to receive, screen, and/or record, e-mail addresses from certain e-mail addresses while suppressing same from entering the user's, the individual's, or the account holder's, e-mail In Box or while suppressing any respective communication device from emitting any sound or from proving any visual, audible, or other, indication, or can be programmed to generate a screened e-mail message report which can be provided to a user, individual, or account holder, or can be programmed to generate a screened e-mail message report notification message or alert message which can, but need not, contain information, a link, or a hyperlink, to the screened e-mail message report, and can transmit same to any communication device used by or associated with the user, individual, or account holder, or can be programmed to allow a user, individual, or account holder, to select or designate e-mail addresses or IP addresses from which e-mail messages can or should be allowed or accepted or rejected in the future, or which can be programmed to allow a user, individual, or account holder, to revise, on the fly, and/or while reviewing the screened e-mail message report, the list of allowed or accepted e-mail addresses or rejected e-mail addresses from and via the screened e-mail message report.

The central processing computer, or any respective telephone service provider computer(s), cellular/wireless service provider computer(s), e-mail service provider computer(s), or cable/satellite service provider computer(s), can also be programmed to provide a listing of allowed or accepted e-mail addresses and/or a list of rejected e-mail addresses, to any central processing computer, to any communication device(s) of the user, individual, or account holder, and/or to any respective telephone service provider computer(s), cellular/wireless service provider computer(s), e-mail service provider computer(s), or cable/satellite service provider computer(s), or governmental agency computer(s). The central processing computer, or any respective telephone service provider computer(s), cellular/wireless service provider computer(s), e-mail service provider computer(s), or cable/satellite service provider computer(s), can also be programmed to generate respective complaint messages containing information for reporting Do Not E-Mail List violations by e-mail transmitting parties and to transmit same to any central processing computer and/or to any respective telephone service provider computer(s), cellular/wireless service provider computer(s), e-mail service provider computer(s), or cable/satellite service provider computer(s), or governmental agency computer(s).

Any and/or all of the various messages, reports, notification messages, or alert messages, or any of the messages or reports described herein as being generated or provided by the apparatus of the present invention, or the central processing computer(s), or any of the telephone service provider computer(s), cellular/wireless service provider computer(s), e-mail service provider computer(s), or cable/satellite service provider computer(s), can contain or include marketing information, marketing materials, or advertisements.

In any and/or all of the embodiments described herein, any user, individual, or account holder, can select or designate any telephone number, cellular telephone number, e-mail address, or IP address, or any other source of any communication, as being an allowed telephone number, cellular telephone number, e-mail address, or IP address, or any other source of any communication, or as being an accepted allowed telephone number, cellular telephone number, e-mail address, or IP address, or any other source of any communication. In any and/or all of the embodiments described herein, any an allowed telephone number, cellular telephone number, e-mail address, or IP address, or any other source of any communication, or any accepted allowed telephone number, cellular telephone number, e-mail address, or IP address, or any other source of any communication can also be of, from, or associated with, an individual, an entity, a company, an advertiser, a marketing entity, any merchant or provider of any goods, products, or services, who or which agrees to pay compensation of any type or kind to the user, the individual, or the account holder, in exchange for the user, individual, or account holder, agreeing to receive any of the herein-described communications, to telephone calls, cellular telephone calls, wireless telephone calls, facsimile (fax) transmissions, text messages, SMS messages, MMS messages, electronic mail (e-mail) messages, instant messages or any other conveyances of data or information, from same. In a preferred embodiment, the compensation can be a cash compensation, a monetary compensation, a credit amount, a debit amount, a coupon, or a discount, or any amount, type, or kind.

The apparatus and method of the present invention can be utilized as a personal communication screening service or as a personal communication answering or communication receiving service which an perform any of the herein-described functions and functionality, described herein as being provided by the apparatus of the present invention, for any of the herein-described users, individuals, or account holders.

In another preferred embodiment, as well as any and/or all of the embodiments described herein, any of the herein-described communication device(s), telephone service provider computer(s), cellular/wireless service provider computer(s), e-mail service provider computer(s), or cable/satellite service provider computer(s), can be programmed and/or adapted to perform any and/or all of the functions and/or functionality described herein as being performed by the central processing computer.

In another preferred embodiment, as well as any and/or all of the embodiments described herein, any of the herein-described communication device(s), central processing computer(s), telephone service provider computer(s), cellular/wireless service provider computer(s), e-mail service provider computer(s), or cable/satellite service provider computer(s), which store e-mail messages or which store e-mail In Boxes for any of the herein-described users, individuals, or account holders, can be programmed to automatically delete e-mail messages from e-mail addresses which have been designated as rejected e-mail addresses at pre-selected time intervals or upon the e-mail memory storage usage reaching a pre-selected level.

Any of the herein-described communication devices can be programmed with software programs, software algorithms, software applications, or software “apps”, for enabling the respective communication device to perform any and/or all of the functions or functionality described herein as being performed by the communications devices described herein.

Any of the herein-described central processing computer(s), or any of the telephone service provider computer(s), cellular/wireless service provider computer(s), e-mail service provider computer(s), or cable/satellite service provider computer(s), can be programmed with software programs, software algorithms, software applications, or software “apps”, for enabling the respective central processing computer(s), telephone service provider computer(s), cellular/wireless service provider computer(s), e-mail service provider computer(s), or cable/satellite service provider computer(s), to perform any and/or all of the functions or functionality described herein as being performed by the respective central processing computer(s), telephone service provider computer(s), cellular/wireless service provider computer(s), e-mail service provider computer(s), or cable/satellite service provider computer(s), described herein.

### BRIEF DESCRIPTION OF THE DRAWINGS

In The Drawings:

FIG. 1 illustrates a preferred embodiment of the apparatus of the present invention, in block diagram form;

FIG. 2 illustrates the central processing computer of FIG. 1, in block diagram form;

FIG. 3 illustrates the communication device of FIG. 1, in block diagram form;

FIG. 4 illustrates the telephone service provider computer of FIG. 1, in block diagram form;

FIG. 5 illustrates the cellular/wireless service provider computer of FIG. 1, in block diagram form;

FIG. 6 illustrates the e-mail service provider computer of FIG. 1, in block diagram form;

FIG. 7 illustrates the cable/satellite service provider computer of FIG. 1, in block diagram form;

FIGS. 8A and 8B illustrate a preferred embodiment method of utilizing the apparatus of the present invention, in flow diagram form;

FIGS. 9A and 9B illustrate another preferred embodiment method of utilizing the apparatus of the present invention, in flow diagram form;

FIGS. 10A and 10B illustrate yet another preferred embodiment method of utilizing the apparatus of the present invention, in flow diagram form;

FIGS. 11A and 11B illustrate still another preferred embodiment method of utilizing the apparatus of the present invention, in flow diagram form;

FIGS. 12A and 12B illustrate another preferred embodiment method of using the apparatus of the present invention, in flow diagram form;

FIGS. 13A and 13B illustrate still another preferred embodiment method for utilizing the apparatus of the present invention, in flow diagram form;

FIGS. 14A and 14B illustrate yet another preferred embodiment method of using the apparatus of the present invention, in flow diagram form; and

FIGS. 15A and 15B illustrate still another preferred embodiment method for utilizing the apparatus of the present invention, in flow diagram form.

### DESCRIPTION OF THE PREFERRED EMBODIMENTS

The present invention pertains to an apparatus and method for screening, identifying, rejecting, and/or reporting, unwanted telephone calls, unwanted facsimile (fax) transmissions, unwanted text messages, unwanted SMS messages, unwanted MMS messages, and/or unwanted electronic mail (e-mail) messages or unwanted instant messages, and/or other unwanted communications, and, in particular, to an apparatus and method for screening, identifying, rejecting, and/or reporting, unwanted telephone calls, unwanted facsimile (fax) transmissions, unwanted text messages, unwanted SMS messages, unwanted MMS messages, and/or unwanted electronic mail (e-mail) messages or unwanted instant messages, which can also provide for enhanced features and devices for screening, identifying, rejecting, and/or reporting, unwanted telephone calls, unwanted facsimile (fax) transmissions, unwanted text messages, unwanted SMS messages, unwanted MMS messages, and/or unwanted electronic mail (e-mail) messages or unwanted instant messages, and/or other unwanted communications, and/or which can also provide a user, an individual, or an account holder, or any service provider or entity providing any type or kind of communications service to the user, individual, or account holder, with the ability to control, monitor, screen, identify, reject, or report, unwanted telephone calls, unwanted facsimile (fax) transmissions, unwanted text messages, unwanted SMS messages, unwanted MMS messages, and/or unwanted electronic mail (e-mail) messages or unwanted instant messages, and/or other unwanted communications.

The apparatus and method of the present invention can be utilized to control, monitor, screen, identify, reject, or report, unwanted telephone calls, unwanted cellular telephone calls, unwanted wireless telephone calls, unwanted facsimile (fax) transmissions, unwanted text messages, unwanted SMS messages, unwanted MMS messages, and/or unwanted electronic mail (e-mail) messages or unwanted instant messages, and/or other unwanted communications.

As defined herein, the term “communication” means or refers to a telephone call, a cellular telephone call, a wireless telephone call, a facsimile (fax) transmission, a text message, an SMS message, an MMS message, an electronic mail (e-mail) message, an instant message, or any other conveyance of data or information of any type or kind.

As defined herein, the term “communications” means or refers to telephone calls, cellular telephone calls, wireless telephone calls, facsimile (fax) transmissions, text messages, SMS messages, MMS messages, electronic mail (e-mail) messages, instant messages or any other conveyances of data or information of any type or kind.

In a preferred embodiment, the apparatus and method of the present invention can be, or can provide, a telephone, a line-connected telephone, a home telephone or residential telephone, an office telephone or a telephone used for business purposes or commercial purposes, a cordless telephone, a cellular telephone, a wireless telephone, a smart phone, a Smartphone, a mobile telephone, a personal communications services (PCS) telephone, a personal digital assistant, a video telephone, a videophone, a digital telephone, a facsimile machine, a personal computer, a laptop computer, a notebook computer, a tablet, or a tablet computer, or a wearable communication device, a wearable computer, or any other type or kind of communication device, wireless communication device, cellular communication device, or mobile communication device, which can be utilized in order to, and/or which can process information regarding, and/or which can be designed, configured, adapted, and/or programmed, to control, monitor, screen, identify, reject, or report, unwanted telephone calls, unwanted facsimile (fax) transmissions, unwanted text messages, unwanted SMS messages, unwanted MMS messages, and/or unwanted electronic mail (e-mail) messages or unwanted instant messages, and/or other unwanted communications.

In another preferred embodiment, the apparatus and method of the present invention can be, or can provide, a central processing computer or any other type or kind of centralized processing computer system which can be utilized in order to, and/or which can process information regarding, and/or which can be designed, configured, adapted, and/or programmed, to control, monitor, screen, identify, reject, or report, unwanted telephone calls, unwanted facsimile (fax) transmissions, unwanted text messages, unwanted SMS messages, unwanted MMS messages, and/or unwanted electronic mail (e-mail) messages or unwanted instant messages, and/or other unwanted communications.

In another preferred embodiment, the apparatus and method of the present invention can be, or can provide, a telephone service provider computer or computer system, or a cellular communication service provider computer or computer system, or a wireless communication service provider computer or computer system, or a mobile communication service provider computer or computer system, or an Internet service provider computer or computer system, or an electronic mail or e-mail service provider computer, server computer, or computer system, or a cable television service provider computer or computer system, a cable television Internet service provider computer or computer system, or a cable television telephone service provider computer or computer system, or a satellite television service provider computer or computer system, or a satellite television Internet service provider computer or computer system, or a satellite television telephone service provider computer or computer system, which can be utilized in order to, and/or which can process information regarding, and/or which can be designed, configured, adapted, and/or programmed, to control, monitor, screen, identify, reject, or report, unwanted telephone calls, unwanted facsimile (fax) transmissions, unwanted text messages, unwanted SMS messages, unwanted MMS messages, and/or unwanted electronic mail (e-mail) messages or unwanted instant messages, and/or other unwanted communications.

As used herein, the term “communication device”, or the plural of same, means or refers to a telephone, a line-connected telephone, a home telephone or residential telephone, an office telephone or a telephone used for business purposes or commercial purposes, a cordless telephone, a cellular telephone, a wireless telephone, a smart phone, a Smartphone, a mobile telephone, a personal communications services (PCS) telephone, a personal digital assistant, a video telephone, a videophone, a digital telephone, a facsimile machine, a personal computer, a laptop computer, a notebook computer, a tablet, or a tablet computer, or a wearable communication device, a wearable computer, or any other type or kind of communication device, wireless communication device, cellular communication device, or mobile communication device, or any other device which can be utilized to allow any user, individual, or account holder, to engage in any type or kind of communication.

Applicant hereby incorporates by reference herein the subject matter and teachings of U.S. Provisional Patent Application Ser. No. 61/943,688, filed Feb. 24, 2014, and entitled “APPARATUS AND METHOD FOR SCREENING, IDENTIFYING, REJECTING, AND/OR REPORTING, UNWANTED TELEPHONE CALLS, UNWANTED FACSIMILE TRANSMISSIONS, UNWANTED TEXT MESSAGES, UNWANTED SMS MESSAGES, UNWANTED MMS MESSAGES, AND/OR UNWANTED ELECTRONIC MAIL MESSAGES OR UNWANTED INSTANT MESSAGES, AND/OR OTHER UNWANTED COMMUNICATIONS”, the subject matter and teachings of which are hereby incorporated by reference herein in their entirety.

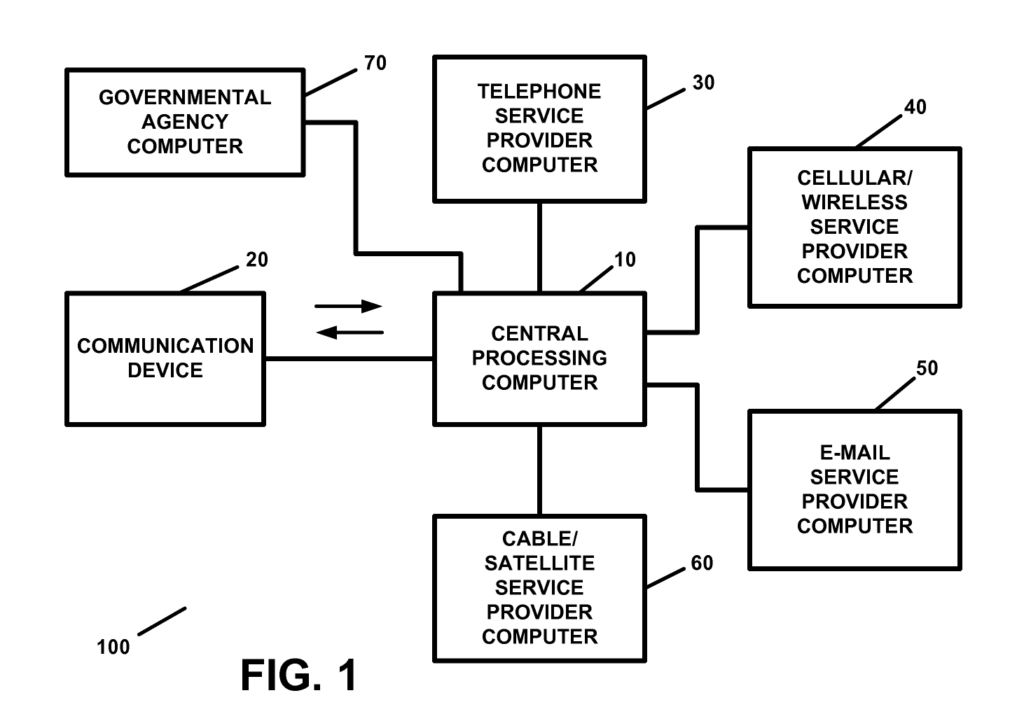

FIG. 1 illustrates a preferred embodiment of the apparatus of the present invention, in block diagram form. The apparatus of the present invention is denoted generally by the reference numeral 100. In the preferred embodiment, the apparatus 100 of the present invention includes a central processing computer or central processing computer system 10 (hereinafter referred to as the “central processing computer 10”). In the preferred embodiment, the central processing computer 10 can be, or can include, any computer or system of computers, or a network computer or a server computer or any number of network computers or server computers.

In the preferred embodiment, the central processing computer 10 can provide control over the apparatus 100 and can perform any of the various processing functions and/or functionality described herein. The central processing computer 10 may be a single computer or a system of computers and/or may be or may include a plurality of computers or computer systems which are utilized in conjunction with one another. The central processing computer 10, in the preferred embodiment, can provide or perform processing functionality for any of the other computers, computer systems, and/or communication devices, described herein as being used by or associated with any of the herein-described users, individuals, or account holders, who or which utilize the apparatus 100 and method of the present invention, or any of the telephone service providers, cellular communication service providers, wireless communication service providers, e-mail service providers, cable television service providers, or satellite television services providers, who or which utilize the apparatus 100 and method of the present invention.

The apparatus 100 also includes a communication device 20 which is, or can be, used by, or which is, or can be, associated with, any user, individual, or account holder, described herein who or which utilizes the apparatus 100 and method of the present invention. In a preferred embodiment, the communication device 20 can be a telephone, a line-connected telephone, a home telephone or residential telephone, an office telephone or a telephone used for business purposes or commercial purposes, a cordless telephone, a cellular telephone, a wireless telephone, a smart phone, a Smartphone, a mobile telephone, a personal communication device, a personal communications services (PCS) telephone, a personal digital assistant, a video telephone, a videophone, a digital telephone, a facsimile machine, a personal computer, a home computer, a laptop computer, a notebook computer, a hand-held computer, a palmtop computer, a tablet, or a tablet computer, a television, a digital television, an interactive television, a beeper, a pager, or a watch, or a wearable communication device, a wearable computer, or any other type or kind of communication device, wireless communication device, cellular communication device, mobile communication device, or any other device which can be utilized to allow any user, individual, or account holder, to engage in any type or kind of communication. In another preferred embodiment, the communication device 20 can also be a server computer or a network computer.

Any number or amount of communication devices 20 can be utilized by, or can be associated with, any user, individual, or account holder, who or which utilizes the apparatus 100 and method of the present invention. The communication device(s) 20 can communicate with, and can operate in conjunction with, the central processing computer 10 and/or any of the other communication devices 20, computers, and/or computer systems, described herein which can be associated with, or which can be used by, any of the users, individuals, account holders, or any of the telephone service providers, cellular communication service providers, wireless communication service providers, e-mail service providers, cable television service providers, or satellite television services providers, who or which utilize the apparatus 100 and method of the present invention.

In a preferred embodiment, any telephone service provider, cellular communication service provider, wireless communication service provider, e-mail service provider, cable television service provider, or satellite television services provider, or any agent or employee of same, can also be a user, an individual, or an account holder, as described herein.

The apparatus 100 can also include a telephone service provider computer or computer system 30 (hereinafter “telephone service provider computer 30”) which can be utilized by, or which can be associated with, any telephone service provider who or which utilizes the apparatus 100 and method of the present invention. Any number or amount of telephone service provider computers 30 can be used by, or can be associated with, any telephone service provider who or which utilizes the apparatus 100 and method of the present invention. Any number of telephone service providers can utilize the apparatus 100 and method of the present invention. In a preferred embodiment, the telephone service provider computer 30 can be any computer or computer system, any server computer or server computer system, or any network computer or network computer system. In a preferred embodiment, the telephone service provider computer 30 can also be, or can include, any of the herein-described communication devices described herein as being a communication device 20.

Any number or amount of telephone service provider computers 30 can be utilized in connection with the apparatus 100 of the present invention. Any number or amount of telephone service provider computers 30 can also be utilized by, or can be associated with, any telephone service provider. The telephone service provider computer 30 can communicate with, and can operate in conjunction with, the central processing computer 10 and/or any of the communication devices 20, and/or any of the computers, and/or computer systems, described herein which can be associated with, or which can be used by, any of the users, individuals, and/or account holders, who or which utilize the apparatus 100 and method of the present invention, and/or can communicate with, and can operate in conjunction with, any of the communication devices, computers, and/or computer systems, described herein which can be associated with, or which can be used by, any of the telephone service providers, cellular communication service providers, wireless communication service providers, Internet service providers, e-mail service providers, cable television service providers, or satellite television services providers, who or which utilize the apparatus 100 and method of the present invention.

The apparatus 100 can also include a cellular or wireless communication service provider computer or computer system 40 (hereinafter “cellular/wireless service provider computer 40”) which can be utilized by, or which can be associated with, any cellular communication service provider or any wireless communication service provider who or which utilizes the apparatus 100 and method of the present invention. Any number or amount of cellular/wireless service provider computers 40 can be used by, or can be associated with, any cellular communication service provider or any wireless communication service provider who or which utilizes the apparatus 100 and method of the present invention. Any number of cellular communication service providers or any number of wireless communication service providers can utilize the apparatus 100 and method of the present invention. In a preferred embodiment, the cellular/wireless service provider computer 40 can be any computer or computer system, any server computer or server computer system, or any network computer or network computer system. In a preferred embodiment, the cellular/wireless service provider computer 40 can also be, or can include, any of the herein-described communication devices described herein as being a communication device 20.

Any number or amount of cellular/wireless service provider computers 40 can be utilized in connection with the apparatus 100 of the present invention. Any number or amount of cellular/wireless service provider computers 40 can also be utilized by, or can be associated with, any cellular communication service provider or any wireless communication service provider. The cellular/wireless service provider computer 40 can communicate with, and can operate in conjunction with, the central processing computer 10 and/or any of the communication devices 20, and/or any of the computers, and/or computer systems, described herein which can be associated with, or which can be used by, any of the users, individuals, and/or account holders, who or which utilize the apparatus 100 and method of the present invention, and/or can communicate with, and can operate in conjunction with, any of the communication devices, computers, and/or computer systems, described herein which can be associated with, or which can be used by, any of the telephone service providers, cellular communication service providers, wireless communication service providers, Internet service providers, e-mail service providers, cable television service providers, or satellite television services providers, who or which utilize the apparatus 100 and method of the present invention.

The apparatus 100 can also include an Internet service provider or e-mail service provider computer or computer system 50 (hereinafter “e-mail service provider computer 50”) which can be utilized by, or which can be associated with, any Internet service provider or e-mail service provider who or which utilizes the apparatus 100 and method of the present invention. Any number or amount of e-mail service provider computers 50 can be used by, or can be associated with, any Internet service provider or e-mail service provider who or which utilizes the apparatus 100 and method of the present invention. Any number of Internet service providers or any number of e-mail service providers can utilize the apparatus 100 and method of the present invention. In a preferred embodiment, the e-mail service provider computer 50 can be any computer or computer system, any server computer or server computer system, or any network computer or network computer system. In a preferred embodiment, the e-mail service provider computer 50 can also be, or can include, any of the herein-described communication devices described herein as being a communication device 20.

Any number or amount of e-mail service provider computers 50 can be utilized in connection with the apparatus 100 of the present invention. Any number or amount of e-mail service provider computers 50 can also be utilized by, or can be associated with, any Internet service provide or any e-mail service provider. The e-mail service provider computer 50 can communicate with, and can operate in conjunction with, the central processing computer 10 and/or any of the communication devices 20, and/or any of the computers, and/or computer systems, described herein which can be associated with, or which can be used by, any of the users, individuals, and/or account holders, who or which utilize the apparatus 100 and method of the present invention, and/or can communicate with, and can operate in conjunction with, any of the communication devices, computers, and/or computer systems, described herein which can be associated with, or which can be used by, any of the telephone service providers, cellular communication service providers, wireless communication service providers, Internet service providers, e-mail service providers, cable television service providers, or satellite television services providers, who or which utilize the apparatus 100 and method of the present invention.

The apparatus 100 can also include a cable television service provider or satellite television service provider computer or computer system 60 (hereinafter “cable/satellite service provider computer 60”) which can be utilized by, or which can be associated with, any cable television service provider or satellite television service provider who or which utilizes the apparatus 100 and method of the present invention. Any number or amount of cable/satellite service provider computers 60 can be used by, or can be associated with, any cable television service provider or satellite television service provider who or which utilizes the apparatus 100 and method of the present invention. Any number of cable television service providers or satellite television service providers can utilize the apparatus 100 and method of the present invention. In a preferred embodiment, the cable/satellite service provider computer 60 can be any computer or computer system, any server computer or server computer system, or any network computer or network computer system. In a preferred embodiment, the cable/satellite service provider computer 60 can also be, or can include, any of the herein-described communication devices described herein as being a communication device 20.

Any number or amount of cable/satellite service provider computers 60 can be utilized in connection with the apparatus 100 of the present invention. Any number or amount of cable/satellite service provider computers 60 can also be utilized by, or can be associated with, any cable television service provider or satellite television service provider. The cable/satellite service provider computer 60 can communicate with, and can operate in conjunction with, the central processing computer 10 and/or any of the communication devices 20, and/or any of the computers, and/or computer systems, described herein which can be associated with, or which can be used by, any of the users, individuals, and/or account holders, who or which utilize the apparatus 100 and method of the present invention, and/or can communicate with, and can operate in conjunction with, any of the communication devices, computers, and/or computer systems, described herein which can be associated with, or which can be used by, any of the telephone service providers, cellular communication service providers, wireless communication service providers, Internet service providers, e-mail service providers, cable television service providers, or satellite television services providers, who or which utilize the apparatus 100 and method of the present invention.

The apparatus 100 can also include a governmental agency or law enforcement agency computer 70 (hereinafter “governmental agency computer 70”) which can be associated with any governmental agency or law enforcement agency responsible for enforcing laws and/or regulations which prohibit or seek to prevent individuals or entities from making or sending unwanted calls, unwanted telephone calls, unwanted cellular telephone calls, unwanted fax transmissions, unwanted text messages, unwanted SMS messages, unwanted MMS messages, unwanted e-mail messages, unwanted instant messages, or any other unwanted communications, to users, individuals, or account holders who do not want to receive same. For example, a governmental agency computer 70 can be responsible for handing violations or prosecuting violations of a Federal or other political subdivision Do Not Call List(s), or any Do Not Fax List(s), Do Not Text List(s), and/or Do Not E-Mail List(s), or any other list(s) or listing(s) meant to protect or shield users, individuals, or account holders, from being targets of, or from receiving, any of the herein-described unwanted calls, unwanted telephone calls, unwanted cellular telephone calls, unwanted fax transmissions, unwanted text messages, unwanted SMS messages, unwanted MMS messages, unwanted e-mail messages, unwanted instant messages, or any other unwanted communications.

The governmental agency computer 70 can be any computer, computer system, server computer, or network computer 70 and can be connected to or linked with any of the central processing computers 10, communication devices 20, telephone service provider computers 30, cellular/wireless service provider computers 40, e-mail service provider computers 50, and/or cable/satellite service provider computers 60, described herein.

In the preferred embodiment, any of the telephone service provider computer(s) 30, the cellular/wireless service provider computer(s) 40, the e-mail service provider computer(s) 50, and/or the cable/satellite service provider computer(s) 60, and/or the governmental agency computer(s) 70, can be also be, or can include, any of the devices described herein as being a communication device 20.

Each of the central processing computer(s) 10, the communication device(s) 20, the telephone service provider computer(s) 30, the cellular/wireless service provider computer(s) 40, the e-mail service provider computer(s) 50, and/or the cable/satellite service provider computer(s) 60, and/or the governmental agency computer(s) 70, can transmit information to, as well as receive information from, any of the computers or communications devices 10, 20, 30, 40, 50, 60, and 70, described herein. In this regard, each of the computers or communications devices 10, 20, 30, 40, 50, 60, and/or 70, can communicate with, process information from, and/or share data and/or information with, each other and/or any other computers or communications devices 10, 20, 30, 40, 50, 60, and/or 70, described herein and/or utilized in conjunction with the present invention. In this manner, data and/or information transfer between any of the computers or communications devices 10, 20, 30, 40, 50, 60, and 70, can be performed or effectuated with any other computers or communications devices 10, 20, 30, 40, 50, 60, and/or 70, in a bi-directional manner.

In a preferred embodiment, the central processing computer(s) 10, the communication device(s) 20, the telephone service provider computer(s) 30, the cellular/wireless service provider computer(s) 40, the e-mail service provider computer(s) 50, and/or the cable/satellite service provider computer(s) 60, and/or the governmental agency computer(s) 70, can communicate with one another, and/or can be linked to one another, over a communication network, a telecommunication network, a telephone network, a line-connected network, a public switched telephone network, or the Internet and/or the World Wide Web, and/or a wireless communication network or a wireless Internet communication network. Each of the computers or communication devices 10, 20, 30, 40, 50, 60, and/or 70, can be linked with any other computer or computers or communication device or communication devices directly or indirectly so as to facilitate a direct or indirect bi-directional communication with and between said respective computers or communication devices.

Communications between each of the computers or communication devices 10, 20, 30, 40, 50, 60, and 70, can also involve an e-mail server or e-mail servers in those instances when e-mail messages are described as being used to transmit or to send any of the information, communications, signals, messages, reports, notification messages, alert messages, or any other communications, described herein, by or between any of the computers or communication devices 10, 20, 30, 40, 50, 60, or 70, or when any of the information, communications, signals, messages, reports, notification messages, alert messages, or any other communications, described herein, are transmitted by and/or between any of the users, individuals, or account holders, or parties described herein and/or by or between any of the computers or communication devices 10, 20, 30, 40, 50, 60, or 70, or any other computers or communication devices, computer systems, communication network equipment, or server computers, etc., or any other devices used or needed in order to facilitate communications or the transmission of any of the herein-described information, communications, signals, messages, reports, notification messages, alert messages, or any other communications.

In a preferred embodiment, each of the central processing computer(s) 10, the communication device(s) 20, the telephone service provider computer(s) 30, the cellular/wireless service provider computer(s) 40, the e-mail service provider computer(s) 50, and/or the cable/satellite service provider computer(s) 60, and/or the governmental agency computer(s) 70, can communicate in a bi-directional manner with, and/or can send and/or receive signals, messages, reports, notification messages, alert messages, or any other communications or electronic communication transmissions, to, from and/or between, any other, or any number of, other central processing computer(s) 10, if utilized, communication device(s) 20, telephone service provider computer(s) 30, the cellular/wireless service provider computer(s) 40, the e-mail service provider computer(s) 50, and/or the cable/satellite service provider computer(s) 60, and/or the governmental agency computer(s) 70.

In a preferred, each of the central processing computer(s) 10, the communication device(s) 20, the telephone service provider computer(s) 30, the cellular/wireless service provider computer(s) 40, the e-mail service provider computer(s) 50, and/or the cable/satellite service provider computer(s) 60, and/or the governmental agency computer(s) 70, can be linked to or with any other central processing computer(s) 10, if utilized, communication device(s) 20, the telephone service provider computer(s) 30, the cellular/wireless service provider computer(s) 40, the e-mail service provider computer(s) 50, and/or the cable/satellite service provider computer(s) 60, and/or the governmental agency computer(s) 70, via a wired link or line or a wireless link.

In a preferred embodiment, each of the communication device(s) 20, telephone service provider computer(s) 30, the cellular/wireless service provider computer(s) 40, the e-mail service provider computer(s) 50, and/or the cable/satellite service provider computer(s) 60, and/or the governmental agency computer(s) 70, can be connected with or linked with the central processing computer 10 as shown in FIG. 1.

In a preferred embodiment, any and/or all of the signals, communications, messages, reports, notification messages, alert messages, or any other communications, described herein as being transmitted from one device, computer, or communication device, to another, can be, or can be included in, or can be attached to, an e-mail message, a text message, an SMS message, an MMS message, an instant messaging message, an electronic transmission, or an electronic data transmission or electronic data interchange, or can be transmitted in, with, or via, any other data or information transmission, and/or can be transmitted via or using any appropriate or necessary computer(s) or device(s).

In the preferred embodiment, the present invention is utilized on, and/or over, a telephone network, a public switched telephone network, a wireless communication network, the Internet and/or the World Wide Web, or a wireless Internet and/or World Wide Web network, or any combination of same. The present invention, in the preferred embodiment, can also utilize wireless Internet and/or World Wide Web services, equipment and/or devices. The central processing computer(s) 10, in the preferred embodiment, has a web site or web sites associated therewith. Each of the other computers or communication devices 20, 30, 40, 50, 60, and/or 70, described herein can also have a web site or web sites associated with same.

Although a telephone network, a public switched telephone network, a wireless communication network, the Internet and/or the World Wide Web, or a wireless Internet and/or World Wide Web network, or any combination of same, is a preferred communication system and/or medium, or combination of same, utilized, the present invention, in any and/or all of the embodiments described herein, can also be utilized with any appropriate communication network or system including, but not limited to, a communication network or system, a telecommunication network or system, a telephone communication network or system, a cellular communication network or system, a wireless communication network or system, a line or wired communication network or system, a wireless Internet network or system, a wireless World Wide Web network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, a cable television network or system, and/or any other communication network or system, and/or any combination of the above communication networks or systems.

In the preferred embodiment, each of the central processing computer(s) 10, the communication device(s) 20, the telephone service provider computer(s) 30, the cellular/wireless service provider computer(s) 40, the e-mail service provider computer(s) 50, and/or the cable/satellite service provider computer(s) 60, and/or the governmental agency computer(s) 70, can transmit data and/or information using TCP/IP, as well as any other Internet and/or World Wide Web, and/or communication, protocols.

The apparatus 100 of the present invention can also utilize electronic commerce technologies and security methods, techniques and technologies, in any and/or all of the instances of data and/or information processing, and/or data and/or information transmission, described herein.

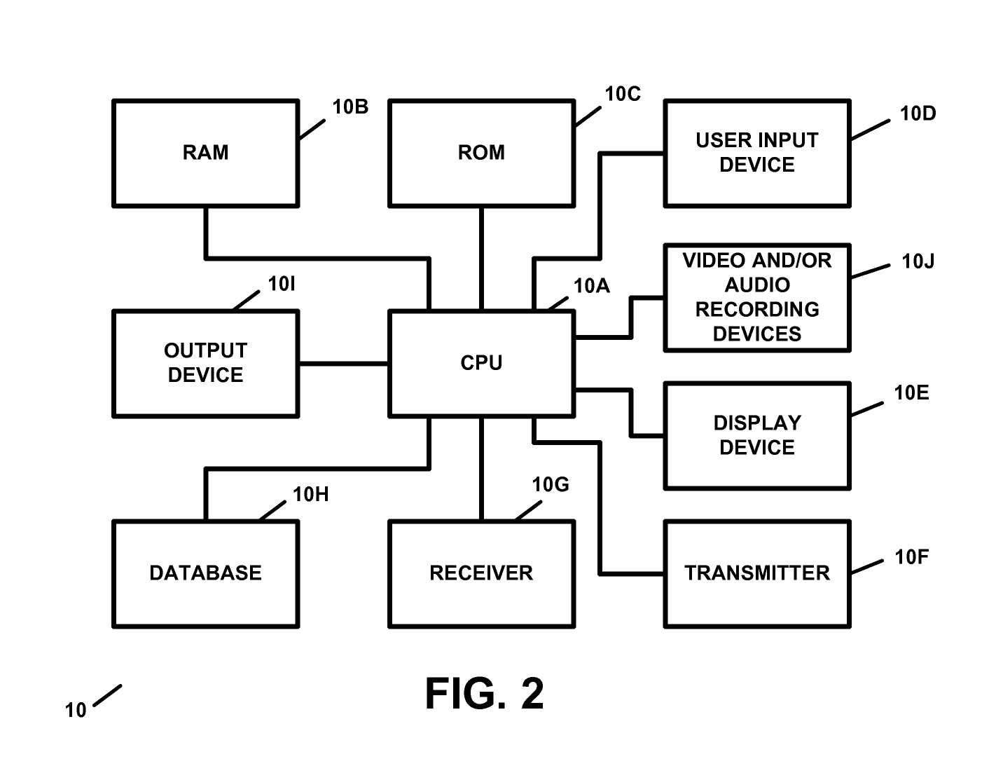

FIG. 2 illustrates the central processing computer 10 of FIG. 1, in block diagram form. The central processing computer 10, in the preferred embodiment, is a network computer or computer system, or any other communication device which can provide the functionality of, and which can be utilized as a central processing computer such as an Internet server computer and/or a web site server computer. In the preferred embodiment, the central processing computer 10 includes a central processing unit or CPU 10A, which in the preferred embodiment, is a microprocessor. The CPU 10A may also be a microcomputer, a minicomputer, a macro-computer, and/or a mainframe computer, depending upon the application.

The central processing computer 10 also includes a random access memory device(s) 10B (RAM) and a read only memory device(s) 10C (ROM), each of which is connected to the CPU 10A, a user input device 10D, for entering data and/or commands into the central processing computer 10, which includes any one or more of a keyboard, keypad, touch screen, touch screen keypad, touch screen keyboard, a scanner, a user pointing device, such as, for example, a mouse, a touch pad, and/or an audio input device and/or a video input device, a microphone or audio recording device, a camera or a video recording device, and/or any device, electronic and/or otherwise which can be utilized for inputting and/or entering data, information, or commands, into the central processing computer 10, which input device(s) are also connected to the CPU 10A. The central processing computer 10 also includes a display device 10E for displaying data and/or information to a user or operator.

The central processing computer 10 also includes a transmitter(s) 10F, for transmitting signals and/or data and/or information to any one or more of any other central processing computer(s) 10, the communication device(s) 20, the telephone service provider computer(s) 30, the cellular/wireless service provider computer(s) 40, the e-mail service provider computer(s) 50, and/or the cable/satellite service provider computer(s) 60, and/or the governmental agency computer(s) 70, or any other computers or communication devices or individual computer(s), which may be utilized in conjunction with the present invention. The central processing computer 10 also includes a receiver 10G, for receiving signals and/or data and/or information from any one or more of any other central processing computer(s) 10, the communication device(s) 20, the telephone service provider computer(s) 30, the cellular/wireless service provider computer(s) 40, the e-mail service provider computer(s) 50, and/or the cable/satellite service provider computer(s) 60, and/or the governmental agency computer(s) 70, or any other computers or communication devices or individual computer(s), which may be utilized in conjunction with the present invention.

The central processing computer 10 also includes a database(s) 10H which contains and/or includes any data and/or information needed or desired for enabling the central processing computer 10 and/or the apparatus 100 to perform all of the functions and/or functionality described herein as being performed, or as being capable of being performed, by the apparatus 100 and methods of the present invention.

In a preferred embodiment, the database 10H can contain and/or can include, for each user, individual, or account holder, who or which uses the apparatus 100 of the present invention, information regarding the respective user's, the individual's, or the account holder's name, address, account number or account identifier, telephone number or telephone numbers, cellular telephone number or cellular telephone numbers, wireless telephone number or wireless telephone numbers, facsimile (fax) number of fax numbers, e-mail address or e-mail addresses, instant messaging information, text messaging number or text messaging numbers, instant messaging number or instant messaging numbers, SMS messaging number or SMS messaging numbers, MMS messaging number or MMS messaging numbers and/or any other contact information for the respective user, individual, or account holder.

In a preferred embodiment, the database 10H can also contain and/or can include, for each respective user, individual, or account holder, data and/or information regarding any and/or all allowed or authorized telephone numbers from which telephone calls can be received on the respective user's, individual's, or account holder's, telephone or telephones, cellular telephone or cellular telephones, wireless telephone or telephones, facsimile machine or facsimile machines, or personal digital assistant, or communication device or computer of any type or kind. In a preferred embodiment, the database 10H can also contain and/or can include, for each respective user, individual, or account holder, data and/or information regarding any and/or all disallowed or rejected telephone numbers from which telephone calls are not to be received, or should not be received, on the respective user's, individual's, or account holder's, telephone or telephones, cellular telephone or cellular telephones, wireless telephone or telephones, facsimile machine or facsimile machines, or communication device or computer of any type or kind.

In a preferred embodiment, the database 10H can also contain and/or can include, for each respective user, individual, or account holder, data and/or information regarding any and/or all allowed or authorized facsimile telephone numbers from which facsimile transmissions can be received on the respective user's, individual's, or account holder's, facsimile machine or facsimile machines, or communication device or computer of any type or kind. In a preferred embodiment, the database 10H can also contain and/or can include, for each respective user, individual, or account holder, data and/or information regarding any and/or all disallowed or rejected facsimile telephone numbers from which facsimile transmissions are not to be received, or should not be received, on the respective user's, individual's, or account holder's, facsimile machine or facsimile machines, or communication device or computer of any type or kind.

In a preferred embodiment, the database 10H can also contain and/or can include, for each respective user, individual, or account holder, data and/or information regarding any and/or all allowed or authorized telephone numbers from which text messages, SMS messages, MMS messages, or any other messages, can be received on the respective user's, individual's, or account holder's, telephone or telephones, cellular telephone or cellular telephones, or wireless telephone or telephones, or personal digital assistant, or personal digital assistant, or communication device or computer of any type or kind. In a preferred embodiment, the database 10H can also contain and/or can include, for each respective user, individual, or account holder, data and/or information regarding any and/or all disallowed or rejected telephone numbers from which text messages, SMS messages, MMS messages, or any other messages, are not to be received, or should not be received, on the respective user's, individual's, or account holder's, telephone or telephones, cellular telephone or cellular telephones, wireless telephone or telephones, or communication device or computer of any type or kind.

In a preferred embodiment, the database 10H can also contain and/or can include, for each respective user, individual, or account holder, data and/or information regarding any and/or all allowed or authorized telephone numbers from which text messages, SMS messages, or MMS messages, or any other messages, can be received on the respective user's, individual's, or account holder's, telephone or telephones, cellular telephone or cellular telephones, or wireless telephone or telephones, or personal digital assistant, or communication device of any type or kind. In a preferred embodiment, the database 10H can also contain and/or can include, for each respective user, individual, or account holder, data and/or information regarding any and/or all disallowed or rejected telephone numbers from which text messages, SMS messages, or MMS messages, or any other messages, are not to be received, or should not be received, on the respective user's, individual's, or account holder's, telephone or telephones, cellular telephone or cellular telephones, wireless telephone or telephones, or communication device of any type or kind.

In a preferred embodiment, the database 10H can also contain and/or can include, for each respective user, individual, or account holder, data and/or information regarding any and/or all allowed or authorized e-mail addresses from which e-mail messages can be received on the respective user's, individual's, or account holder's, computer, personal computer, home computer, laptop computer, notebook computer, tablet, tablet computer, telephone or telephones, cellular telephone or cellular telephones, or wireless telephone or telephones, or personal digital assistant, or communication device of any type or kind. In a preferred embodiment, the database 10H can also contain and/or can include, for each respective user, individual, or account holder, data and/or information regarding any and/or all disallowed or rejected e-mail addresses from which e-mail messages are not to be received, or should not be received, on the respective user's, individual's, or account holder's, computer, personal computer, home computer, laptop computer, notebook computer, tablet, tablet computer, telephone or telephones, cellular telephone or cellular telephones, or wireless telephone or telephones, or personal digital assistant, or communication device of any type or kind.

In a preferred embodiment, the database 10H can also contain and/or can include, for each respective user, individual, or account holder, data and/or information regarding any and/or all allowed or authorized addresses, IP addresses, or any other authorized computers or other devices or sources, from which instant messages can be received on the respective user's, individual's, or account holder's, computer, personal computer, home computer, laptop computer, notebook computer, tablet, tablet computer, telephone or telephones, cellular telephone or cellular telephones, or wireless telephone or telephones, or personal digital assistant, or communication device of any type or kind. In a preferred embodiment, the database 10H can also contain and/or can include, for each respective user, individual, or account holder, data and/or information regarding any and/or all disallowed or rejected addresses, IP addresses, or any other authorized computers or other devices or sources, from which instant messages are not to be received, or should not be received, on the respective user's, individual's, or account holder's, computer, personal computer, home computer, laptop computer, notebook computer, tablet, tablet computer, telephone or telephones, cellular telephone or cellular telephones, or wireless telephone or telephones, or personal digital assistant, or communication device of any type or kind.

In a preferred embodiment, the database 10H can also contain and/or can include, for each respective user, individual, or account holder, data and/or information regarding any and/or all allowed or authorized IP addresses from which Internet communications of any type or kind can be received on the respective user's, individual's, or account holder's, computer, personal computer, home computer, laptop computer, notebook computer, tablet, tablet computer, telephone or telephones, cellular telephone or cellular telephones, or wireless telephone or telephones, or personal digital assistant, or communication device of any type or kind. In a preferred embodiment, the database 10H can also contain and/or can include, for each respective user, individual, or account holder, data and/or information regarding any and/or all disallowed or rejected IP addresses from which Internet communications of any type or kind are not to be received, or should not be received, on the respective user's, individual's, or account holder's, computer, personal computer, home computer, laptop computer, notebook computer, tablet, tablet computer, telephone or telephones, cellular telephone or cellular telephones, or wireless telephone or telephones, or personal digital assistant, or communication device of any type or kind.

The database 10H can also contain and/or include, for each account of each user, individual, or account holder, who uses the apparatus 100 of the present invention, for each communication device 20, and/or for any and/or all the accounts services by the central processing computer 10, by any communication device 20, and/or by any of the respective telephone service provider computer(s) 30, cellular/wireless service provider computer(s) 40, e-mail service provider computer(s) 50, or cable/satellite service provider computer(s) 60, or governmental agency computer(s) 70, data and/or information regarding allowed telephone numbers and/or accepted telephone numbers from which telephone calls can be accepted, and//or any allowed telephone number lists and/or any accepted telephone number lists, and/or rejected telephone numbers from which telephone calls are not to be accepted, and/or any rejected telephone number lists, and/or allowed cellular telephone numbers and/or accepted cellular telephone numbers from which telephone calls or cellular telephone calls can be accepted, and//or any allowed cellular telephone number lists and/or any accepted cellular telephone number lists, and/or rejected cellular telephone numbers from which telephone calls or cellular telephone calls are not to be accepted, and/or any rejected cellular telephone number lists, and/or allowed telephone numbers and/or accepted telephone numbers from which fax transmissions can be accepted, and//or any allowed telephone number lists or allowed fax/telephone lists, and/or any accepted telephone number lists or accepted fax/telephone number lists, and/or rejected telephone numbers or rejected fax/telephone numbers from which fax transmissions are not to be accepted, and/or any rejected telephone number lists or rejected fax/telephone numbers lists, and/or allowed telephone numbers or allowed text/telephone numbers and/or accepted telephone numbers or accepted text/telephone numbers from which text messages, SMS messages, or MMS messages, or other messages, can be accepted, and//or any allowed telephone number lists or allowed text/telephone number lists, and/or any accepted telephone number lists or accepted text/telephone lists, and/or rejected telephone numbers or rejected text/telephone numbers from which text messages, SMS messages, or MMS messages, or other messages, are not to be accepted, and/or any rejected text/telephone number lists or rejected text/telephone numbers lists, and/or allowed e-mail addresses and/or accepted e-mail addresses from which e-mail messages can be accepted, and//or any allowed e-mail address lists or any accepted e-mail address lists, and/or rejected e-mail addresses from which e-mail messages are not to be accepted, and/or any rejected mail address lists, and/or allowed IP addresses or other addresses and/or accepted IP addresses or other addresses from which instant messages or any other messages can be accepted, and//or any allowed IP address or other address lists or any accepted IP address or other address lists, and/or rejected IP addresses or other addresses from which e-mail messages are not to be accepted, and/or any rejected IP address or other address lists.

The database 10H can also contain and/or include, for each account of each user, individual, or account holder, who uses the apparatus 100 of the present invention, for each communication device 20, and/or for any and/or all the accounts services by the central processing computer 10, by any communication device 20, and/or by any of the respective telephone service provider computer(s) 30, cellular/wireless service provider computer(s) 40, e-mail service provider computer(s) 50, or cable/satellite service provider computer(s) 60, or governmental agency computer(s) 70, any an/do all of the herein-described screened telephone call message playback reports, screened telephone call message playback report notification messages, screened telephone call message playback report alert messages, and/or Do Not Call List violations complaint messages, forms, or reports, and/or any information regarding same, the date and time of same, the date and time of the generation of same and the identification computer or communication device generating same, the data and time of the reporting or the transmitting of same, and/or the data and time of the reviewing of same and/or information regarding the reviewing person, and/or any information regarding any action taken regarding same by any respective user, individual, account holder, provider, operator, or governmental agency.

The database 10H can also contain and/or include, for each account of each user, individual, or account holder, who uses the apparatus 100 of the present invention, for each communication device 20, and/or for any and/or all the accounts services by the central processing computer 10, by any communication device 20, and/or by any of the respective telephone service provider computer(s) 30, cellular/wireless service provider computer(s) 40, e-mail service provider computer(s) 50, or cable/satellite service provider computer(s) 60, or governmental agency computer(s) 70, any and/do all of the herein-described screened fax transmission reports, screened fax transmission report notification messages, screened fax transmission report alert messages, and/or Do Not Fax List violations complaint messages, forms, or reports, and/or any information regarding same, the date and time of same, the date and time of the generation of same and the identification computer or communication device generating same, the data and time of the reporting or the transmitting of same, and/or the data and time of the reviewing of same and/or information regarding the reviewing person, and/or any information regarding any action taken regarding same by any respective user, individual, account holder, provider, operator, or governmental agency.

The database 10H can also contain and/or include, for each account of each user, individual, or account holder, who uses the apparatus 100 of the present invention, for each communication device 20, and/or for any and/or all the accounts services by the central processing computer 10, by any communication device 20, and/or by any of the respective telephone service provider computer(s) 30, cellular/wireless service provider computer(s) 40, e-mail service provider computer(s) 50, or cable/satellite service provider computer(s) 60, or governmental agency computer(s) 70, any and/do all of the herein-described screened text message reports, screened text message report notification messages, screened text message report alert messages, and/or Do Not Text List violations complaint messages, forms, or reports, and/or any information regarding same, the date and time of same, the date and time of the generation of same and the identification computer or communication device generating same, the data and time of the reporting or the transmitting of same, and/or the data and time of the reviewing of same and/or information regarding the reviewing person, and/or any information regarding any action taken regarding same by any respective user, individual, account holder, provider, operator, or governmental agency.

The database 10H can also contain and/or include, for each account of each user, individual, or account holder, who uses the apparatus 100 of the present invention, for each communication device 20, and/or for any and/or all the accounts services by the central processing computer 10, by any communication device 20, and/or by any of the respective telephone service provider computer(s) 30, cellular/wireless service provider computer(s) 40, e-mail service provider computer(s) 50, or cable/satellite service provider computer(s) 60, or governmental agency computer(s) 70, any and/do all of the herein-described screened e-mail message reports, screened e-mail message report notification messages, screened e-mail message report alert messages, and/or Do Not E-Mail List violations complaint messages, forms, or reports, and/or any information regarding same, the date and time of same, the date and time of the generation of same and the identification computer or communication device generating same, the data and time of the reporting or the transmitting of same, and/or the data and time of the reviewing of same and/or information regarding the reviewing person, and/or any information regarding any action taken regarding same by any respective user, individual, account holder, provider, operator, or governmental agency.

The database 10H can also contain and/or include any other data and/or information, lists, reports, notification messages, alert messages, complaints, or compliant forms, or other information generated by any the apparatus 100, by any of the herein-described central processing computers 10, communication devices 20, telephone service provider computers 30, cellular/wireless service provider computers 40, e-mail service provider computers 50, and/or cable/satellite service provider computers 60, and/or governmental agency computers 70.

The database 10H can also contain and/or include activity logs or activity reports for each user, individual, or account holder, who uses the apparatus 100 of the present invention. The database 10H can also contain and/or include activity logs or activity reports for each operator or provider of any of the herein-described central processing computers 10, telephone service provider computers 30, cellular/wireless service provider computers 40, e-mail service provider computers 50, and/or cable/satellite service provider computers 60, and/or governmental agency computers 70.

The database 10H can also contain and/or include any information regarding any users, individuals, or account holders, and/or any and/or all of their accounts, which are serviced by the apparatus 100, by the central processing computer 10, and/or by any other central processing computers, or by any of the herein-described telephone service provider computers 30, cellular/wireless service provider computers 40, e-mail service provider computers 50, and/or cable/satellite service provider computers 60, and/or governmental agency computers 70.

The database 10H can also contain and/or include any information regarding any of the herein-described telephone service provider computers 30, cellular/wireless service provider computers 40, e-mail service provider computers 50, and/or cable/satellite service provider computers 60, and/or governmental agency computers 70, which are utilized in connection with the apparatus 100 of the present invention and/or any of the herein-described data and/or information regarding any and/or all of the users, individuals, or account holders, and/or their respective accounts, which are serviced by the respective telephone service provider computer 30, cellular/wireless service provider computer 40, e-mail service provider computer 50, and/or cable/satellite service provider computer 60, and/or governmental agency computer 70.

The database 10H can also contain and/or include any information regarding any of the herein-described communication devices 20 which are utilized in connection with the apparatus 100 of the present invention and/or any of the herein-described data and/or information regarding any and/or all of the users, individuals, or account holders, associated with the respective communication device 20.

In a preferred embodiment, the database 10H can also contain and/or include any data, information, software, programs, algorithms, or any other data and/or information for allowing the apparatus 100, and/or any of the herein-described central processing computers 10, communication devices 20, telephone service provider computers 30, cellular/wireless service provider computers 40, e-mail service provider computers 50, and/or cable/satellite service provider computers 60, and/or governmental agency computers 70, to perform all of the functions and functionality described herein as being performed by the apparatus 100 and method of the present invention, and/or by the central processing computers 10, communication devices 20, telephone service provider computers 30, cellular/wireless service provider computers 40, e-mail service provider computers 50, and/or cable/satellite service provider computers 60, and/or governmental agency computers 70.

The central processing computer 10 also includes an output device 101 for outputting any data, information, reports, or messages, described herein as being generated and/or transmitted by the apparatus 100 of the present invention. In the preferred embodiment, the output device 101 can be a printer, a display, a transmitter, a modem, and/or any other device which can be used to output data or information.

The central processing computer 10 can also include a video and/or audio recording device(s) 10J which can include a camera and/or a video recording device for recording pictures or video and/or video clips and/or a microphone or an audio recording device for recording audio or audio clips which can be stored in the central processing computer 10, and/or which can be transmitted to and/or stored in any other central processing computer(s) 10, the communication device(s) 20, the telephone service provider computer(s) 30, the cellular/wireless service provider computer(s) 40, the e-mail service provider computer(s) 50, and/or the cable/satellite service provider computer(s) 60, and/or the governmental agency computer(s) 70, described herein, and/or which can be utilized to allow a user or operator or the central processing computer 10 to engage in video conferencing with any other users, individuals, account holders, or any employees or agents of any of the telephone service providers, cellular communication service providers or wireless communication service providers, Internet service provides or e-mail service providers, or cable television service providers or satellite television service providers, who or which utilize the apparatus 100 and method of the present invention, and/or which can be utilized to allow a user or operator of the central processing computer 10 to record and/or transmit video messages, telephone message, facsimile messages, text messages, SMS messages, MMS messages, e-mail messages, instant messages, video e-mail messages, and/or any other messages or communications which can allow a user or operator of the central processing computer 10 to utilize or engage in or with any other video messaging or communications applications.

Any of the data and/or information stored in the database 10H can be updated by any of the herein-described users, individuals, account holders, or any or any employees or agents of any of the telephone service providers, cellular communication service providers or wireless communication service providers, Internet service provides or e-mail service providers, or cable television service providers or satellite television service providers, who or which utilize the apparatus 100 and method of the present invention, and any such updated data and/or information can be made available to any other users, individuals, account holders, or any or any employees or agents of any of the telephone service providers, cellular communication service providers or wireless communication service providers, Internet service provides or e-mail service providers, or cable television service providers or satellite television service providers.

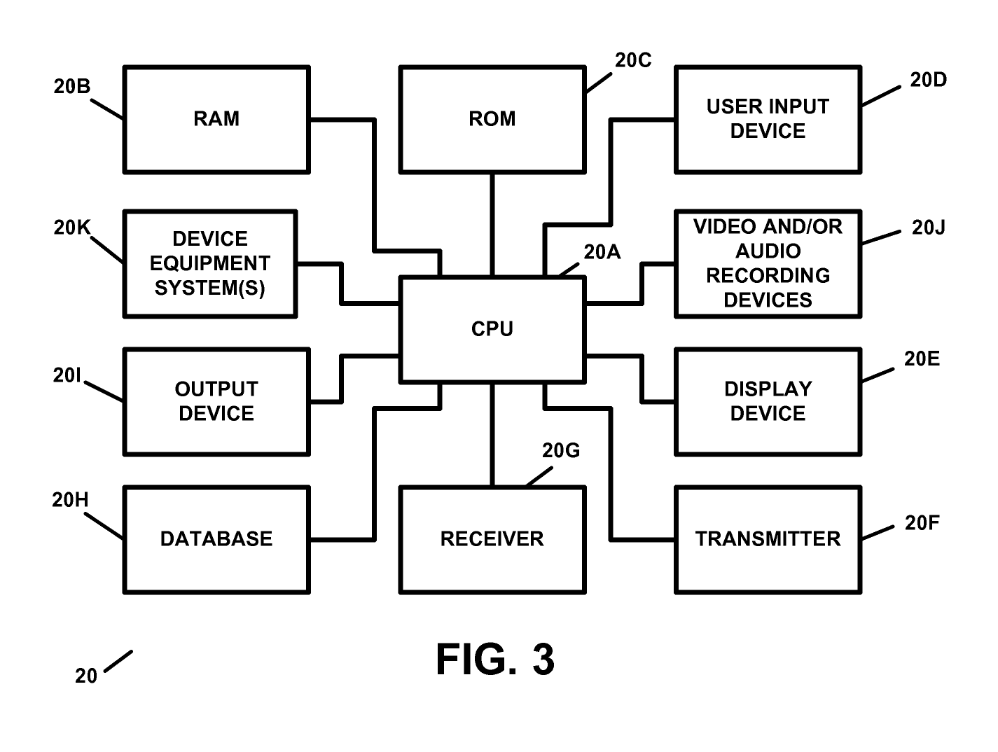

FIG. 3 illustrates the communication device 20 of FIG. 1, in block diagram form. The communication device 20, in the preferred embodiment, can be any a telephone, a line-connected telephone, a home telephone or residential telephone, an office telephone or a telephone used for business purposes or commercial purposes, a cordless telephone, a cellular telephone, a wireless telephone, a smart phone, a Smartphone, a mobile telephone, a personal communications services (PCS) telephone, a personal digital assistant, a video telephone, a videophone, a digital telephone, a facsimile machine, a personal computer, a laptop computer, a notebook computer, a tablet, or a tablet computer, or a wearable communication device, a wearable computer, or any other type or kind of communication device, wireless communication device, cellular communication device, or mobile communication device, or any other device which can be utilized to allow any user, individual, or account holder, to engage in any type or kind of communication, or any other computer or communication device, which can be utilized as a communication device 20. In the preferred embodiment, the communication device 20 includes a central processing unit or CPU 20A, which in the preferred embodiment, is a microprocessor. The CPU 20A may also be a microcomputer, a minicomputer, a macro-computer, and/or a mainframe computer, depending upon the application.

The communication device 20 also includes a random access memory device(s) 20B (RAM) and a read only memory device(s) 20C (ROM), each of which is connected to the CPU 20A, a user input device 20D, for entering data, information, and/or commands, into the communication device 20, which includes any one or more of a keypad, touch screen, touch screen keypad, touch screen keyboard, a keyboard, a scanner, a user pointing device, such as, for example, a mouse, a touch pad, and/or an audio input device and/or a video input device, and/or any device, electronic and/or otherwise which can be utilized for inputting and/or entering data, information, or commands into the communication device 20, and which input device(s) are also connected to the CPU 20A.

The communication device 20 also includes a display device 20E for displaying data and/or information to a user or operator. The communication device 20 also includes a transmitter(s) 20F, for transmitting signals and/or data and/or information to any one or more of the central processing computer(s) 10, any other communication device(s) 20, the telephone service provider computer(s) 30, the cellular/wireless service provider computer(s) 40, the e-mail service provider computer(s) 50, and/or the cable/satellite service provider computer(s) 60, and/or the governmental agency computer(s) 70, which may be utilized in conjunction with the apparatus 100 and method of the present invention. The communication device 20 also includes a receiver 20G, for receiving signals and/or data and/or information from any one or more of the central processing computer(s) 10, any other communication device(s) 20, the telephone service provider computer(s) 30, the cellular/wireless service provider computer(s) 40, the e-mail service provider computer(s) 50, and/or the cable/satellite service provider computer(s) 60, and/or the governmental agency computer(s) 70, which may be utilized in conjunction with the apparatus 100 and method of the present invention.

The communication device 20 also includes a database(s) 20H for storing any data and/or information needed or desired for utilizing the apparatus 100 and method of the present invention and/or for performing any and/or all of the functions and functionality described herein as being performed by the apparatus 100, the central processing computer 10, and/or the communication device 20.

The database 20H can also contain and/or include, any data and/or information described herein as being stored in the database 10H of the central processing computer 10 which is needed or desired for the communication device 20 to perform any and/or all of the functions and functionality described herein as being performed by the communication device 20, and/or which is need and/or desired for processing any data and/or information for or regarding the user's, the individual's, or the account holder's, account.

The database 20H can also contain and/or include, and/or contain and/or include a link(s) or a hyperlink(s) to, any data and/or information described herein as being stored in any of the databases 10H, 20H, 30H, 40H, 50H, and/or 60H, described herein. The database 20H can also contain and/or be linked to any of the data and/or information described herein as being stored in the database 10H.

The database 20H can also contain and/or include, and/or contain and/or include a link(s) or a hyperlink(s) to, any data and/or information described herein as being stored in any of the databases 10H, 20H, 30H, 40H, 50H, and/or 60H, described herein. The database 20H can also contain and/or be linked to any of the data and/or information described herein as being stored in the database 10H.

In a preferred embodiment, the database 20H can also contain and/or can include, for the user, individual, or account holder who or which utilizes the communication device 20, information regarding the user's, the individual's, or the account holder's, name, address, telephone number, cellular telephone number, wireless telephone number, e-mail address, text messaging number, SMS messaging number, MMS messaging number, company name or business name, company telephone number or business telephone number, company e-mail address or business e-mail address, and/or, if applicable, the user's, the individual's, or the account holder's agent's name, the agent's telephone number, the agent's cellular telephone number, the agent's wireless telephone number, the agent's e-mail address, the agent's text messaging number, and/or the agent's SMS messaging number, MMS messaging number, and/or any other contact information for the user, individual, or account holder and/or his or her agent.

The communication device 20 also includes an output device 201 for outputting any data, information, report, or message, described herein. In the preferred embodiment, the output device 201 can be a printer, a display, a transmitter, a modem, and/or any other device which can be used to output data or information.

The communication device 20 also includes a video and/or audio recording device(s) 20J which can include a camera and/or a video recording device for recording pictures or video and/or video clips and/or a microphone or an audio recording device for recording audio or audio clips which can be stored in the communication device 20, and/or which can be transmitted to and/or stored in any other communication device(s) 20, the central processing computer(s) 10, the telephone service provider computer(s) 30, the cellular/wireless service provider computer(s) 40, the e-mail service provider computer(s) 50, and/or the cable/satellite service provider computer(s) 60, and/or the governmental agency computer(s) 70, described herein, and/or which can be utilized to allow a user of the communication device 20 to engage in video conferencing with any other users, individuals, or account holders, or any employees or agents of any of the telephone service providers, cellular communication service providers or wireless communication service providers, Internet service provides or e-mail service providers, or cable television service providers or satellite television service providers, who or which utilize the apparatus 100 and method of the present invention, and/or which can be utilized to allow a user of the communication device 20 to record and/or transmit video messages, video e-mails, and/or which can allow a user of the communication device 20 to utilize or engage in or with any other video messaging applications.

The communication device 20 also includes any and/or all of the device equipment system(s) 20K which are needed or required for the communication device 20 to perform all of its functions or functionality. For example, in an embodiment where the communication device 20 is a telephone, the device equipment system(s) 20K can include, but is not limited to, any of the microprocessors, computers, memory devices, hardware, software, and/or any other components or equipment, typically provided in or with a telephone, which perform the various and/or typical functions of the telephone, such as, but not limited to, any calling functions or functionality, call dialing functions or functionality, call receiving functions or functionality, caller identification processing and/or displaying functions or functionality, call ringing functions or functionality, answering machine functions or functionality, call re-dialing functions or functionality, intercom functions or functionality, speakerphone functions or functionality, computational functions or functionality, and/or any other functions or functionality typically provided or performed by telephones.

In an embodiment, where the communication device 20 is a cellular telephone, a wireless telephone, a smart phone, a Smartphone, a personal digital assistant, or a communication device, the device equipment system(s) 20K can, for example, include, but not be limited to, any of the microprocessors, computers, memory devices, hardware, software, and/or any other components or equipment, typically provided in or with a cellular telephone, a wireless telephone, smart phone, Smartphone, a personal digital assistant, or a communication device, which perform any of the various and/or typical functions of the cellular telephone, wireless telephone, smart phone, Smartphone, personal digital assistant, or communication device, such as, but not limited to, any calling or communications functions or functionality, call dialing functions or functionality, call receiving functions or functionality, caller identification processing and/or displaying functions or functionality, call ringing functions or functionality, answering machine or call recording functions or functionality, call re-dialing functions or functionality, intercom functions or functionality, speakerphone functions or functionality, text message, SMS message receiving, storing, and/or displaying, functions or functionality, text message, SMS message, creation and/or transmission functions or functionality, e-mail message receiving, storing, and/or displaying, functions or functionality, e-mail message creation and/or transmission functions or functionality, instant message receiving, storing, and/or displaying, functions or functionality, instant message creation and/or transmission functions or functionality, or any computational functions or functionality and/or any other functions or functionality typically provided or performed by cellular telephones, wireless telephones, smart phones, Smartphones, personal digital assistants, or communication devices.

In an embodiment, where the communication device 20 is a fax machine, the device equipment system(s) 20K can include, but is not limited to, any of the microprocessors, computers, memory devices, hardware, software, and/or any other components or equipment, typically provided in or with a fax machine, which perform the various and/or typical functions of the fax machine, such as, but not limited to, any calling or fax transmission functions or functionality, call or fax transmission dialing functions or functionality, call or fax transmission receiving functions or functionality, caller or fax identification processing and/or displaying functions or functionality, call or fax ringing functions or functionality, call or fax transmission recording functions or functionality, call or fax transmission re-dialing functions or functionality, fax printing functions or functionality, computational functions or functionality, and/or any other functions or functionality typically provided or performed by fax machines.

In an embodiment, where the communication device 20 is a personal computer, laptop computer, notebook computer, tablet computer, tablet, hand-held computer, palm-top computer, or any other computer or communication device, the device equipment system(s) 20K can, for example, include, but not be limited to, any of the microprocessors, computers, memory devices, hardware, software, and/or any other components or equipment, typically provided in or with a personal computer, laptop computer, notebook computer, tablet computer, tablet, hand-held computer, palm-top computer, or any other computer or communication device, which perform any of the various and/or typical functions of the personal computer, laptop computer, notebook computer, tablet computer, tablet, hand-held computer, palm-top computer, or other computer or communication device, such as, but not limited to, any of the computational functions or functionality which can be performed by or provided by the personal computer, laptop computer, notebook computer, tablet computer, tablet, hand-held computer, palm-top computer, or other computer or communication device, text message or SMS message receiving, storing, and/or displaying, functions or functionality, text message or SMS message, creation, and/or transmission, functions or functionality, e-mail message receiving, storing, and/or displaying, functions or functionality, e-mail message creation and/or transmission functions or functionality, instant message receiving, storing, and/or displaying, functions or functionality, instant message creation and/or transmission functions or functionality, and/or any other functions or functionality typically provided or performed by personal computers, laptop computers, notebook computers, tablet computers, tablets, hand-held computers, palm-top computers, or other computers or communication devices.

In an embodiment where any other type or kind of communication device 20 is utilized, the device equipment system(s) 20K can include, but is not limited to, any of the microprocessors, computers, memory devices, hardware, software, and/or any other components or equipment, typically provided in or with that type or kind of communication device 20 which allows or enables that communication device 20 to perform the various and/or typical functions of same.

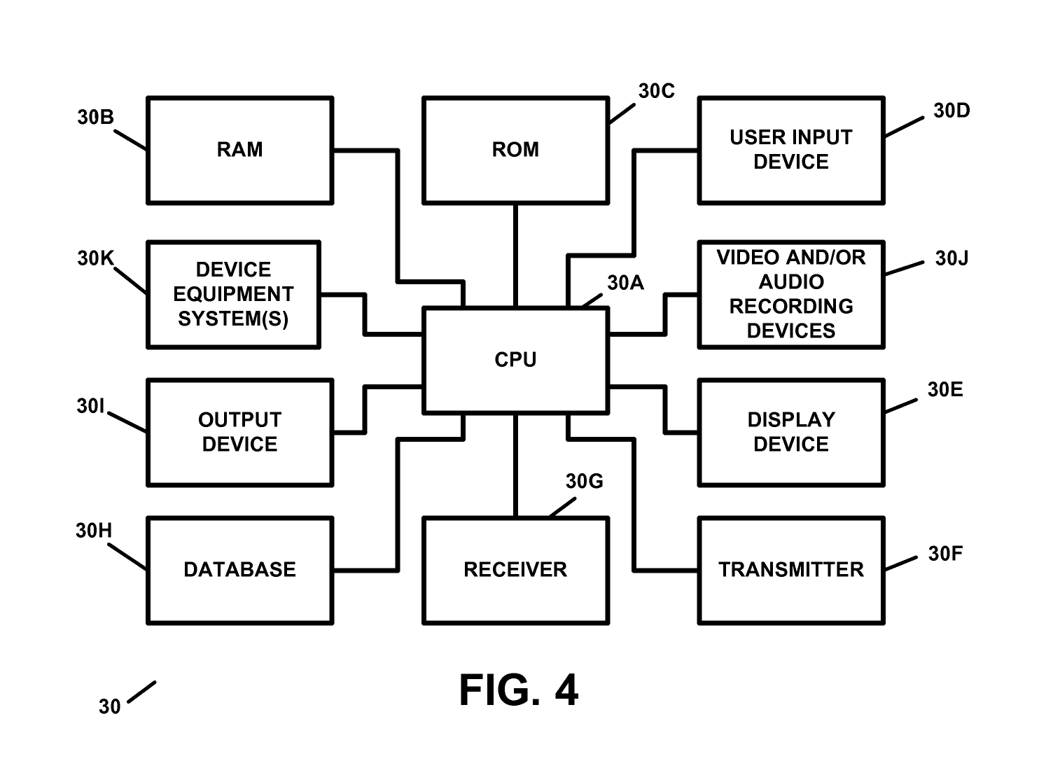

FIG. 4 illustrates the telephone service provider computer 30 of FIG. 1, in block diagram form. The telephone service provider computer 30, in the preferred embodiment, can be any computer, personal computer, network computer, or computer system, or any other computer or communication device, which can be utilized as a telephone service provider computer 30. In the preferred embodiment, the telephone service provider computer 30 includes a central processing unit or CPU 30A, which in the preferred embodiment, is a microprocessor. The CPU 30A may also be a microcomputer, a minicomputer, a macro-computer, and/or a mainframe computer, depending upon the application.

The telephone service provider computer 30 also includes a random access memory device(s) 30B (RAM) and a read only memory device(s) 30C (ROM), each of which is connected to the CPU 30A, a user input device 30D, for entering data, information, and/or commands, into the telephone service provider computer 30, which includes any one or more of a keyboard, a keypad, touch screen, touch screen keypad, touch screen keyboard, a scanner, a user pointing device, such as, for example, a mouse, a touch pad, and/or an audio input device and/or a video input device, and/or any device, electronic and/or otherwise which can be utilized for inputting and/or entering data, information, or commands into the telephone service provider computer 30, and which input device(s) are also connected to the CPU 30A.

The telephone service provider computer 30 also includes a display device 30E for displaying data and/or information to a user or operator. The telephone service provider computer 30 also includes a transmitter(s) 30F, for transmitting signals and/or data and/or information to any one or more of the central processing computer(s) 10, the communication device(s) 20, any other telephone service provider computer(s) 30, the cellular/wireless service provider computer(s) 40, the e-mail service provider computer(s) 50, and/or the cable/satellite service provider computer(s) 60, and/or the governmental agency computer(s) 70, which may be utilized in conjunction with the apparatus 100 and method of the present invention. The telephone service provider computer 30 also includes a receiver 30G, for receiving signals and/or data and/or information from any one or more of the central processing computer(s) 10, the communication device(s) 20, any other telephone service provider computer(s) 30, the cellular/wireless service provider computer(s) 40, the e-mail service provider computer(s) 50, and/or the cable/satellite service provider computer(s) 60, and/or the governmental agency computer(s) 70, which may be utilized in conjunction with the apparatus 100 and method of the present invention.

The telephone service provider computer 30 also includes a database(s) 30H for storing any data and/or information needed or desired for utilizing the apparatus 100 and method of the present invention and/or for performing any and/or all of the functions and functionality described herein as being performed by the apparatus 100, the central processing computer 10, and/or the telephone service provider computer 30.

The database 30H can also contain and/or include, any data and/or information described herein as being stored in the database 10H of the central processing computer 10 which is needed or desired for the telephone service provider computer 30 to perform any and/or all of the functions and functionality described herein as being performed by the telephone service provider computer 30, and/or which is need and/or desired for processing any data and/or information for or regarding any of the user's, the individual's, or the account holder's, accounts which are serviced by the telephone service provider computer 30.

The database 30H can also contain and/or include, and/or contain and/or include a link(s) or a hyperlink(s) to, any data and/or information described herein as being stored in any of the databases 10H, 20H, 30H, 40H, 50H, and/or 60H, described herein. The database 30H can also contain and/or be linked to any of the data and/or information described herein as being stored in the database 10H.

In a preferred embodiment, the database 30H can also contain and/or can include, for the provider who or which utilizes the provider communication device 30, information regarding the provider's name, address, telephone number, cellular telephone number, wireless telephone number, e-mail address, text messaging number, SMS messaging number, MMS messaging number, company name or business name, company telephone number or business telephone number, company e-mail address or business e-mail address, the provider's agent's name, the provider's agent's telephone number, the provider's agent's cellular telephone number, the provider's agent's wireless telephone number, the provider's agent's e-mail address, the provider's agent's text messaging number, and/or the provider's agent's SMS messaging number, MMS messaging number, and/or any other contact information for the provider and/or for the provider's agent.

The telephone service provider computer 30 also includes an output device 301 for outputting any data, information, report, or message, described herein. In the preferred embodiment, the output device 301 can be a printer, a display, a transmitter, a modem, and/or any other device which can be used to output data or information.

The telephone service provider computer 30 also includes a video and/or audio recording device(s) 30J which can include a camera and/or a video recording device for recording pictures or video and/or video clips and/or a microphone or an audio recording device for recording audio or audio clips which can be stored in the telephone service provider computer 30, and/or which can be transmitted to and/or stored in any other telephone service provider computer(s) 30, the central processing computer(s) 10, the communication device(s) 20, the cellular/wireless service provider computer(s) 40, the e-mail service provider computer(s) 50, and/or the cable/satellite service provider computer(s) 60, described herein, and/or which can be utilized to allow a user or operator of the telephone service provider computer 30 to engage in video conferencing with any other users, individuals, or account holders, or any employees or agents of any of the telephone service providers, cellular communication service providers or wireless communication service providers, Internet service provides or e-mail service providers, or cable television service providers or satellite television service providers, who or which utilize the apparatus 100 and method of the present invention, and/or which can be utilized to allow a user of the telephone service provider computers 30 to record and/or transmit video messages, video e-mails, and/or which can allow a user of the telephone service provider computer 30 to utilize or engage in or with any other video messaging applications.

The telephone service provider computer 30 also includes any and/or all of the device equipment system(s) 30K which are needed or required for the telephone service provider computer 30 to perform all of its functions or functionality. For example, the telephone service provider computer 30 can include any of the microprocessors, computers, memory devices, hardware, software, peripheral devices, and/or any other components or equipment, typically provided in or with a telephone service provider computer, and/or which can allow the telephone service provider computer 30 to perform the various and/or typical functions of a telephone service provider computer.

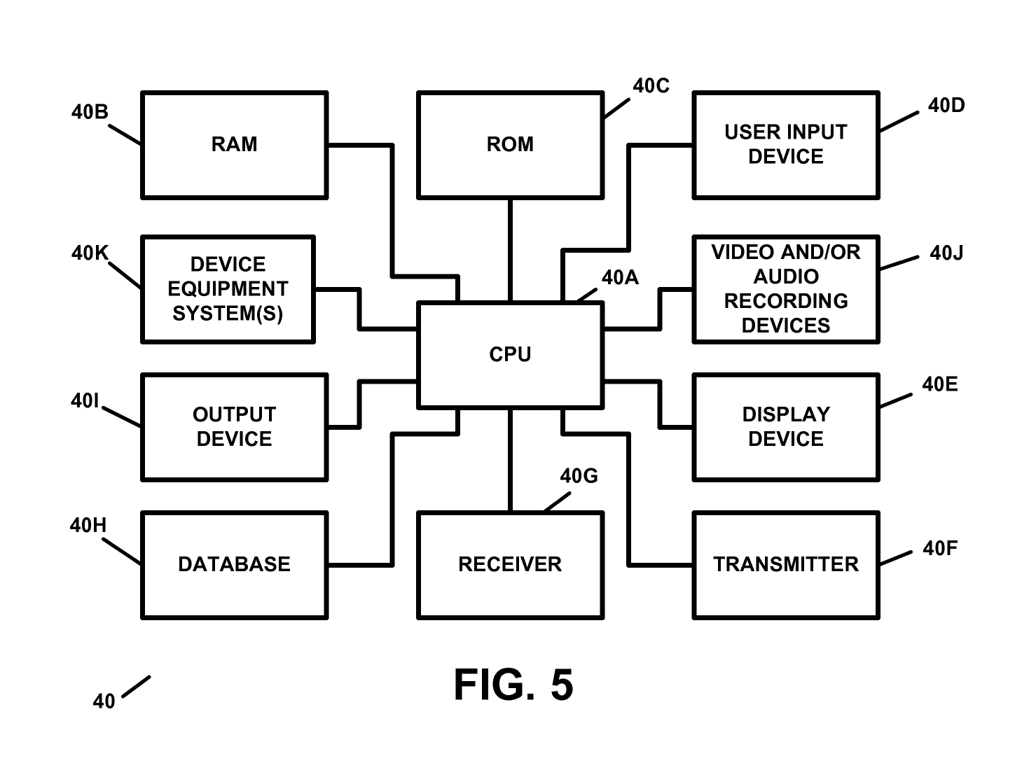

FIG. 5 illustrates the cellular/wireless service provider computer 40 of FIG. 1, in block diagram form. The cellular/wireless service provider computer 40, in the preferred embodiment, can be any computer, personal computer, network computer, or computer system, or any other computer or communication device, which can be utilized as a cellular/wireless service provider computer 40. In the preferred embodiment, the cellular/wireless service provider computer 40 includes a central processing unit or CPU 40A, which in the preferred embodiment, is a microprocessor. The CPU 40A may also be a microcomputer, a minicomputer, a macro-computer, and/or a mainframe computer, depending upon the application.

The cellular/wireless service provider computer 40 also includes a random access memory device(s) 40B (RAM) and a read only memory device(s) 40C (ROM), each of which is connected to the CPU 40A, a user input device 40D, for entering data, information, and/or commands, into the cellular/wireless service provider computer 40, which includes any one or more of a keyboard, a keypad, touch screen, touch screen keypad, touch screen keyboard, a scanner, a user pointing device, such as, for example, a mouse, a touch pad, and/or an audio input device and/or a video input device, and/or any device, electronic and/or otherwise which can be utilized for inputting and/or entering data, information, or commands into the cellular/wireless service provider computer 40, and which input device(s) are also connected to the CPU 40A.

The cellular/wireless service provider computer 40 also includes a display device 40E for displaying data and/or information to a user or operator. The cellular/wireless service provider computer 40 also includes a transmitter(s) 40F, for transmitting signals and/or data and/or information to any one or more of the central processing computer(s) 10, the communication device(s) 20, the telephone service provider computer(s) 30, any other cellular/wireless service provider computer(s) 40, the e-mail service provider computer(s) 50, and/or the cable/satellite service provider computer(s) 60, and/or the governmental agency computer(s) 70, which may be utilized in conjunction with the apparatus 100 and method of the present invention. The cellular/wireless service provider computer 40 also includes a receiver 40G, for receiving signals and/or data and/or information from any one or more of the central processing computer(s) 10, the communication device(s) 20, the telephone service provider computer(s) 30, any other cellular/wireless service provider computer(s) 40, the e-mail service provider computer(s) 50, and/or the cable/satellite service provider computer(s) 60, and/or the governmental agency computer(s) 70, which may be utilized in conjunction with the apparatus 100 and method of the present invention.

The cellular/wireless service provider computer 40 also includes a database(s) 40H for storing any data and/or information needed or desired for utilizing the apparatus 100 and method of the present invention and/or for performing any and/or all of the functions and functionality described herein as being performed by the apparatus 100, the central processing computer 10, and/or the cellular/wireless service provider computer 40.

The database 40H can also contain and/or include, any data and/or information described herein as being stored in the database 10H of the central processing computer 10 which is needed or desired for the cellular/wireless service provider computer 40 to perform any and/or all of the functions and functionality described herein as being performed by the cellular/wireless service provider computer 40, and/or which is need and/or desired for processing any data and/or information for or regarding any of the user's, the individual's, or the account holder's, accounts which are serviced by the cellular/wireless service provider computer 40.

The database 40H can also contain and/or include, and/or contain and/or include a link(s) or a hyperlink(s) to, any data and/or information described herein as being stored in any of the databases 10H, 20H, 30H, 40H, 50H, and/or 60H, described herein. The database 40H can also contain and/or be linked to any of the data and/or information described herein as being stored in the database 10H.

In a preferred embodiment, the database 40H can contain and/or can include, for the provider who or which utilizes the provider communication device 40, information regarding the provider's name, address, telephone number, cellular telephone number, wireless telephone number, e-mail address, text messaging number, SMS messaging number, MMS messaging number, company name or business name, company telephone number or business telephone number, company e-mail address or business e-mail address, the provider's agent's name, the provider's agent's telephone number, the provider's agent's cellular telephone number, the provider's agent's wireless telephone number, the provider's agent's e-mail address, the provider's agent's text messaging number, and/or the provider's agent's SMS messaging number, MMS messaging number, and/or any other contact information for the provider and/or for the provider's agent.

The cellular/wireless service provider computer 40 also includes an output device 401 for outputting any data, information, report, or message, described herein. In the preferred embodiment, the output device 401 can be a printer, a display, a transmitter, a modem, and/or any other device which can be used to output data or information.

The cellular/wireless service provider computer 40 also includes a video and/or audio recording device(s) 40J which can include a camera and/or a video recording device for recording pictures or video and/or video clips and/or a microphone or an audio recording device for recording audio or audio clips which can be stored in the cellular/wireless service provider computer 40, and/or which can be transmitted to and/or stored in any other cellular/wireless service provider computer(s) 40, the central processing computer(s) 10, the communication device(s) 20, the telephone service provider computer(s) 30, the e-mail service provider computer(s) 50, and/or the cable/satellite service provider computer(s) 60, described herein, and/or which can be utilized to allow a user or operator of the cellular/wireless service provider computer 40 to engage in video conferencing with any other users, individuals, or account holders, or any employees or agents of any of the telephone service providers, cellular communication service providers or wireless communication service providers, Internet service provides or e-mail service providers, or cable television service providers or satellite television service providers, who or which utilize the apparatus 100 and method of the present invention, and/or which can be utilized to allow a user of the cellular/wireless service provider computer 40 to record and/or transmit video messages, video e-mails, and/or which can allow a user of the cellular/wireless service provider computer 40 to utilize or engage in or with any other video messaging applications.

The cellular/wireless service provider computer 40 also includes any and/or all of the device equipment system(s) 40K which are needed or required for the cellular/wireless service provider computer 40 to perform all of its functions or functionality. For example, the cellular/wireless service provider computer 40 can include any of the microprocessors, computers, memory devices, hardware, software, peripheral devices, and/or any other components or equipment, typically provided in or with a telephone service provider computer, and/or which can allow the cellular/wireless service provider computer 40 to perform the various and/or typical functions of a telephone service provider computer.

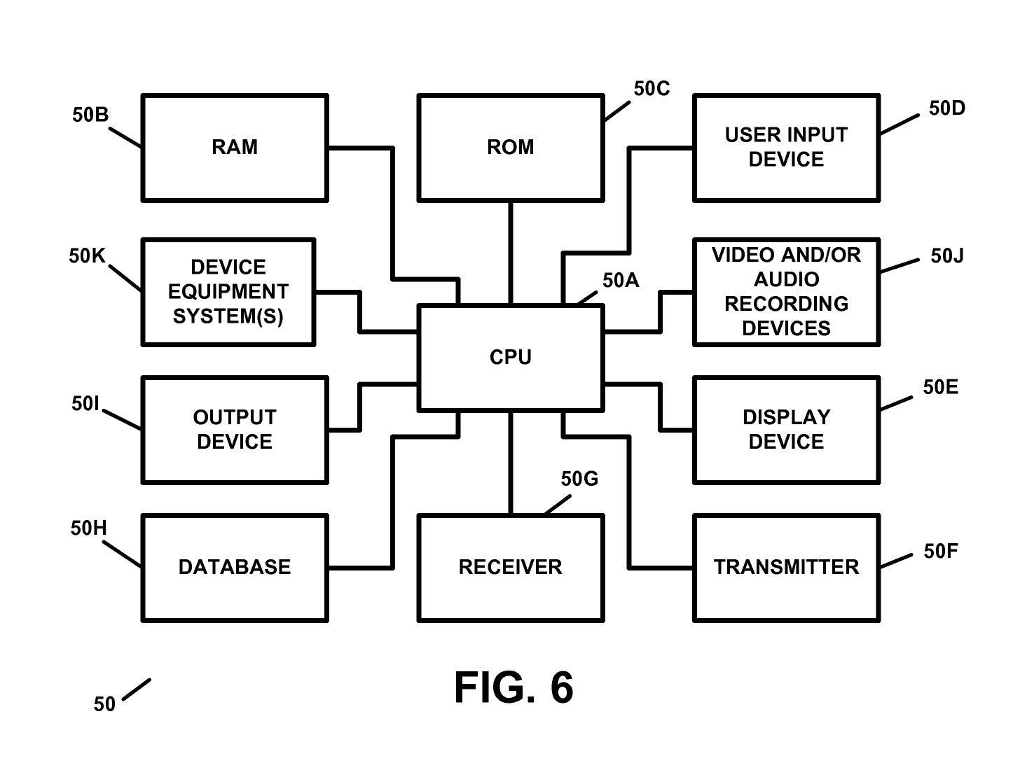

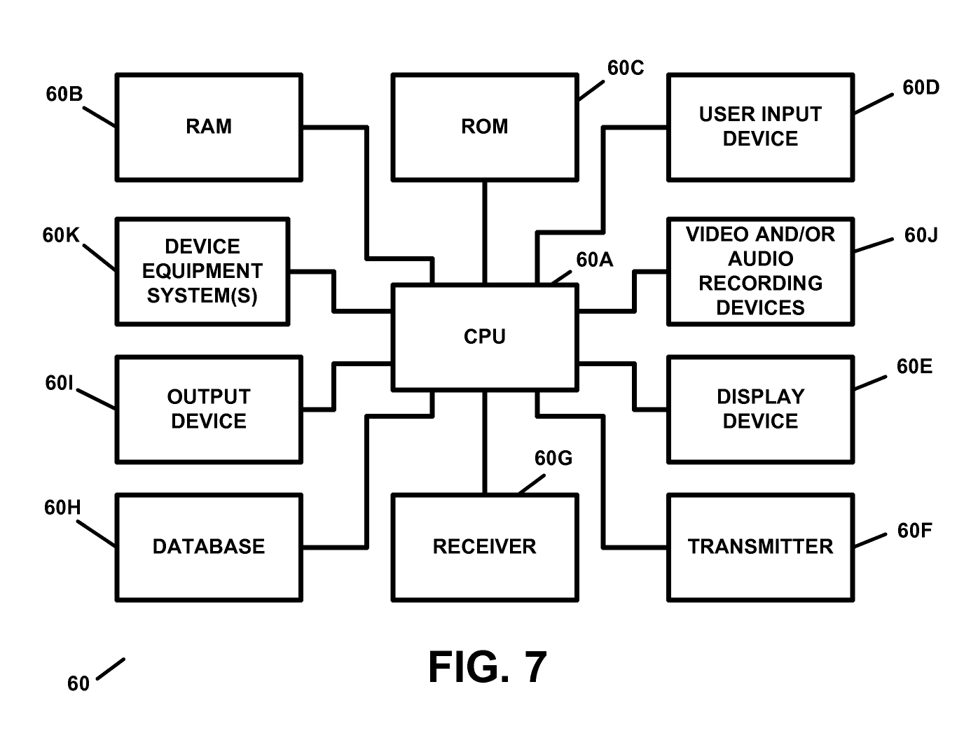

FIG. 6 illustrates the e-mail service provider computer 50 of FIG. 1, in block diagram form. The e-mail service provider computer 50, in the preferred embodiment, can be any computer, personal computer, network computer, or computer system, or any other computer or communication device, which can be utilized as an e-mail service provider computer 50. In the preferred embodiment, the e-mail service provider computer 50 includes a central processing unit or CPU 50A, which in the preferred embodiment, is a microprocessor. The CPU 50A may also be a microcomputer, a minicomputer, a macro-computer, and/or a mainframe computer, depending upon the application.

The e-mail service provider computer 50 also includes a random access memory device(s) 50B (RAM) and a read only memory device(s) 50C (ROM), each of which is connected to the CPU 50A, a user input device 50D, for entering data, information, and/or commands, into the e-mail service provider computer 50, which includes any one or more of a keyboard, a keypad, touch screen, touch screen keypad, touch screen keyboard, a scanner, a user pointing device, such as, for example, a mouse, a touch pad, and/or an audio input device and/or a video input device, and/or any device, electronic and/or otherwise which can be utilized for inputting and/or entering data, information, or commands into the e-mail service provider computer 50, and which input device(s) are also connected to the CPU 50A.

The e-mail service provider computer 50 also includes a display device 50E for displaying data and/or information to a user or operator. The e-mail service provider computer 50 also includes a transmitter(s) 50F, for transmitting signals and/or data and/or information to any one or more of the central processing computer(s) 10, the communication device(s) 20, the telephone service provider computer(s) 30, the cellular/wireless service provider computer(s) 40, any other e-mail service provider computer(s) 50, and/or the cable/satellite service provider computer(s) 60, and/or the governmental agency computer(s) 70, which may be utilized in conjunction with the apparatus 100 and method of the present invention. The e-mail service provider computer 50 also includes a receiver 50G, for receiving signals and/or data and/or information from any one or more of the central processing computer(s) 10, the communication device(s) 20, the telephone service provider computer(s) 30, the cellular/wireless service provider computer(s) 40, any other e-mail service provider computer(s) 50, and/or the cable/satellite service provider computer(s) 60, and/or the governmental agency computer(s) 70, which may be utilized in conjunction with the apparatus 100 and method of the present invention.

The e-mail service provider computer 50 also includes a database(s) 50H for storing any data and/or information needed or desired for utilizing the apparatus 100 and method of the present invention and/or for performing any and/or all of the functions and functionality described herein as being performed by the apparatus 100, the central processing computer 10, and/or the e-mail service provider computer 50.

The database 50H can also contain and/or include, any data and/or information described herein as being stored in the database 10H of the central processing computer 10 which is needed or desired for the e-mail service provider computer 50 to perform any and/or all of the functions and functionality described herein as being performed by the e-mail service provider computer 50, and/or which is need and/or desired for processing any data and/or information for or regarding any of the user's, the individual's, or the account holder's, accounts which are serviced by the e-mail service provider computer 50.

The database 50H can also contain and/or include, and/or contain and/or include a link(s) or a hyperlink(s) to, any data and/or information described herein as being stored in any of the databases 10H, 20H, 30H, 40H, 50H, and/or 60H, described herein. The database 50H can also contain and/or be linked to any of the data and/or information described herein as being stored in the database 10H.

In a preferred embodiment, the database 50H can contain and/or can include, for the provider who or which utilizes the e-mail service provider computer 50, information regarding the provider's name, address, telephone number, cellular telephone number, wireless telephone number, e-mail address, text messaging number, SMS messaging number, MMS messaging number, company name or business name, company telephone number or business telephone number, company e-mail address or business e-mail address, the provider's agent's name, the provider's agent's telephone number, the provider's agent's cellular telephone number, the provider's agent's wireless telephone number, the provider's agent's e-mail address, the provider's agent's text messaging number, and/or the provider's agent's SMS messaging number, MMS messaging number, and/or any other contact information for the provider and/or for the provider's agent.

The e-mail service provider computer 50 also includes an output device 501 for outputting any data, information, report, or message, described herein. In the preferred embodiment, the output device 501 can be a printer, a display, a transmitter, a modem, and/or any other device which can be used to output data or information.

The e-mail service provider computer 50 also includes a video and/or audio recording device(s) 50J which can include a camera and/or a video recording device for recording pictures or video and/or video clips and/or a microphone or an audio recording device for recording audio or audio clips which can be stored in the e-mail service provider computer 50, and/or which can be transmitted to and/or stored in any other e-mail service provider computer(s) 50, the central processing computer(s) 10, the communication device(s) 20, the telephone service provider computer(s) 30, and/or the cable/satellite service provider computer(s) 60, described herein, and/or which can be utilized to allow a user or operator of the e-mail service provider computer 50 to engage in video conferencing with any other users, individuals, or account holders, or any employees or agents of any of the telephone service providers, cellular communication service providers or wireless communication service providers, Internet service provides or e-mail service providers, or cable television service providers or satellite television service providers, who or which utilize the apparatus 100 and method of the present invention, and/or which can be utilized to allow a user of the e-mail service provider computer 50 to record and/or transmit video messages, video e-mails, and/or which can allow a user of the e-mail service provider computer 50 to utilize or engage in or with any other video messaging applications.

The e-mail service provider computer 50 also includes any and/or all of the device equipment system(s) 50K which are needed or required for the e-mail service provider computer 50 to perform all of its functions or functionality. For example, the e-mail service provider computer 50 can include any of the microprocessors, computers, memory devices, hardware, software, peripheral devices, and/or any other components or equipment, typically provided in or with an e-mail service provider computer, and/or which can allow the e-mail service provider computer 50 to perform the various and/or typical functions of an e-mail service provider computer.

FIG. 6 illustrates the cable/satellite service provider computer 60 of FIG. 1, in block diagram form. The cable/satellite service provider computer 60, in the preferred embodiment, can be any computer, personal computer, network computer, or computer system, or any other computer or communication device, which can be utilized as a cable/satellite service provider computer 60. In the preferred embodiment, the cable/satellite service provider computer 60 includes a central processing unit or CPU 60A, which in the preferred embodiment, is a microprocessor. The CPU 60A may also be a microcomputer, a minicomputer, a macro-computer, and/or a mainframe computer, depending upon the application.

The cable/satellite service provider computer 60 also includes a random access memory device(s) 60B (RAM) and a read only memory device(s) 60C (ROM), each of which is connected to the CPU 60A, a user input device 60D, for entering data, information, and/or commands, into the cable/satellite service provider computer 60, which includes any one or more of a keyboard, a keypad, touch screen, touch screen keypad, touch screen keyboard, a scanner, a user pointing device, such as, for example, a mouse, a touch pad, and/or an audio input device and/or a video input device, and/or any device, electronic and/or otherwise which can be utilized for inputting and/or entering data, information, or commands into the cable/satellite service provider computer 60, and which input device(s) are also connected to the CPU 60A.

The cable/satellite service provider computer 60 also includes a display device 60E for displaying data and/or information to a user or operator. The cable/satellite service provider computer 60 also includes a transmitter(s) 60F, for transmitting signals and/or data and/or information to any one or more of the central processing computer(s) 10, the communication device(s) 20, the telephone service provider computer(s) 30, the cellular/wireless service provider computer(s) 40, the e-mail service provider computer(s) 50, and/or any other cable/satellite service provider computer(s) 60, and/or the governmental agency computer(s) 70, which may be utilized in conjunction with the apparatus 100 and method of the present invention. The cable/satellite service provider computer 60 also includes a receiver 60G, for receiving signals and/or data and/or information from any one or more of the central processing computer(s) 10, the communication device(s) 20, the telephone service provider computer(s) 30, the cellular/wireless service provider computer(s) 40, the e-mail service provider computer(s) 50, and/or any other cable/satellite service provider computer(s) 60, and/or the governmental agency computer(s) 70, which may be utilized in conjunction with the apparatus 100 and method of the present invention.

The cable/satellite service provider computer 60 also includes a database(s) 60H for storing any data and/or information needed or desired for utilizing the apparatus 100 and method of the present invention and/or for performing any and/or all of the functions and functionality described herein as being performed by the apparatus 100, the central processing computer 10, and/or the cable/satellite service provider computer 60.

The database 60H can also contain and/or include, any data and/or information described herein as being stored in the database 10H of the central processing computer 10 which is needed or desired for the cable/satellite service provider computer 60 to perform any and/or all of the functions and functionality described herein as being performed by the cable/satellite service provider computer 60, and/or which is need and/or desired for processing any data and/or information for or regarding any of the user's, the individual's, or the account holder's, accounts which are serviced by the cable/satellite service provider computer 60.

The database 60H can also contain and/or include, and/or contain and/or include a link(s) or a hyperlink(s) to, any data and/or information described herein as being stored in any of the databases 10H, 20H, 30H, 40H, 50H, and/or 60H, described herein. The database 60H can also contain and/or be linked to any of the data and/or information described herein as being stored in the database 10H.

In a preferred embodiment, the database 60H can contain and/or can include, for the provider who or which utilizes the cable/satellite service provider computer 60, information regarding the provider's name, address, telephone number, cellular telephone number, wireless telephone number, e-mail address, text messaging number, SMS messaging number, MMS messaging number, company name or business name, company telephone number or business telephone number, company e-mail address or business e-mail address, the provider's agent's name, the provider's agent's telephone number, the provider's agent's cellular telephone number, the provider's agent's wireless telephone number, the provider's agent's e-mail address, the provider's agent's text messaging number, and/or the provider's agent's SMS messaging number, MMS messaging number, and/or any other contact information for the provider and/or for the provider's agent.

The cable/satellite service provider computer 60 also includes an output device 601 for outputting any data, information, report, or message, described herein. In the preferred embodiment, the output device 601 can be a printer, a display, a transmitter, a modem, and/or any other device which can be used to output data or information.

The cable/satellite service provider computer 60 also includes a video and/or audio recording device(s) 60J which can include a camera and/or a video recording device for recording pictures or video and/or video clips and/or a microphone or an audio recording device for recording audio or audio clips which can be stored in the cable/satellite service provider computer 60, and/or which can be transmitted to and/or stored in any other cable/satellite service provider computer 60, the central processing computer(s) 10, the communication device(s) 20, the telephone service provider computer(s) 30, and/or the e-mail service provider computer(s) 50, described herein, and/or which can be utilized to allow a user or operator of the cable/satellite service provider computer 60 to engage in video conferencing with any other users, individuals, or account holders, or any employees or agents of any of the telephone service providers, cellular communication service providers or wireless communication service providers, Internet service provides or e-mail service providers, or cable television service providers or satellite television service providers, who or which utilize the apparatus 100 and method of the present invention, and/or which can be utilized to allow a user of the cable/satellite service provider computer 60 to record and/or transmit video messages, video e-mails, and/or which can allow a user of the cable/satellite service provider computer 60 to utilize or engage in or with any other video messaging applications.

The cable/satellite service provider computer 60 also includes any and/or all of the device equipment system(s) 60K which are needed or required for the cable/satellite service provider computer 60 to perform all of its functions or functionality. For example, the cable/satellite service provider computer 60 can include any of the microprocessors, computers, memory devices, hardware, software, peripheral devices, and/or any other components or equipment, typically provided in or with a cable/satellite service provider computer, and/or which can allow the cable/satellite service provider computer 60 to perform the various and/or typical functions of a cable/satellite service provider computer.

In a preferred embodiment, the apparatus 100 and method of the present invention can be utilized to provide a communication device 20, which can be any type or kind of communication device including, but not limited to, a telephone, a line-connected telephone, a home telephone or residential telephone, an office telephone or a telephone used for business purposes or commercial purposes, a cordless telephone, a cellular telephone, a wireless telephone, a smart phone, a Smartphone, a mobile telephone, a personal communications services (PCS) telephone, a personal digital assistant, a video telephone, a videophone, a digital telephone, a facsimile machine, a personal computer, a laptop computer, a notebook computer, a tablet, or a tablet computer, or a wearable communication device, a wearable computer, or any other type or kind of communication device, wireless communication device, cellular communication device, or mobile communication device, which can be programmed to accept telephone calls or cellular telephone calls from allowed or accepted telephone numbers or from allowed or accepted cellular telephone numbers, or can be programmed to reject telephone calls or cellular telephone calls from unaccepted or rejected telephone numbers or from unaccepted or rejected cellular telephone numbers, or from unknown telephone numbers or unknown cellular telephone numbers, from unidentifiable telephone numbers or unidentifiable cellular telephone numbers, from private telephone numbers or private cellular telephone numbers, or from concealed, hidden, or disguised, telephone numbers or cellular telephone numbers, or can be programmed to receive, screen, and/or record, telephone calls or cellular telephone calls and associated messages from certain telephone numbers or cellular telephone numbers while suppressing or preventing the telephone or the cellular telephone, which is the communication device 20 in such an embodiment, from ringing, or can be programmed to generate a screened telephone call message playback report which can be provided or played back to a user, individual, or account holder, or can be programmed to generate a screened telephone call playback report notification message or alert message which can, but need not, contain information, a link, or a hyperlink, to the screened telephone call playback report, and can transmit same to any communication device 20 used by or associated with the user, individual, or account holder, or can be programmed to allow a user, individual, or account holder, to select or designate certain of the telephone numbers or cellular telephone numbers from which messages are recorded which can or should be allowed or accepted or rejected in the future, or which can be programmed to allow a user, individual, or account holder, to revise, on the fly, and/or while listening to or reviewing the screened telephone call message playback report, the list of allowed or accepted telephone numbers or allowed or accepted cellular telephone number, or rejected telephone numbers or rejected cellular telephone numbers, from and via the screened telephone call message playback report.

In a preferred embodiment, the communication device 20 can also be programmed to provide a listing of allowed or accepted telephone numbers or allowed or accepted cellular telephone numbers, and/or a list of rejected telephone numbers or rejected cellular telephone numbers, to the central processing computer 10, to any other communication device(s) 20 of the user, individual, or account holder, and/or to any respective telephone service provider computer(s) 30, cellular/wireless service provider computer(s) 40, e-mail service provider computer(s) 50, or cable/satellite service provider computer(s) 60, or governmental agency computer(s) 70. The communication device 20 can also be programmed to generate respective complaint messages containing information for reporting Do Not Call List violations by calling parties and to transmit same to the central processing computer 10 and/or to any respective telephone service provider computer(s) 30, cellular/wireless service provider computer(s) 40, e-mail service provider computer(s) 50, or cable/satellite service provider computer(s) 60, or governmental agency computer(s) 70.

In another preferred embodiment, the apparatus 100 and method of the present invention can be utilized to provide a communication device 20 which can be programmed to accept fax calls and/or fax transmissions from allowed or accepted telephone numbers or allowed or accepted cellular telephone numbers, or can be programmed to reject fax calls and/or fax transmissions from unaccepted or rejected telephone numbers or from unaccepted or rejected cellular telephone numbers, from unknown fax telephone numbers, from unidentifiable fax telephone numbers, from private fax telephone numbers, or from concealed, hidden, or disguised, fax telephone numbers or cellular fax telephone numbers (“fax telephone numbers”), or can be programmed to receive, screen, and/or record, fax calls and/or fax transmissions and associated fax messages from certain fax telephone numbers while suppressing the fax machine, which is the communication device 20 in this embodiment, from ringing, or can be programmed to generate a screened fax transmission report which can be provided to a user, individual, or account holder, or can be programmed to generate a screened fax transmission report notification message or alert message which can, but need not, contain information, a link, or a hyperlink, to the screened fax transmission report, and can transmit same to any communication device 20 used by or associated with the user, individual, or account holder, or can be programmed to allow a user, individual, or account holder, to select or designate fax telephone numbers from which fax transmissions can or should be allowed or accepted or rejected in the future, or which can be programmed to allow a user, individual, or account holder, to revise, on the fly, and/or while reviewing the screened fax transmission message report, the list of allowed or accepted fax telephone numbers or rejected fax telephone numbers from and via the screened fax transmission message report.

In a preferred embodiment, the communication device 20 can also be programmed to provide a listing of allowed or accepted fax telephone numbers, and/or a list of rejected fax telephone numbers, to the central processing computer 10, to any other communication device(s) 20 of the user, individual, or account holder, and/or to any respective telephone service provider computer(s) 30, cellular/wireless service provider computer(s) 40, e-mail service provider computer(s) 50, or cable/satellite service provider computer(s) 60, or governmental agency computer(s) 70. The communication device 20 can also be programmed to generate respective complaint messages containing information for reporting any Do Not Fax List violations by fax transmitting parties and to transmit same to the central processing computer 10 and/or to any respective telephone service provider computer(s) 30, cellular/wireless service provider computer(s) 40, e-mail service provider computer(s) 50, or cable/satellite service provider computer(s) 60, or governmental agency computer(s) 70.

In another preferred embodiment, the apparatus 100 and method of the present invention can be utilized to provide a communication device 20 which can be programmed to accept text messages, or SMS messages, or MMS messages, or other messages (also collectively referred to herein as a “text message” or “text messages”), from allowed or accepted telephone numbers or allowed or accepted cellular telephone numbers (“telephone numbers”), or can be programmed to reject text messages from unaccepted or rejected telephone numbers, from unknown telephone numbers, from unidentifiable telephone numbers, from private telephone numbers, or from concealed, hidden, or disguised, telephone numbers, or can be programmed to receive, screen, and/or record, text messages from certain telephone numbers while suppressing the cellular telephone, the wireless telephone, the smart phone, the Smartphone, the cellular communication device, the wireless communication device, or the personal digital assistant (“cellular or wireless communication device”), which is the communication device 20 in this embodiment, from emitting a sound or from ringing, or can be programmed to generate a screened text message report which can be provided to a user, individual, or account holder, or can be programmed to generate a screened text message report notification message or alert message, which can, but need not, contain information, a link, or a hyperlink, to the screened text message report, and can transmit same to any communication device 20 used by or associated with the user, individual, or account holder, or can be programmed to allow a user, individual, or account holder, to select or designate telephone numbers from which text messages can or should be allowed or accepted or rejected in the future, or which can be programmed to allow a user, individual, or account holder, to revise, on the fly, and/or while reviewing the screened text message report, the list of allowed or accepted telephone numbers or rejected telephone numbers from and via the screened text message report.

In a preferred embodiment, the communication device 20 can also be programmed to provide a listing of allowed or accepted telephone numbers, and/or a list of rejected telephone numbers, to the central processing computer 10, to any other communication device(s) 20 of the user, individual, or account holder, and/or to any respective telephone service provider computer(s) 30, cellular/wireless service provider computer(s) 40, e-mail service provider computer(s) 50, or cable/satellite service provider computer(s) 60, or governmental agency computer(s) 70. The communication device 20 can also be programmed to generate respective complaint messages containing information for reporting Do Not Text List violations by text message transmitting parties and to transmit same to the central processing computer 10 and/or to any respective telephone service provider computer(s) 30, cellular/wireless service provider computer(s) 40, e-mail service provider computer(s) 50, or cable/satellite service provider computer(s) 60, or governmental agency computer(s) 70.

In another preferred embodiment, the apparatus 100 and method of the present invention can be utilized to provide a communication device 20 which can be programmed to accept e-mail messages, instant messages, or messages transmitted from an IP address (“e-mail messages”) from allowed or accepted e-mail addresses or IP addresses (“e-mail addresses”), or can be programmed to reject, or automatically delete, e-mail messages from unaccepted or rejected e-mail addresses, from unknown e-mail addresses, from unidentifiable e-mail addresses, from private e-mail addresses, or from concealed, hidden, or disguised, e-mail addresses, or can be programmed to receive, screen, and/or record, e-mail addresses from certain e-mail addresses while suppressing same from entering the user's, the individual's, or the account holder's, e-mail In Box or while suppressing the respective personal computer, the laptop computer, the notebook computer, the telephone, the cellular telephone, the wireless telephone, the smart phone, the Smartphone, the cellular communication device, the wireless communication device, or the personal digital assistant (“communication device”), which is the communication device 20 in this embodiment, from emitting any sound or from proving any visual, audible, or other, indication, or can be programmed to generate a screened e-mail message report which can be provided to a user, individual, or account holder, or can be programmed to generate a screened e-mail message report notification message or alert message which can, but need not, contain information, a link, or a hyperlink, to the screened e-mail message report, and can transmit same to any communication device 20 used by or associated with the user, individual, or account holder, or can be programmed to allow a user, individual, or account holder, to select or designate e-mail addresses or IP addresses from which e-mail messages can or should be allowed or accepted or rejected in the future, or which can be programmed to allow a user, individual, or account holder, to revise, on the fly, and/or while reviewing the screened e-mail message report, the list of allowed or accepted e-mail addresses or rejected e-mail addresses from and via the screened e-mail message report.

In a preferred embodiment, the communication device 20 can also be programmed to provide a listing of allowed or accepted e-mail addresses and/or a list of rejected e-mail addresses, to the central processing computer 10, to any other communication device(s) 20 of the user, individual, or account holder, and/or to any respective telephone service provider computer(s) 30, cellular/wireless service provider computer(s) 40, e-mail service provider computer(s) 50, or cable/satellite service provider computer(s) 60, or governmental agency computer(s) 70. The communication device 20 can also be programmed to generate respective complaint messages containing information for reporting Do Not E-Mail List violations by e-mail transmitting parties and to transmit same to the central processing computer 10 and/or to any respective telephone service provider computer(s) 30, cellular/wireless service provider computer(s) 40, e-mail service provider computer(s) 50, or cable/satellite service provider computer(s) 60, or governmental agency computer(s) 70.

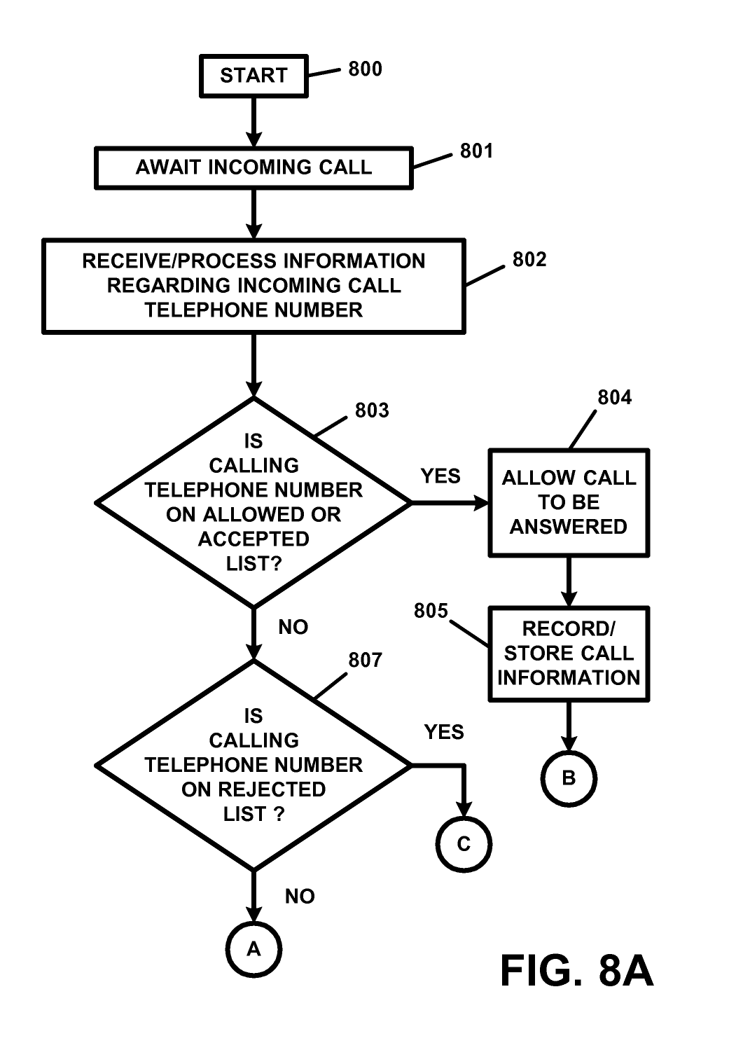

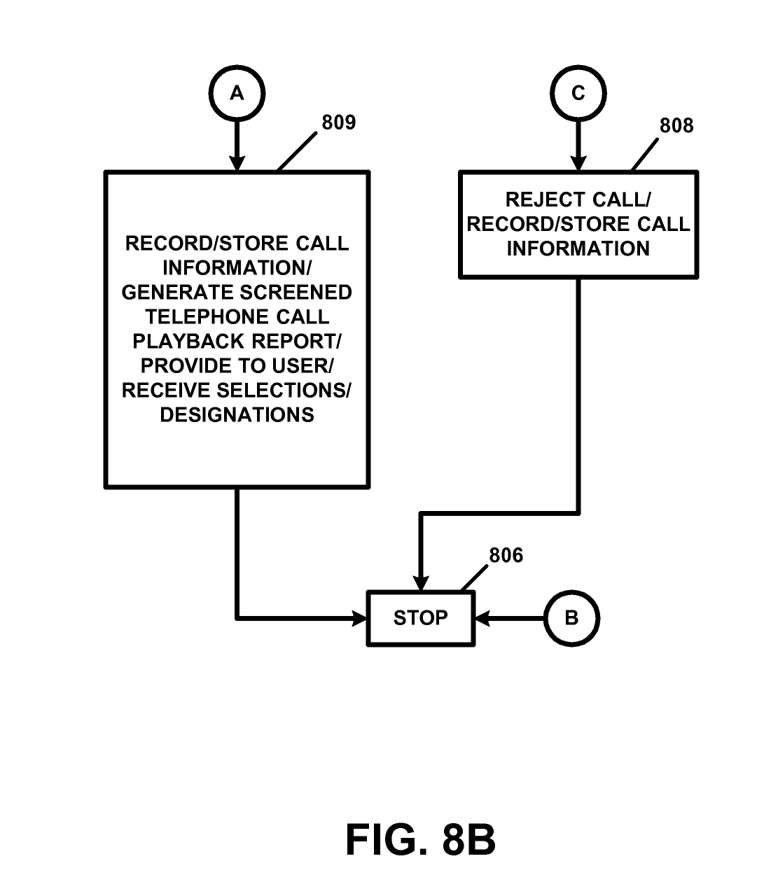

In a preferred embodiment, the apparatus 100 and method of the present invention can be utilized to provide, or can be, a telephone, a line-connected telephone, a home telephone or residential telephone, an office telephone or a telephone used for business purposes or commercial purposes, or a cordless telephone, which can screen, identify, reject, and/or report, unwanted telephone calls. In this preferred embodiment, a telephone, line-connected telephone, home telephone or residential telephone, office telephone or telephone used for business purposes or commercial purposes, or cordless telephone, can be used as a, or as the, communication device 20. FIGS. 8A and 8B illustrate a preferred embodiment method for utilizing the apparatus 100 of the present invention, in flow diagram form, in connection with a telephone which can screen, identify, reject, and/or report, unwanted telephone calls.

Although a telephone is described as being utilized as the communication device 20 in the preferred embodiment of FIGS. 8A and 8B, it is important to note that the embodiment of FIGS. 8A and 8B can also be utilized in a same, a similar, and/or an analogous, manner using, or in connection with, a line-connected telephone, a home telephone or residential telephone, an office telephone or a telephone used for business purposes or commercial purposes, a cordless telephone, or using, or in connection with, a cellular telephone, a wireless telephone, a smart phone, a Smartphone, a mobile telephone, a personal communications services (PCS) telephone, a personal digital assistant, a video telephone, a videophone, a digital telephone, a facsimile machine, a personal computer, a laptop computer, a notebook computer, a tablet, or a tablet computer, or a wearable communication device, a wearable computer, or any other type or kind of communication device, wireless communication device, cellular communication device, or mobile communication device, which can be adapted, configured, or programmed, to accept, receive, and/or which can be used for making or receiving calls or cellular telephone calls.

The communication device 20, which is a telephone in this preferred embodiment, and which can be referred to as “telephone” or “communication device 20” in the description of this preferred embodiment, can be pre-programmed by the user, individual, or account holder, with the telephone number(s) or cellular telephone number(s) (hereinafter “telephone number(s)”) from which calls can be received by the telephone (the “allowed telephone number(s)” or the “accepted telephone number(s)”). In this regard, the user, individual, or account holder, can create an allowed telephone number(s) list or an accepted telephone number(s) list. In a preferred embodiment, the communication device 20 can also be pre-programmed by the user, individual, or account holder, with the telephone number(s) from which calls are to be, or should be, rejected by the telephone (the “rejected telephone number(s)”). In this regard, the user, individual or account holder, can create a rejected telephone number(s) list.

In a preferred embodiment, the user, individual, or account holder, can also pre-program the telephone to reject telephone calls or cellular telephone calls (“telephone calls”) from telephone numbers which have not been identified as being allowed telephone number(s) or accepted telephone number(s), or to reject telephone calls from rejected telephone numbers, or to reject telephone calls from unknown or unaccepted telephone numbers, or from unknown telephone numbers, from unidentifiable telephone numbers, from private telephone numbers or private number telephone numbers, or from concealed, hidden, or disguised, telephone numbers. In a preferred embodiment, the communication device 20 can also be programmed to receive, screen, and/or record, telephone calls and associated messages or voice messages from certain telephone numbers, which have not yet been designated or identified as being allowed, accepted, or rejected, while suppressing or preventing the communication device 20 (or the telephone) from ringing, so as to not disturb the user, individual, or account holder, or other persons.

In a preferred embodiment, the communication device 20 can also be programmed to generate a screened telephone call message playback report which can provide, or play back, to the user, individual, or account holder, any telephone messages recorded by the communication device 20 at the user's, individual's, or account holder's, convenience or at any other time. The user, individual, or account holder, can also program the communication device 20 with, or record, an answering message informing the caller that the message is a call screening message and of the user's, individual's, or account holder's, desire to only receive calls from certain allowed or accepted telephone numbers or from certain allowed or accepted callers. The user, individual, or account holder, can also program the communication device 20 so that the screened telephone call message playback report can be provided to the user, individual, or account holder, at any desired, and/or pre-selected, and/or pre-specified, time interval(s), or daily, weekly, or monthly, or when a pre-selected number of telephone messages have been received or recorded by the communication device 20.

In a preferred embodiment, the communication device 20 can also be pre-programmed to generate a screened telephone call playback report notification message or alert message which can, but need not, contain information, a link, or a hyperlink, to the screened telephone call playback report, and can transmit same to any other communication device 20 used by or associated with the user, individual, or account holder. In a preferred embodiment, the user, individual, or account holder, can, upon or when reviewing or listening to the telephone messages, select to add any telephone number associated with any message to the allowed telephone number(s) list or the accepted telephone number(s) list or can select to add any telephone number associated with any message to the rejected telephone number(s) list. In this regard, the user, individual, or account holder, can select or designate certain of the telephone numbers from which messages are received and/or recorded which can or should be accepted or rejected in the future, or the user, individual, or account holder, can revise, on the fly, and/or while listening to or reviewing the screened telephone call message playback report, the list of allowed telephone numbers or accepted telephone numbers, or the list of rejected telephone numbers, from and via the screened telephone call message playback report.

In a preferred embodiment, the communication device 20 can also be programmed to provide, or to generate and/or transmit a message containing, a list of allowed or accepted telephone numbers and/or a list of rejected telephone numbers to the central processing computer 10, to any other communication device(s) 20 of the user, individual, or account holder, and/or to any respective telephone service provider computer(s) 30, cellular/wireless service provider computer(s) 40, e-mail service provider computer(s) 50, or cable/satellite service provider computer(s) 60, or governmental agency computer(s) 70. The communication device 20 can also be programmed to generate a complaint message containing information for reporting a Do Not Call List violation by a calling party and to transmit same to the central processing computer 10, and/or to any respective telephone service provider computer(s) 30, cellular/wireless service provider computer(s) 40, e-mail service provider computer(s) 50, or cable/satellite service provider computer(s) 60, or governmental agency computer(s) 70.

With reference to FIGS. 8A and 8B, the operation of the apparatus 100 commences at step 800. At step 801, the communication device 20, or the CPU 20A, will await the receiving of an incoming telephone call. At step 802, the communication device 20, or the CPU 20A, will receive the incoming telephone call and receive and process information regarding the caller identification of same so as to identify or ascertain the incoming telephone number or the telephone number of the incoming telephone call. In a preferred embodiment, at step 802, the communication device 20, or the CPU 20A, will process information regarding the incoming telephone call and will not allow the communication device 20 to start ringing, signifying the incoming telephone call, until any and/or all processing regarding same is completed.

At step 803, the communication device 20, or the CPU 20A, can ascertain whether or not the incoming telephone number is an allowed telephone number or an accepted telephone number by comparing the incoming telephone number with or against the list of telephone numbers on the allowed telephone number(s) list or on the accepted telephone number(s) list. If, at step 803, the communication device 20, or the CPU 20A, determines that the incoming telephone number is on the allowed telephone number(s) list or on the accepted telephone number(s) list, then the operation of the apparatus 100 will proceed to step 804 and the communication device 20 will start ringing to allow for the signaling of the incoming telephone call.

At step 804, the user, individual, or account holder, or any other person, can then answer and take the telephone call. After the call is completed, or if the call has not been answered, then the operation of the apparatus 100 will proceed to step 805 and information regarding the time and date of the incoming telephone call, the incoming telephone number, the duration of the call, if answered, or the number of rings, if not answered, can be recorded and stored by the communication device 20, or the CPU 20A, in the database 20H, and/or the time and date of the incoming telephone call and the incoming telephone number can be added to and stored in a missed call list which can be provided to the user, individual, or account holder, or any other person, at any time until cleared or reset by the user, individual, or account holder, or other person. At step 805, any other data and/or information regarding the incoming telephone call, the incoming telephone number, and/or any other information regarding the incoming calling event, can be stored by the communication device 20, or the CPU 20A, in the database 20H. Thereafter, the operation of the apparatus 100 will cease at step 806.

If, at step 803, the communication device 20, or the CPU 20A, determines that the incoming telephone number is not on the allowed telephone number(s) list or not on the accepted telephone number(s) list, then the operation of the apparatus 100 will proceed to step 807. At step 807, the communication device 20, or the CPU 20A, will ascertain whether or not the incoming telephone number is a rejected telephone number by comparing the incoming telephone number with or against the list of telephone numbers on the rejected telephone number(s) list. At step 807, the communication device 20, or the CPU 20A, can also, if so programmed, ascertain whether or not the incoming telephone number is an unknown telephone number, an unidentifiable telephone number, a private telephone number or private number telephone number, or a concealed, hidden, or disguised, telephone number, and can reject the incoming call.

If, at step 807, the communication device 20, or the CPU 20A, determines that the incoming telephone number is on the rejected telephone number(s) list, or that the incoming telephone call is an unknown telephone number, an unidentifiable telephone number, a private telephone number or private number telephone number, or a concealed, hidden, or disguised, telephone number, which should be rejected, then the operation of the apparatus 100 will proceed to step 808 and the communication device 20 will reject the incoming call without allowing the communication device 20 to ring. In this regard, in a preferred embodiment, the apparatus 100 serves to not disturb the user, individual, or account holder, or any other person, with any telephone ringing sound or noise which would otherwise be associated with a rejected telephone number.

Thereafter, the operation of the apparatus 100 will proceed to step 808, and any information regarding the time and date of the rejected incoming telephone call and the rejected incoming telephone number, can be recorded and stored by the communication device 20, or the CPU 20A, in the database 20H, and/or the time and date of the rejected incoming telephone call and the rejected incoming telephone number can be added to and stored in a missed call list which can be provided to the user, individual, or account holder, or any other person, at any time until cleared or reset by the user, individual, or account holder, or other person. At step 808, any other data and/or information regarding the rejected incoming telephone call, the rejected incoming telephone number, and/or any other information regarding the rejected incoming calling event, can be stored by the communication device 20, or the CPU 20A, in the database 20H. At step 808, if applicable, any other data and/or information regarding the unknown telephone number, the unidentifiable telephone number, the private telephone number or private number telephone number, or the concealed, hidden, or disguised, telephone number can also be stored by the communication device 20, or the CPU 20A, in the database 20H. Thereafter, the operation of the apparatus 100 will cease at step 806.

If, at step 807, the communication device 20, or the CPU 20A, determines that the incoming telephone number is not on the rejected telephone number(s) list, then the operation of the apparatus 100 will proceed to step 809. At step 809, the communication device 20, or the CPU 20A, will record and store the incoming telephone number, the time and date of same, and can allow the caller or calling party to leave or record a message, a voice message, a voicemail message, an answering service message, an answering machine message, or voice message or a video and/or audio message, for the user, individual, or account holder, or other person, and/or can record and store any information relating to the incoming telephone number and/or the incoming telephone call. At step 809, the communication device 20, or the CPU 20A, can generate a screened telephone call playback report and/or can store information relating to the incoming telephone call number, any information regarding same, and/or any message, as well as any other information recorded and stored at step 809, in the screened telephone call playback report.

At step 809, the communication device 20, or the CPU 20A, can also generate a screened telephone call playback report notification message or alert message which can, but need not, contain information, a link, or a hyperlink, to the screened telephone call playback report, and/or can transmit same, as an e-mail message and/or as an attachment(s) to an e-mail message, as a text message, or as an audio message, or in or as any other communication transmission, to any other communication device 20 used by or associated with the user, individual, or account holder. At step 809, the user, individual, or account holder, can thereafter, access the screened telephone call playback report notification message or alert message and view or listen to the information or recordings contained in or attached to the screened telephone call playback report notification message or alert message, the screened telephone call playback report, and/or any messages, voice messages, voicemail messages, answering service messages, answering machine messages, or a video and/or audio messages, contained in the screened telephone call playback report.

At step 809, the user, individual, or account holder, can also review the incoming telephone number(s) contained in the screened telephone call playback report and, for each incoming telephone number contained in the screened telephone call playback report, can select or designate same to be either an allowed telephone number or an accepted telephone number to be added to the allowed telephone number(s) list or the accepted telephone number(s) list for future apparatus 100 use, or can select or designate same to be a rejected telephone number to be added to the rejected telephone number(s) list for future apparatus 100 use, or can simply ignore and/or delete the information regarding the incoming telephone call.

At step 809, any information entered into the communication device 20 regarding any selections or designations made by the user, individual, or account holder, can be stored in the communication device and can be transmitted to the central processing computer 10 and can be stored in the database 10H of same. Thereafter, at step 809, the communication device 20, or the CPU 20A, can store any and/or all data and/or information regarding the use or operation of the apparatus 100. Thereafter, the operation of the apparatus 100 will cease at step 806.

In another preferred embodiment, at step 809, the communication device 20, or the CPU 20A, can generate a report containing the allowed telephone number(s) list, or the accepted telephone number(s) list, or the rejected telephone number(s) list, and can transmit same to the central processing computer 10, and/or to any respective telephone service provider computer(s) 30, cellular/wireless service provider computer(s) 40, e-mail service provider computer(s) 50, or cable/satellite service provider computer(s) 60, which services the user's, the individual's, or the account holder's, account, or to a respective governmental agency computer(s) 70, for storage at or in same and/or for later use by same.

In another preferred embodiment, the communication device 20, or the CPU 20A, can also, at step 809, for any and/or each incoming telephone number contained in the screened telephone call playback report, generate a Do Not Call complaint reporting form or report, containing information regarding the respective incoming telephone call, the telephone number from which the telephone call came, the date and time of same, and information reporting same as a violation of the Do Not Call List law or regulation, and can transmit same to the appropriate governmental agency computer 70 so as to report the Do Not Call List violation, and/or can transmit same to the central processing computer(s) 10, and/or to any respective telephone service provider computer(s) 30, cellular/wireless service provider computer(s) 40, e-mail service provider computer(s) 50, or cable/satellite service provider computer(s) 60, for storage at or in same and/or for later use by same. In this regard, the apparatus 100 and/or the communication device 20 can automatically report Do Not Call List violations and/or violators to the appropriate governmental agency or agencies, and/or to the operators of any of the herein-described central processing computer(s) 10, and/or to any respective telephone service provider computer(s) 30, cellular/wireless service provider computer(s) 40, e-mail service provider computer(s) 50, or cable/satellite service provider computer(s) 60.

Although a telephone is described as being utilized in the preferred embodiment of FIGS. 8A and 8B as the communication device 20, it is important to note that the embodiment of FIGS. 8A and 8B can also be utilized in a same, a similar, and/or an analogous, manner using, or in connection with, a line-connected telephone, a home telephone or residential telephone, an office telephone or a telephone used for business purposes or commercial purposes, a cordless telephone, or using, or in connection with, a cellular telephone, a wireless telephone, a smart phone, a Smartphone, a mobile telephone, a personal communications services (PCS) telephone, a personal digital assistant, a video telephone, a videophone, a digital telephone, a facsimile machine, a personal computer, a laptop computer, a notebook computer, a tablet, or a tablet computer, or a wearable communication device, a wearable computer, or any other type or kind of communication device, wireless communication device, cellular communication device, or mobile communication device, which can be adapted, configured, or programmed, to accept, receive, and be used for making or receiving, telephone calls or cellular telephone calls, in order to control, monitor, screen, identify, reject, or report, or prevent the receipt of, unwanted telephone calls.

In this regard, it is important to note that the apparatus 100 of FIGS. 8A and 8B can also be utilized in connection with cellular telephones, cellular communication devices, wireless telephones, smart phones, Smartphones, wireless communication devices, and/or mobile telephone or mobile communication devices, and/or personal digital assistants, or any of the communication devices 20, and/or their equivalents, described herein as being utilized by, with, or in connection with, the apparatus 100 of the present invention in order to control, monitor, screen, identify, reject, or report, or prevent the receipt of, unwanted telephone calls.

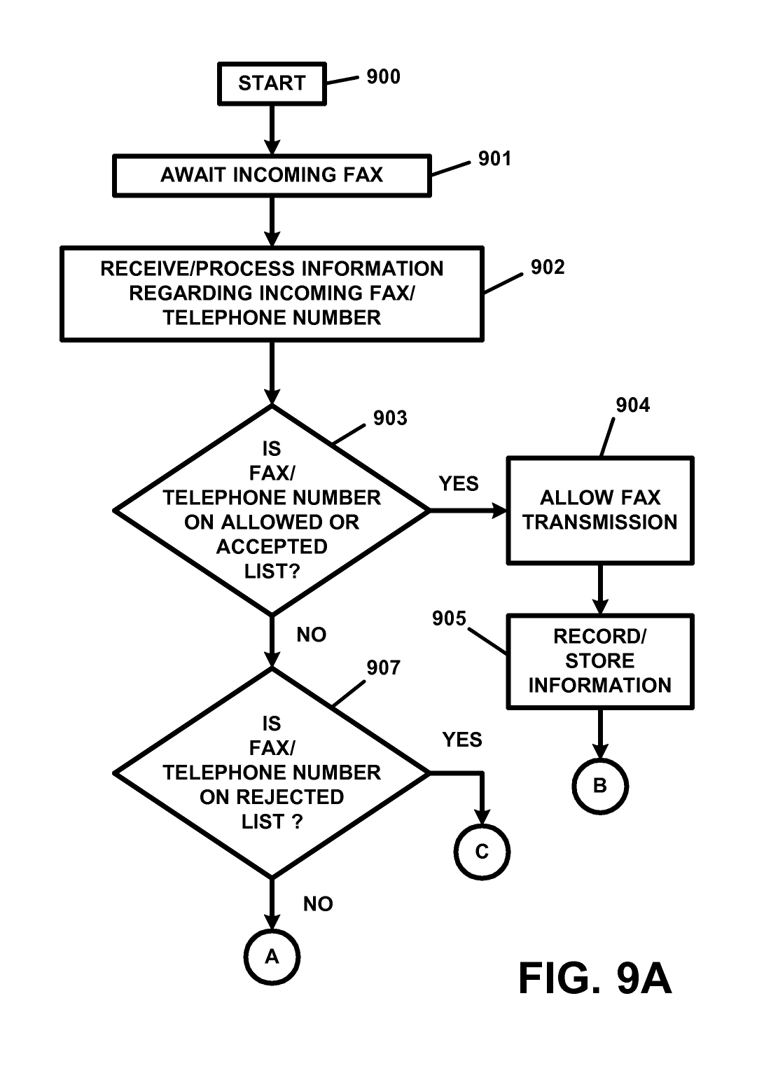

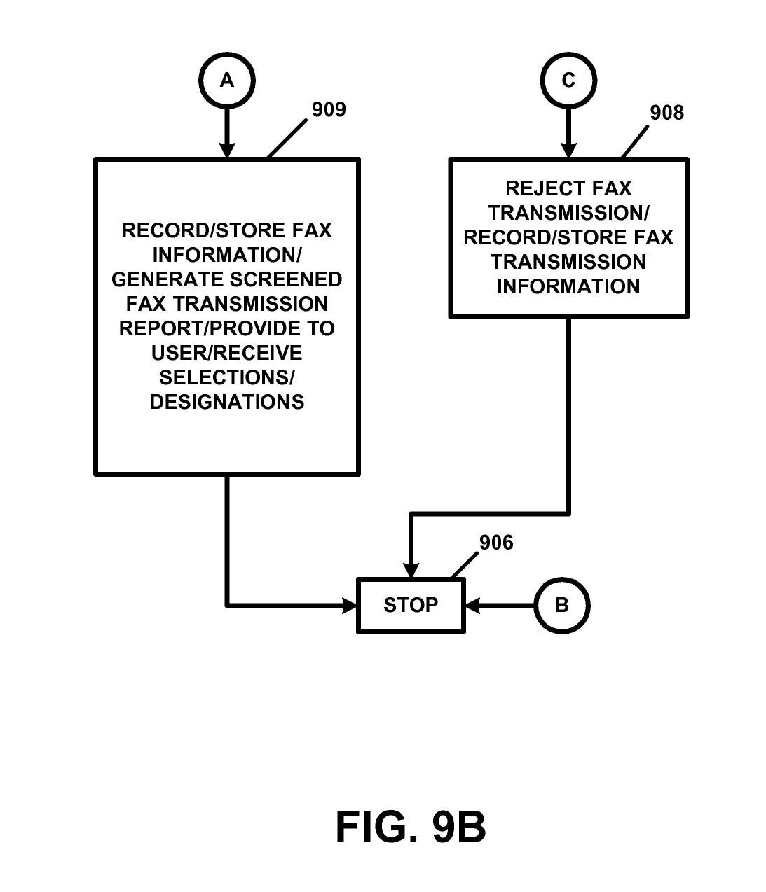

In another preferred embodiment, the apparatus 100 and method of the present invention can be utilized to provide, or can be, a fax machine, or any device which can send or receive fax transmissions, which can screen, identify, reject, and/or report, unwanted fax transmissions. In this preferred embodiment, a fax machine, or any device which can send and/or receive a fax transmission, can be utilized as a, or as the, communication device 20. FIGS. 9A and 9B illustrates a preferred embodiment method for utilizing the apparatus 100 of the present invention, in flow diagram form, in connection with a fax machine which can screen, identify, reject, and/or report, unwanted fax transmissions.

Although a fax machine is described as being utilized as the communication device 20 in the preferred embodiment of FIGS. 9A and 9B, it is important to note that the embodiment of FIGS. 9A and 9B can also be utilized in a same, a similar, and/or an analogous, manner using, or in connection with, a telephone, a line-connected telephone, a home telephone or residential telephone, an office telephone or a telephone used for business purposes or commercial purposes, a cordless telephone, or using, or in connection with, a cellular telephone, a wireless telephone, a smart phone, a Smartphone, a mobile telephone, a personal communications services (PCS) telephone, a personal digital assistant, a video telephone, a videophone, a digital telephone, a facsimile machine, a personal computer, a laptop computer, a notebook computer, a tablet, or a tablet computer, or a wearable communication device, a wearable computer, or any other type or kind of communication device, wireless communication device, cellular communication device, or mobile communication device, which can be adapted, configured, or programmed, to accept, receive, and/or which can be used for transmitting or receiving fax transmissions.

The communication device 20, which is a fax machine, in this preferred embodiment, and which can be referred to as “fax machine” or “communication device 20” in the description of this preferred embodiment, can be pre-programmed by the user, individual, or account holder, with the telephone number(s) or fax number(s) (hereinafter “fax/telephone number(s)”) from which fax transmissions can be received by the fax machine (the “allowed fax/telephone number(s)” or the “accepted fax/telephone number(s)”). In this regard, the user, individual, or account holder, can create an allowed fax/telephone number(s) list or an accepted fax/telephone number(s) list. In a preferred embodiment, the communication device 20 can also be pre-programmed by the user, individual, or account holder, with the fax/telephone number(s) from which fax transmissions are to be, or should be, rejected by the fax machine (the “rejected fax/telephone number(s)”). In this regard, the user, individual, or account holder, can create a rejected fax/telephone number(s) list.

In a preferred embodiment, the user, individual, or account holder, can also pre-program the fax machine to reject fax transmissions from fax/telephone numbers which have not been identified as being allowed fax/telephone number(s) or accepted fax/telephone number(s), or to reject fax transmissions from rejected fax/telephone numbers, or to reject fax transmissions from unknown or unaccepted fax/telephone numbers, or from unknown fax/telephone numbers, from unidentifiable fax/telephone numbers, from private fax/telephone numbers or private number fax/telephone numbers, or from concealed, hidden, or disguised, fax/telephone numbers. In a preferred embodiment, the communication device 20 can also be programmed to receive, screen, and/or record, fax transmissions and associated fax documents or messages from certain fax/telephone numbers, which have not yet been designated or identified as being allowed, accepted, or rejected, while suppressing or preventing the communication device 20 (or the fax machine) from ringing, so as to not disturb the user, individual, or account holder, or other person(s).

In a preferred embodiment, the communication device 20 can also be programmed to generate a screened fax transmission report which can provide, to the user, individual, or account holder, any fax transmission(s) received by the communication device 20 at the user's, individual's, or account holder's, convenience or at any other time. The user, individual, or account holder, can also program the communication device 20 with, or record, an answering message informing the fax transmitter that the message is a fax transmission screening message and of the user's, individual's, or account holder's, desire to only receive fax transmissions from certain allowed or accepted fax/telephone numbers or from certain fax transmitters or transmitting individuals or parties. The user, individual, or account holder, can also program the communication device 20 so that the screened fax transmission report can be provided to the user, individual, or account holder, at any desired, and/or pre-selected, and/or pre-specified, time interval(s), or daily, weekly, or monthly, or when a pre-selected number of fax transmissions have been received or recorded by the communication device 20.

In a preferred embodiment, the communication device 20 can also be pre-programmed to generate a screened fax transmission report notification message or alert message which can, but need not, contain information, a link, or a hyperlink, to the screened fax transmission report, and can transmit same to any other communication device 20 used by or associated with the user, individual, or account holder. In a preferred embodiment, the user, individual, or account holder, can, upon or when reviewing the fax transmission(s), select to add any fax/telephone number associated with any fax transmission to the allowed fax/telephone number(s) list or the accepted fax/telephone number(s) list or can select to add any fax/telephone number associated with any fax transmission to the rejected fax/telephone number(s) list. In this regard, the user, individual, or account holder, can select or designate certain of the fax/telephone numbers from which fax transmissions are received and/or recorded which can or should be accepted or rejected in the future, or the user, individual, or account holder, can revise, on the fly, and/or while reviewing the screened fax transmission report, the list of allowed fax/telephone numbers or accepted fax/telephone numbers, or the list of rejected fax/telephone numbers, from and via the screened fax transmission report.

In a preferred embodiment, the communication device 20 can also be programmed to provide, or to generate and/or transmit a message containing, a list of allowed or accepted fax/telephone numbers and/or a list of rejected fax/telephone numbers to the central processing computer 10, to any other communication device(s) 20 of the user, individual, or account holder, and/or to any respective telephone service provider computer(s) 30, cellular/wireless service provider computer(s) 40, e-mail service provider computer(s) 50, or cable/satellite service provider computer(s) 60, or governmental agency computer(s) 70. The communication device 20 can also be programmed to generate a complaint message containing information for reporting any Do Not Fax List violation by a fax transmitting party and to transmit same to the central processing computer 10, and/or to any respective telephone service provider computer(s) 30, cellular/wireless service provider computer(s) 40, e-mail service provider computer(s) 50, or cable/satellite service provider computer(s) 60, or governmental agency computer(s) 70.

With reference to FIGS. 9A and 9B, the operation of the apparatus 100 commences at step 900. At step 901, the communication device 20, or the CPU 20A, will await the receiving of an incoming fax transmission. At step 902, the communication device 20, or the CPU 20A, will receive the incoming fax transmission and receive and process information regarding the fax transmission transmitter identification of same so as to identify or ascertain the incoming fax/telephone number or the telephone number of the incoming fax transmission. In a preferred embodiment, at step 902, the communication device 20, or the CPU 20A, will process information regarding the incoming fax transmission and will not allow the communication device 20 to start ringing, signifying the incoming fax transmission, until any and/or all processing regarding same is completed.

At step 903, the communication device 20, or the CPU 20A, can ascertain whether or not the incoming fax/telephone number is an allowed fax/telephone number or an accepted fax/telephone number by comparing the incoming fax/telephone number with or against the list of fax/telephone numbers on the allowed fax/telephone number(s) list or on the accepted fax/telephone number(s) list. If, at step 903, the communication device 20, or the CPU 20A, determines that the incoming fax/telephone number is on the allowed fax/telephone number(s) list or on the accepted fax/telephone number(s) list, then the operation of the apparatus 100 will proceed to step 904 and the communication device 20 will start ringing to allow for the signaling of the incoming fax transmission.

At step 904, the communication device 20 can then receive the fax transmission. After the fax transmission is completed, or if it has terminated unsuccessfully, the operation of the apparatus 100 will proceed to step 905 and information regarding the time and date of the incoming fax transmission, the incoming fax/telephone number, the duration of the fax transmission, and the fax transmission document or message, can be recorded and stored by the communication device 20, or the CPU 20A, in the database 20H, and/or the time and date of the incoming fax transmission and the incoming fax/telephone number can be added to and stored in a fax transmission list which can be provided to the user, individual, or account holder, or any other person, at any time until cleared or reset by the user, individual, or account holder, or other person. At step 905, any other data and/or information regarding the incoming fax transmission, the incoming fax/telephone number, and/or any other information regarding the incoming fax transmission event, can be stored by the communication device 20, or the CPU 20A, in the database 20H. Thereafter, the operation of the apparatus 100 will cease at step 906.

If, at step 903, the communication device 20, or the CPU 20A, determines that the incoming fax/telephone number is not on the allowed fax/telephone number(s) list or not on the accepted fax/telephone number(s) list, then the operation of the apparatus 100 will proceed to step 907. At step 907, the communication device 20, or the CPU 20A, can ascertain whether or not the incoming fax transmission is a rejected fax/telephone number by comparing the incoming fax/telephone number with or against the list of fax/telephone numbers on the rejected fax/telephone number(s) list. At step 907, the communication device 20, or the CPU 20A, can also, if so programmed, ascertain whether or not the incoming fax/telephone number is an unknown fax/telephone number, an unidentifiable fax/telephone number, a private fax/telephone number or private number fax/telephone number, or a concealed, hidden, or disguised, fax/telephone number, and can reject the incoming fax transmission.

If, at step 907, the communication device 20, or the CPU 20A, determines that the incoming fax/telephone number is on the rejected fax/telephone number(s) list, or that the incoming fax/telephone call is an unknown fax/telephone number, an unidentifiable fax/telephone number, a private fax/telephone number or private number fax/telephone number, or a concealed, hidden, or disguised, fax/telephone number, which should be rejected, then the operation of the apparatus 100 will proceed to step 908 and the communication device 20 will reject the incoming fax transmission without allowing the communication device 20 to ring. In this regard, in a preferred embodiment, the apparatus 100 serves to not disturb the user, individual, or account holder, or any other person, with any fax machine ringing sound or noise which would otherwise be associated with a rejected fax transmission. Thereafter, the operation of the apparatus 100 will proceed to step 908, and any information regarding the time and date of the rejected incoming fax transmission and the rejected incoming fax/telephone number, can be recorded and stored by the communication device 20, or the CPU 20A, in the database 20H, and/or the time and date of the rejected incoming fax transmission and the rejected incoming fax/telephone number can be added to and stored in a fax transmission list which can be provided to the user, individual, or account holder, or any other person, at any time until cleared or reset by the user, individual, or account holder, or other person.

At step 908, any other data and/or information regarding the rejected incoming fax transmission, the rejected incoming fax/telephone number, and/or any other information regarding the rejected incoming fax transmission event, can be stored by the communication device 20, or the CPU 20A, in the database 20H. At step 908, if applicable, any other data and/or information regarding the unknown fax/telephone number, the unidentifiable fax/telephone number, the private fax/telephone number or private number fax/telephone number, or the concealed, hidden, or disguised, fax/telephone number can also be stored by the communication device 20, or the CPU 20A, in the database 20H. Thereafter, the operation of the apparatus 100 will cease at step 906.

If, at step 907, the communication device 20, or the CPU 20A, determines that the incoming fax/telephone number is not on the rejected fax/telephone number(s) list, then the operation of the apparatus 100 will proceed to step 909. At step 909, the communication device 20, or the CPU 20A, will record and store the incoming fax/telephone number, the time and date of same, any content, document(s), or message(s) included in the fax transmission, and/or can allow the fax transmission to be received and recorded. At step 909, the communication device 20, or the CPU 20A, can also record and store any information relating to the incoming fax/telephone number and/or the incoming fax transmission. At step 909, the communication device 20, or the CPU 20A, can generate a screened fax transmission report and can store information relating to the incoming fax/telephone number, the incoming fax transmission, any content, document(s), or message(s) included in the incoming fax transmission, as well as any other information recorded and stored at step 909, in the screened fax transmission report.

At step 909, the communication device 20, or the CPU 20A, can also generate a screened fax transmission report notification message or alert message which can, but need not, contain information, a link, or a hyperlink, to the screened fax transmission report, and/or can transmit same, as an e-mail message and/or as an attachment(s) to an e-mail message, as a text message, or in or as any other communication transmission, to any other communication device 20 used by or associated with the user, individual, or account holder.

At step 909, the user, individual, or account holder, can thereafter, access the screened fax transmission report notification message or alert message and view the information or document(s) or message(s) contained in or attached to the screened fax transmission report notification message or alert message, the screened fax transmission report, and/or any document(s) or message(s) contained in the screened fax transmission report. At step 909, the user, individual, or account holder, can also review the incoming fax/telephone number(s) contained in the screened fax transmission report and, for each incoming fax/telephone number contained in the screened fax transmission report, can select or designate same to be either an allowed fax/telephone number or an accepted fax/telephone number to be added to the allowed fax/telephone number(s) list or the accepted fax/telephone number(s) list for future apparatus 100 use, or can select or designate same to be a rejected fax/telephone number to be added to the rejected fax/telephone number(s) list for future apparatus 100 use, or can simply ignore and/or delete the information regarding the incoming fax transmission.

At step 909, any information entered into the communication device 20 regarding any selections or designations made by the user, individual, or account holder, can be stored in the communication device and can be transmitted to the central processing computer 10 and can be stored in the database 10H of same. Thereafter, at step 909, the communication device 20, or the CPU 20A, can store any and/or all data and/or information regarding the use or operation of the apparatus 100. Thereafter, the operation of the apparatus 100 will cease at step 906.

In another preferred embodiment, at step 909, the communication device 20, or the CPU 20A, can generate a report containing the allowed fax/telephone number(s) list, or the accepted fax/telephone number(s) list, or the rejected fax/telephone number(s) list, and can transmit same to the central processing computer 10, and/or to any respective telephone service provider computer(s) 30, cellular/wireless service provider computer(s) 40, e-mail service provider computer(s) 50, or cable/satellite service provider computer(s) 60, which services the user's, the individual's, or the account holder's, account, or to a respective governmental agency computer(s) 70, for storage at or in same and/or for later use by same.

In another preferred embodiment, the communication device 20, or the CPU 20A, can also, at step 909, for any and/or each incoming fax/telephone number contained in the screened fax transmission report, generate a Do Not Fax complaint reporting form or report, containing information regarding the respective incoming fax transmission, the fax/telephone number from which the fax transmission was sent or transmitted, the date and time of same, and information reporting same as a violation of any Do Not Fax List law or regulation, and can transmit same to the appropriate governmental agency computer 70 so as to report the Do Not Fax List violation, and/or can transmit same to the central processing computer(s) 10, and/or to any respective telephone service provider computer(s) 30, cellular/wireless service provider computer(s) 40, e-mail service provider computer(s) 50, or cable/satellite service provider computer(s) 60, for storage at or in same and/or for later use by same. In this regard, the apparatus 100 and/or the communication device 20 can automatically report Do Not Fax List violations and/or violators to the appropriate governmental agency or agencies, and/or to the operators of any of the herein-described central processing computer(s) 10, and/or to any respective telephone service provider computer(s) 30, cellular/wireless service provider computer(s) 40, e-mail service provider computer(s) 50, or cable/satellite service provider computer(s) 60.

Although a fax machine is described as being utilized in the preferred embodiment of FIGS. 9A and 9B as the communication device 20, it is important to note that the embodiment of FIGS. 9A and 9B can also be utilized in a same, a similar, and/or an analogous, manner using, or in connection with, a line-connected telephone, a home telephone or residential telephone, an office telephone or a telephone used for business purposes or commercial purposes, a cordless telephone, or using, or in connection with, a cellular telephone, a wireless telephone, a smart phone, a Smartphone, a mobile telephone, a personal communications services (PCS) telephone, a personal digital assistant, a video telephone, a videophone, a digital telephone, a facsimile machine, a personal computer, a laptop computer, a notebook computer, a tablet, or a tablet computer, or a wearable communication device, a wearable computer, or any other type or kind of communication device, wireless communication device, cellular communication device, or mobile communication device, which can be adapted, configured, or programmed, to accept, receive, and/or be used for sending or receiving, fax transmissions, in order to control, monitor, screen, identify, reject, or report, or prevent the receipt of, unwanted fax transmissions.

In this regard, it is important to note that the apparatus 100 of FIGS. 9A and 9B can also be utilized in connection with any of the herein-described communication devices 20, and/or their equivalents, described herein as being utilized by, with, or in connection with, the apparatus 100 of the present invention in order to control, monitor, screen, identify, reject, or report, or prevent the receipt of, unwanted fax transmissions.

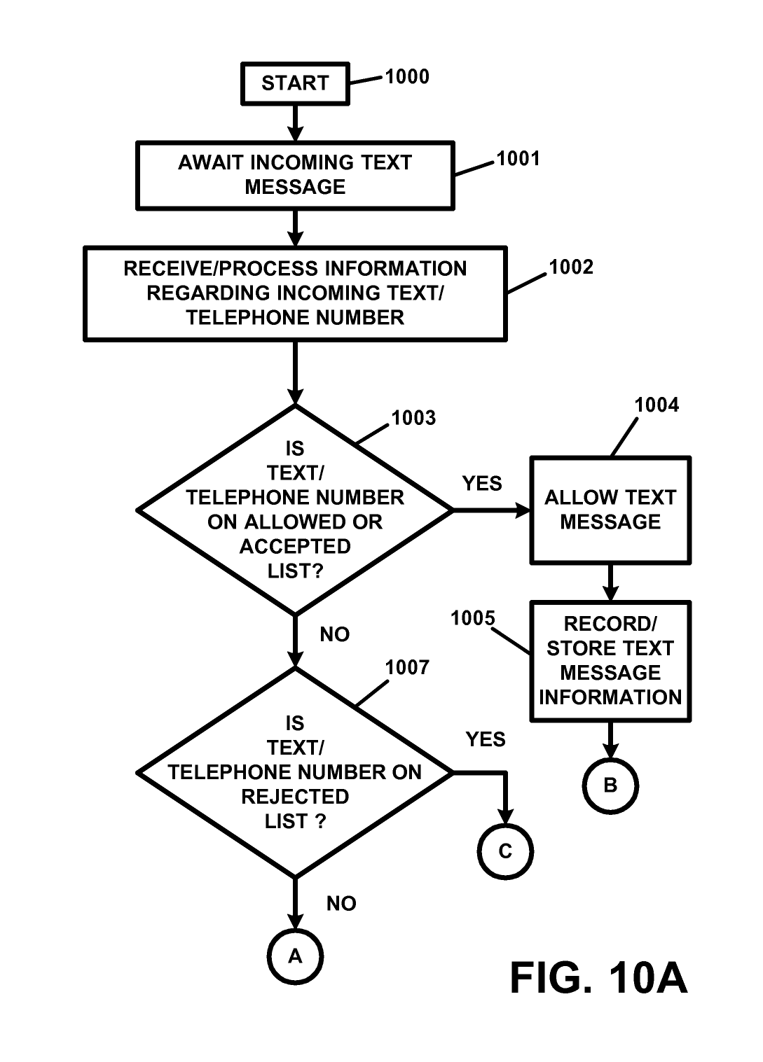

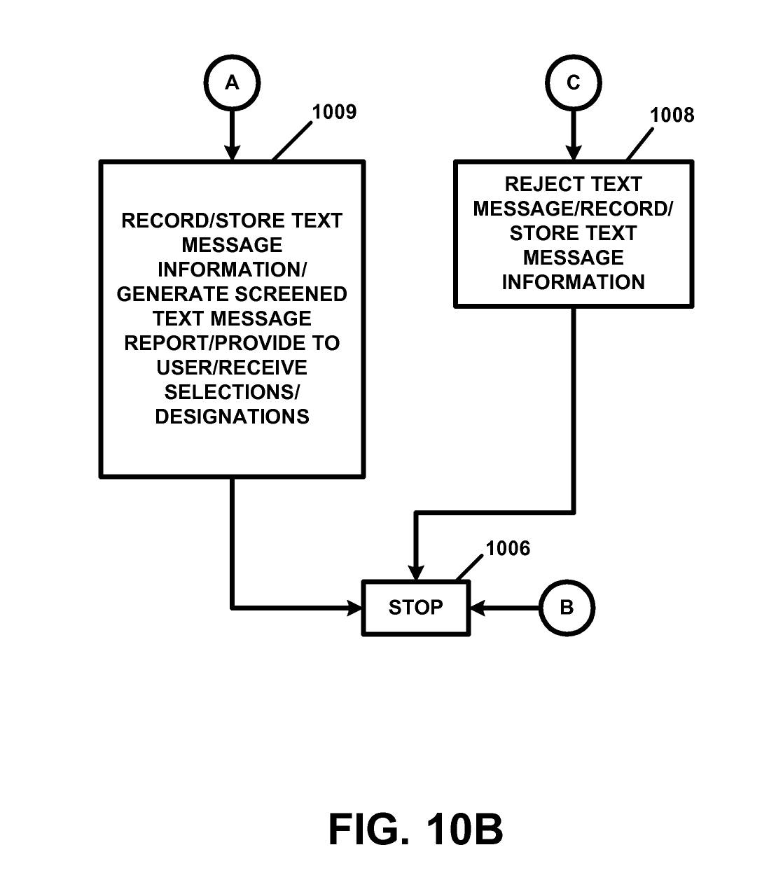

In another preferred embodiment, the apparatus 100 and method of the present invention can be utilized to provide, or can be, a cellular telephone, a wireless telephone, a smart phone, a Smartphone, a mobile telephone, a personal communications services (PCS) telephone, or a personal digital assistant, or any of the other herein-described communication devices 20 which can have the capability to send and/or receive text messages, SMS messages, or MMS messages, or any other messages or messaging data and/or information, which can screen, identify, reject, and/or report, unwanted text messages, unwanted SMS messages, unwanted MMS messages, or any other unwanted messages or messaging data and/or information. In this preferred embodiment, a cellular telephone can be used as a, or as the, communication device 20. FIGS. 10A and 10B illustrates a preferred embodiment method for utilizing the apparatus 100 of the present invention, in flow diagram form, in connection with a cellular telephone which can screen, identify, reject, and/or report, unwanted text messages.

Although a cellular telephone is described as being utilized as the communication device 20 in the preferred embodiment of FIGS. 10A and 10B, it is important to note that the embodiment of FIGS. 10A and 10B can also be utilized in a same, a similar, and/or an analogous, manner using, or in connection with, a telephone, a line-connected telephone, a home telephone or residential telephone, an office telephone or a telephone used for business purposes or commercial purposes, a cordless telephone, or using, or in connection with, a cellular telephone, a wireless telephone, a smart phone, a Smartphone, a mobile telephone, a personal communications services (PCS) telephone, a personal digital assistant, a video telephone, a videophone, a digital telephone, a facsimile machine, a personal computer, a laptop computer, a notebook computer, a tablet, or a tablet computer, or a wearable communication device, a wearable computer, or any other type or kind of communication device, wireless communication device, cellular communication device, or mobile communication device, which can be adapted, configured, or programmed, to send, receive, and/or which can be used for sending or receiving, text messages.

Although the embodiment of FIGS. 10A and 10B is described as being used for screening, identifying, rejecting, and/or reporting, unwanted text messages, it is important to note that the apparatus 100 of the preferred embodiment of FIGS. 10A and 10B can also be utilized in a same, a similar, and/or an analogous, manner to screen, identify, reject, and/or report, unwanted SMS messages, unwanted MMS messages, or any other unwanted messages or messaging data and/or information.

The communication device 20, which is a cellular telephone (“a cellular telephone communication device 20”) in this preferred embodiment, and which can be referred to as “cellular telephone” or as a “communication device 20” in the description of this preferred embodiment, can be pre-programmed by the user, individual, or account holder, with the telephone number(s) or cellular telephone number(s) (hereinafter “telephone number(s)”) from which text messages can be received by the cellular telephone (the “allowed text/telephone number(s)” or the “accepted text/telephone number(s)”). In this regard, the user, individual, or account holder, can create an allowed text/telephone number(s) list or an accepted text/telephone number(s) list. In a preferred embodiment, the communication device 20 can also be pre-programmed by the user, individual, or account holder, with the text/telephone number(s) from which text messages are to be, or should be, rejected by the cellular telephone (the “rejected text/telephone number(s)”). In this regard, the user, individual or account holder, can create a rejected text telephone number(s) list.

In a preferred embodiment, the user, individual, or account holder, can also pre-program the cellular telephone or communication device 20 to reject text messages from text/telephone numbers which have not been identified as being allowed text/telephone number(s) or accepted text/telephone number(s), or to reject text messages from rejected text/telephone numbers, or to reject text messages from unknown or unaccepted text/telephone numbers, or from unknown text/telephone numbers, from unidentifiable text/telephone numbers, from private text/telephone numbers or private number text/telephone numbers, or from concealed, hidden, or disguised, text/telephone numbers. In a preferred embodiment, the communication device 20 can also be programmed to receive, screen, and/or record, text messages and any associated pictures, video clips, or audio clips, from certain text/telephone numbers, which have not yet been designated or identified as being allowed, accepted, or rejected, while suppressing or preventing the communication device 20 from making any sound and/or from vibrating, so as to not disturb the user, individual, or account holder, or other persons.

In a preferred embodiment, the communication device 20 can also be programmed to generate a screened text message report which can provide the user, individual, or account holder, with any text messages, and/or any pictures, video clips, or audio clips associated therewith, recorded or stored by the communication device 20 at the user's, individual's, or account holder's, convenience or at any other time. The user, individual, or account holder, can also program the communication device 20 with, or record, a reply text message informing the texting individual or party that the reply text message is a text message screening message and of the user's, individual's, or account holder's, desire to only receive text messages from certain allowed or accepted text/telephone numbers or from certain allowed or accepted texting individuals or parties. The user, individual, or account holder, can also program the communication device 20 so that the screened text message report can be provided to the user, individual, or account holder, at any desired, and/or pre-selected, and/or pre-specified, time interval(s), or daily, weekly, or monthly, or when a pre-selected number of text messages have been received or recorded by the communication device 20.

In a preferred embodiment, the communication device 20 can also be pre-programmed to generate a screened text message report notification message or alert message which can, but need not, contain information, a link, or a hyperlink, to the screened text message report, and can transmit same to any other communication device 20 used by or associated with the user, individual, or account holder. In a preferred embodiment, the user, individual, or account holder, can, upon or when reviewing the text messages, select to add any text/telephone number associated with any text message to the allowed text/telephone number(s) list or the accepted text/telephone number(s) list or can select to add any telephone number associated with any text message to the rejected text/telephone number(s) list. In this regard, the user, individual, or account holder, can select or designate certain of the text/telephone numbers from which text messages are received and/or recorded which can or should be accepted or rejected in the future, or the user, individual, or account holder, can revise, on the fly, and/or while reviewing the screened text message report, the list of allowed text/telephone numbers or accepted text/telephone numbers, or the list of rejected text/telephone numbers, from and via the screened text message report.

In a preferred embodiment, the communication device 20 can also be programmed to provide, or to generate and/or transmit a message containing, a list of allowed or accepted text/telephone numbers and/or a list of rejected text/telephone numbers to the central processing computer 10, or to any other communication device(s) 20 of the user, individual, or account holder, and/or to any respective telephone service provider computer(s) 30, cellular/wireless service provider computer(s) 40, e-mail service provider computer(s) 50, or cable/satellite service provider computer(s) 60, or governmental agency computer(s) 70. The communication device 20 can also be programmed to generate a complaint message containing information for reporting a Do Not Text List violation by a texting individual or party and to transmit same to the central processing computer 10, and/or to any respective telephone service provider computer(s) 30, cellular/wireless service provider computer(s) 40, e-mail service provider computer(s) 50, or cable/satellite service provider computer(s) 60, or governmental agency computer(s) 70.

With reference to FIGS. 10A and 10B, the operation of the apparatus 100 commences at step 1000. At step 1001, the communication device 20, or the CPU 20A, will await the receiving of an incoming text message. At step 1002, the communication device 20, or the CPU 20A, will receive the incoming text message and receive and process information regarding the text/telephone number associated with same so as to identify or ascertain the incoming text/telephone number of the incoming text message. In a preferred embodiment, at step 1002, the communication device 20, or the CPU 20A, will process information regarding the incoming text message and will not allow the communication device 20 to make any sound and/or vibrate, signifying the incoming text message, until any and/or all processing regarding same is completed. At step 1003, the communication device 20, or the CPU 20A, can ascertain whether or not the text/telephone number associated with the incoming text message is an allowed text/telephone number or an accepted text/telephone number by comparing the incoming text/telephone number with or against the list of text/telephone numbers on the allowed text/telephone number(s) list or on the accepted text/telephone number(s) list.

If, at step 1003, the communication device 20, or the CPU 20A, determines that the incoming text/telephone number is on the allowed text/telephone number(s) list or on the accepted text/telephone number(s) list, then the operation of the apparatus 100 will proceed to step 1004 and the communication device 20 will commence making a sound and/or vibrating to allow for the signaling of the incoming text message, and the text message will be provided via, or will be allowed to be accessed via, the communication device 20.

At step 1004, the user, individual, or account holder, or any other person, can then retrieve and review the text message. After the text message has been read or reviewed, or has not been read or reviewed, then the operation of the apparatus 100 will proceed to step 1005 and information regarding the time and date of the incoming text message, and/or the incoming text/telephone number, and/or any picture(s), video clip(s), or audio clip(s) which was include in or with, or which accompanied, the text message, can be recorded and stored by the communication device 20, or the CPU 20A, in the database 20H, and/or the time and date of the incoming text message and the incoming text/telephone number can be added to and stored in a missed text message list which can be provided to the user, individual, or account holder, or any other person, at any time until cleared or reset by the user, individual, or account holder, or other person. At step 1005, any other data and/or information regarding the incoming text message, the incoming text/telephone number, and/or any other information regarding the incoming text messaging event, can be stored by the communication device 20, or the CPU 20A, in the database 20H. Thereafter, the operation of the apparatus 100 will cease at step 1006.

If, at step 1003, the communication device 20, or the CPU 20A, determines that the incoming text/telephone number is not on the allowed text/telephone number(s) list or not on the accepted text/telephone number(s) list, then the operation of the apparatus 100 will proceed to step 1007. At step 1007, the communication device 20, or the CPU 20A, can ascertain whether or not the incoming text/telephone number is a rejected text/telephone number by comparing the incoming text/telephone number with or against the list of text/telephone numbers on the rejected text/telephone number(s) list. At step 1007, the communication device 20, or the CPU 20A, can also, if so programmed, ascertain whether or not the incoming text/telephone number is an unknown text/telephone number, an unidentifiable text/telephone number, a private text/telephone number or private number text/telephone number, or a concealed, hidden, or disguised, text/telephone number, and can reject the incoming text message.

If, at step 1007, the communication device 20, or the CPU 20A, determines that the incoming text/telephone number is on the rejected text/telephone number(s) list, or that the incoming text message is sent from an unknown text/telephone number, an unidentifiable text/telephone number, a private text/telephone number or private number text/telephone number, or a concealed, hidden, or disguised, text/telephone number, which should be rejected, then the operation of the apparatus 100 will proceed to step 1008 and the communication device 20 will reject the incoming text message without allowing the communication device 20 to make any sound or vibrate. In this regard, in a preferred embodiment, the apparatus 100 serves to not disturb the user, individual, or account holder, or any other person, with any sounds or vibrations or other noise which would otherwise be associated with a rejected text message.

Thereafter, the operation of the apparatus 100 will proceed to step 1008, and any information regarding the time and date of the rejected incoming text message and the rejected incoming text/telephone number, can be recorded and stored by the communication device 20, or the CPU 20A, in the database 20H, and/or the time and date of the rejected incoming text message and the rejected incoming text/telephone number can be added to and stored in a missed text message list which can be provided to the user, individual, or account holder, or any other person, at any time until cleared or reset by the user, individual, or account holder, or other person. At step 1008, any other data and/or information regarding the rejected incoming text message, the rejected incoming text/telephone number, and/or any other information regarding the rejected incoming text messaging event, can be stored by the communication device 20, or the CPU 20A, in the database 20H. At step 1008, if applicable, any other data and/or information regarding the unknown text/telephone number, the unidentifiable text/telephone number, the private text/telephone number or private number text/telephone number, or the concealed, hidden, or disguised, text/telephone number can also be stored by the communication device 20, or the CPU 20A, in the database 20H. Thereafter, the operation of the apparatus 100 will cease at step 1006.

If, at step 1007, the communication device 20, or the CPU 20A, determines that the incoming text telephone number is not on the rejected text/telephone number(s) list, then the operation of the apparatus 100 will proceed to step 1009. At step 1009, the communication device 20, or the CPU 20A, will record and store the incoming text/telephone number, the time and date of same, the content of the incoming text message, any picture(s), video clip(s), or audio clip(s) included in or with the text message, and/or can allow the texting individual or party to record a message, a voice message, a voicemail message, an answering service message, an answering machine message, or voice message or a video and/or audio message, for the user, individual, or account holder, or other person, and/or can store information relating to the incoming text/telephone number and/or the incoming text message. At step 1009, the communication device 20, or the CPU 20A, can generate a screened text message report and/or can store information relating to the incoming text/telephone number, any information regarding same, and/or the incoming text message, or any other information contained in or with the incoming text message, as well as any other information recorded and stored at step 1009, in the screened text message report.

At step 1009, the communication device 20, or the CPU 20A, can also generate a screened text message report notification message or alert message which can, but need not, contain information, a link, or a hyperlink, to the screened text message report, and/or can transmit same, as an e-mail message and/or as an attachment(s) to an e-mail message, as a text message, or as an audio message, or in or as any other communication transmission, to any other communication device 20 used by or associated with the user, individual, or account holder. At step 1009, the user, individual, or account holder, can thereafter, access the screened text message report notification message or alert message and review the information, picture(s), video clip(s), or audio clip(s), or recordings, contained in or attached to the screened text message report notification message or alert message, the screened text message report, and/or any messages, voice messages, voicemail messages, answering service messages, answering machine messages, or video and/or audio messages, contained in the screened text message report.

At step 1009, the user, individual, or account holder, can also review the incoming text/telephone number(s) contained in the screened text message report and, for each incoming text/telephone number contained in the screened text message report, can select or designate same to be either an allowed text/telephone number or an accepted text/telephone number to be added to the allowed text/telephone number(s) list or the accepted text/telephone number(s) list for future apparatus 100 use, or can select or designate same to be a rejected text/telephone number to be added to the rejected text/telephone number(s) list for future apparatus 100 use, or can simply ignore and/or delete the information regarding the incoming text message.

At step 1009, any information entered into the communication device 20 regarding any selections or designations made by the user, individual, or account holder, can be stored in the communication device and can be transmitted to the central processing computer 10 and can be stored in the database 10H of same. Thereafter, at step 1009, the communication device 20, or the CPU 20A, can store any and/or all data and/or information regarding the use or operation of the apparatus 100. Thereafter, the operation of the apparatus 100 will cease at step 1006.

In another preferred embodiment, at step 1009, the communication device 20, or the CPU 20A, can generate a report containing the allowed text/telephone number(s) list, or the accepted text/telephone number(s) list, or the rejected text/telephone number(s) list, and can transmit same to the central processing computer 10, and/or to any respective telephone service provider computer(s) 30, cellular/wireless service provider computer(s) 40, e-mail service provider computer(s) 50, or cable/satellite service provider computer(s) 60, which services the user's, the individual's, or the account holder's, account, or to a respective governmental agency computer(s) 70, for storage at or in same and/or for later use by same.

In another preferred embodiment, the communication device 20, or the CPU 20A, can also, at step 1009, for any and/or each incoming text/telephone number contained in the screened text message report, generate a Do Not Text complaint reporting form or report, containing information regarding the respective incoming text message, the text/telephone number from which the text message was sent or transmitted, the date and time of same, and/or information reporting same as a violation of any Do Not Text List law or regulation, and can transmit same to the appropriate governmental agency computer 70 so as to report the Do Not Text List violation, and/or can transmit same to the central processing computer(s) 10, and/or to any respective telephone service provider computer(s) 30, cellular/wireless service provider computer(s) 40, e-mail service provider computer(s) 50, or cable/satellite service provider computer(s) 60, for storage at or in same and/or for later use by same. In this regard, the apparatus 100 and/or the communication device 20 can automatically report Do Not Text List violations and/or violators to the appropriate governmental agency or agencies, and/or to the operators of any of the herein-described central processing computer(s) 10, and/or to any respective telephone service provider computer(s) 30, cellular/wireless service provider computer(s) 40, e-mail service provider computer(s) 50, or cable/satellite service provider computer(s) 60.

Although a cellular telephone is described as being utilized in the preferred embodiment of FIGS. 10A and 10B as the communication device 20, it is important to note that the embodiment of FIGS. 10A and 10B can also be utilized in a same, a similar, and/or an analogous, manner using, or in connection with, a telephone, a line-connected telephone, a home telephone or residential telephone, an office telephone or a telephone used for business purposes or commercial purposes, a cordless telephone, or using, or in connection with, a cellular telephone, a wireless telephone, a smart phone, a Smartphone, a mobile telephone, a personal communications services (PCS) telephone, a personal digital assistant, a video telephone, a videophone, a digital telephone, a facsimile machine, a personal computer, a laptop computer, a notebook computer, a tablet, or a tablet computer, or a wearable communication device, a wearable computer, or any other type or kind of communication device, wireless communication device, cellular communication device, or mobile communication device, or any communication device 20 described herein and/or any equivalents of same, which can be adapted, configured, or programmed, to accept, receive, and be used for sending or receiving, text messages in order to control, monitor, screen, identify, reject, or report, or prevent the receipt of, unwanted text messages.

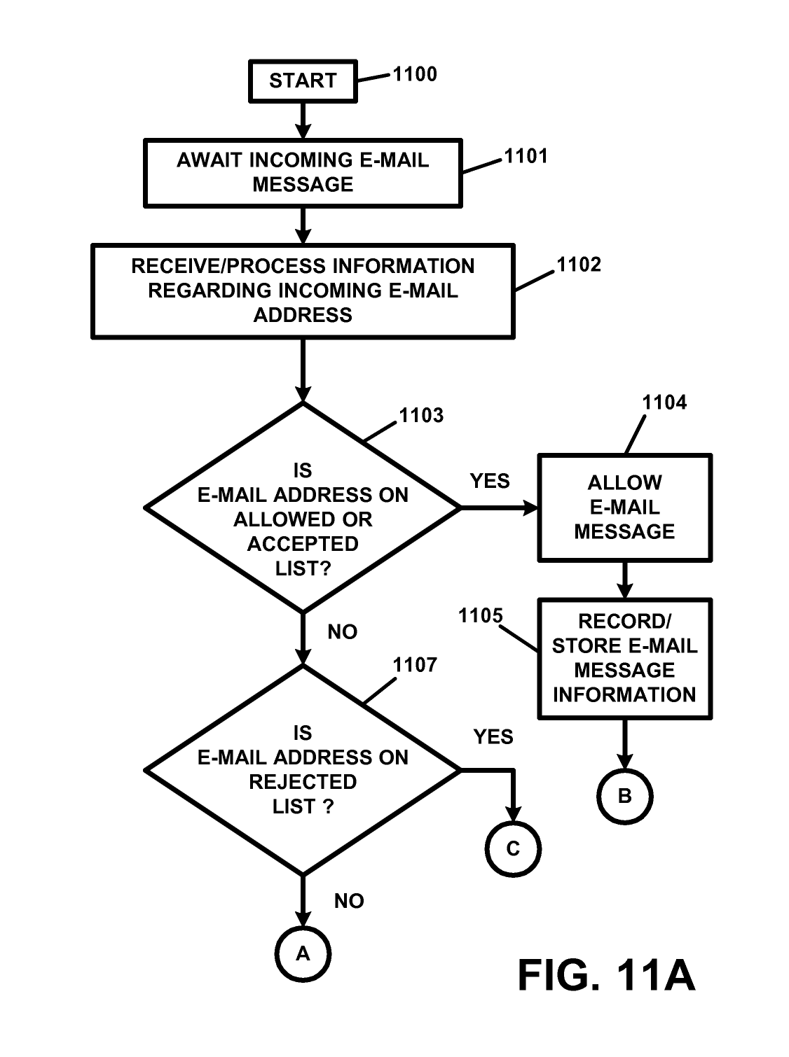

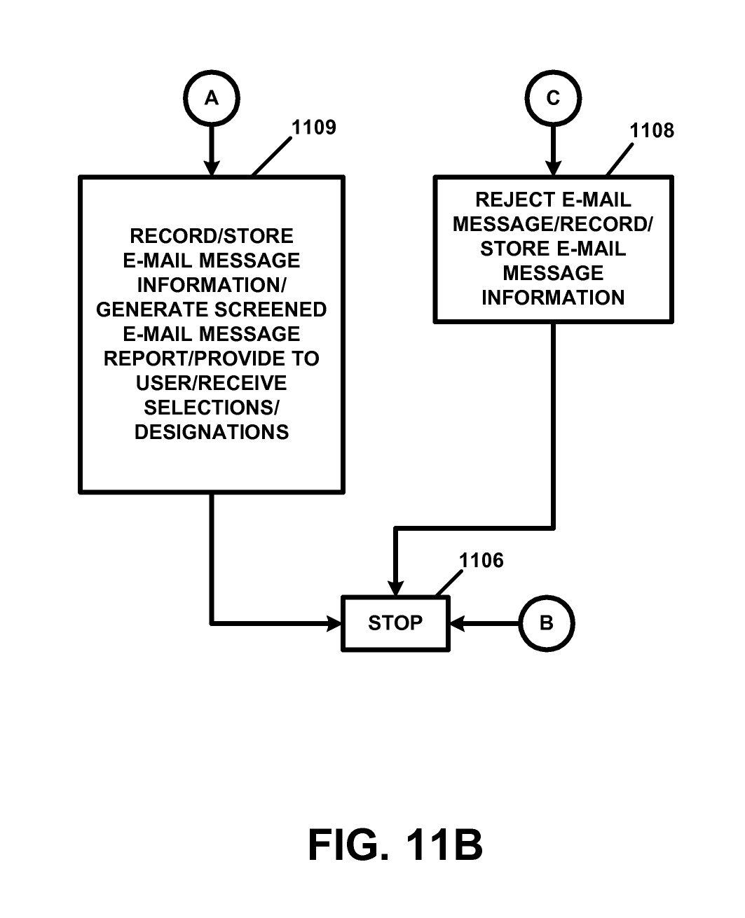

In another preferred embodiment, the apparatus 100 and method of the present invention can be utilized to provide, or can be, a personal computer, a laptop computer, a notebook computer, a tablet computer, a tablet, a cellular telephone, a wireless telephone, a smart phone, a Smartphone, a mobile telephone, a personal communications services (PCS) telephone, or a personal digital assistant, or any of the other herein-described communication devices 20 which can have the capability to send and/or receive e-mail messages or any other communications transmitted from IP addresses, which can screen, identify, reject, and/or report, unwanted e-mail messages or unwanted instant messages, or any other unwanted communications. In this preferred embodiment, a personal computer can be used as a, or as the, communication device 20. FIGS. 11A and 11B illustrates a preferred embodiment method for utilizing the apparatus 100 of the present invention, in flow diagram form, in connection with a personal computer which can screen, identify, reject, and/or report, unwanted e-mail messages.

Although a personal computer is described as being utilized as the communication device 20 in the preferred embodiment of FIGS. 11A and 11B, it is important to note that the embodiment of FIGS. 11A and 11B can also be utilized in a same, a similar, and/or an analogous, manner using, or in connection with, a telephone, a line-connected telephone, a home telephone or residential telephone, an office telephone or a telephone used for business purposes or commercial purposes, a cordless telephone, or using, or in connection with, a cellular telephone, a wireless telephone, a smart phone, a Smartphone, a mobile telephone, a personal communications services (PCS) telephone, a personal digital assistant, a video telephone, a videophone, a digital telephone, a facsimile machine, a laptop computer, a notebook computer, a tablet, or a tablet computer, or a wearable communication device, a wearable computer, or any other type or kind of communication device, wireless communication device, cellular communication device, or mobile communication device, which can be adapted, configured, or programmed, to send, receive, and/or which can be used for sending or receiving, e-mail messages.

Although the apparatus 100 of the preferred embodiment of FIGS. 11A and 11B is described as being used for screening, identifying, rejecting, and/or reporting, unwanted e-mail messages, it is important to note that the apparatus 100 of the preferred embodiment of FIGS. 11A and 11B can also be utilized in a same, a similar, and/or an analogous, manner to screen, identify, reject, and/or report, unwanted instant messages or any other unwanted communications which are, or can be, transmitted from any IP address.

The communication device 20, which is a personal computer in this preferred embodiment, and which can be referred to as “personal computer” or “communication device 20” in the description of this preferred embodiment, can be pre-programmed by the user, individual, or account holder, with the e-mail addresses from which e-mail messages can be received by the personal computer (the “allowed e-mail address(es)” or the “accepted e-mail address(es)”. In this regard, the user, individual, or account holder, can create an allowed e-mail address(es) list or an accepted e-mail address(es) list. In a preferred embodiment, the communication device 20 can also be pre-programmed by the user, individual, or account holder, with the e-mail address(es) from which e-mail messages are to be, or should be, rejected by the personal computer (the “rejected e-mail address(es)”). In this regard, the user, individual or account holder, can create a rejected e-mail address(es) list.

In a preferred embodiment, the user, individual, or account holder, can also pre-program the personal computer to reject e-mail messages from e-mail addresses which have not been identified as being allowed e-mail addresses or accepted e-mail addresses, or to reject e-mail messages from rejected e-mail addresses, or to reject e-mail messages from unknown or unaccepted e-mail addresses, or from unknown e-mail addresses, from unidentifiable e-mail addresses, from private e-mail addresses, or from concealed, hidden, or disguised, e-mail addresses. In a preferred embodiment, the communication device 20 can also be programmed to receive, screen, and/or record, e-mail messages and any associated or attached documents, pictures, video clips, or audio clips, from certain e-mail addresses, which have not yet been designated or identified as being allowed, accepted, or rejected, while suppressing or preventing the communication device 20 from making any sound and/or from providing any other e-mail receipt indication, so as to not disturb the user, individual, or account holder, or other persons.

In a preferred embodiment, the communication device 20 can also be programmed to generate a screened e-mail message report which can provide the user, individual, or account holder, with any e-mail messages, and/or any documents, pictures, video clips, or audio clips, attached thereto or associated therewith, recorded or stored by the communication device 20 at the user's, individual's, or account holder's, convenience or at any other time. The user, individual, or account holder, can also program the communication device 20 with, or record, a reply e-mail message informing the e-mail sending individual or party that the reply e-mail message is an e-mail message screening message and of the user's, individual's, or account holder's, desire to only receive e-mail messages from certain allowed or accepted e-mail addresses or from certain e-mailing individuals or parties. The user, individual, or account holder, can also program the communication device 20 so that the screened e-mail message report can be provided to the user, individual, or account holder, at any desired, and/or pre-selected, and/or pre-specified, time interval(s), or daily, weekly, or monthly, or when a pre-selected number of e-mail messages have been received or recorded by the communication device 20.

In a preferred embodiment, the communication device 20 can also be pre-programmed to generate a screened e-mail message report notification message or alert message which can, but need not, contain information, a link, or a hyperlink, to the screened e-mail message report, and can transmit same to any other communication device 20 used by or associated with the user, individual, or account holder. In a preferred embodiment, the user, individual, or account holder, can, upon or when reviewing the e-mail messages, select to add any e-mail address associated with any e-mail message to the allowed e-mail address(es) list or the accepted e-mail address(es) list or can select to add any e-mail address associated with any e-mail message to the rejected e-mail address(es) list. In this regard, the user, individual, or account holder, can select or designate certain of the e-mail addresses from which e-mail messages are received and/or recorded which can or should be accepted or rejected in the future, or the user, individual, or account holder, can revise, on the fly, and/or while reviewing the screened e-mail message report, the list of allowed e-mail addresses or accepted e-mail addresses, or the list of rejected e-mail addresses, from and via the screened e-mail message report.

In a preferred embodiment, the communication device 20 can also be programmed to provide, or to generate and/or transmit a message containing, a list of allowed or accepted e-mail addresses and/or a list of rejected e-mail addresses to the central processing computer 10, or to any other communication device(s) 20 of the user, individual, or account holder, and/or to any respective telephone service provider computer(s) 30, cellular/wireless service provider computer(s) 40, e-mail service provider computer(s) 50, or cable/satellite service provider computer(s) 60, or governmental agency computer(s) 70. The communication device 20 can also be programmed to generate a complaint message containing information for reporting a Do Not E-Mail List violation by an e-mailing individual or party and to transmit same to the central processing computer 10, and/or to any respective telephone service provider computer(s) 30, cellular/wireless service provider computer(s) 40, e-mail service provider computer(s) 50, or cable/satellite service provider computer(s) 60, or governmental agency computer(s) 70.

With reference to FIGS. 11A and 11B, the operation of the apparatus 100 commences at step 1100. At step 1101, the communication device 20, or the CPU 20A, will await the receiving of an incoming e-mail message. At step 1102, the communication device 20, or the CPU 20A, will receive the incoming e-mail message and receive and process information regarding the e-mail address associated with same so as to identify or ascertain the incoming e-mail address of the incoming e-mail message. In a preferred embodiment, at step 1102, the communication device 20, or the CPU 20A, will process information regarding the incoming e-mail message and will not allow the communication device 20 to make any sound and/or provide any other e-mail receipt indication, signifying the incoming e-mail message, until any and/or all processing regarding same is completed. At step 1103, the communication device 20, or the CPU 20A, can ascertain whether or not the e-mail address associated with the incoming e-mail message is an allowed e-mail address or an accepted e-mail address by comparing the incoming e-mail address with or against the list of e-mail address on the allowed e-mail address(es) list or on the accepted e-mail address(es) list.

If, at step 1103, the communication device 20, or the CPU 20A, determines that the incoming e-mail address is on the allowed e-mail address(es) list or on the accepted e-mail address(es) list, then the operation of the apparatus 100 will proceed to step 1104 and the communication device 20 will commence making a sound and/or providing any other indication to allow for the signaling of the incoming e-mail message.

At step 1104, the user, individual, or account holder, or any other person, can then retrieve and review the e-mail message. After the e-mail message has been read or reviewed, or has not been read or reviewed, then the operation of the apparatus 100 will proceed to step 1105 and information regarding the time and date of the incoming e-mail message, and/or the incoming e-mail address, and/or any document(s), picture(s), video clip(s), or audio clip(s), which was included in same, attached to same, or associated with same, or which accompanied, the e-mail message, can be recorded and stored by the communication device 20, or the CPU 20A, in the database 20H, and/or the time and date of the incoming e-mail message and the incoming e-mail address can be added to and stored in a missed e-mail message list which can be provided to the user, individual, or account holder, or any other person, at any time until cleared or reset by the user, individual, or account holder, or other person. At step 1105, any other data and/or information regarding the incoming e-mail message, the incoming e-mail address from which it was sent or transmitted, and/or any other information regarding the incoming e-mail messaging event, can be stored by the communication device 20, or the CPU 20A, in the database 20H. Thereafter, the operation of the apparatus 100 will cease at step 1106.

If, at step 1103, the communication device 20, or the CPU 20A, determines that the incoming e-mail address is not on the allowed e-mail address(es) list or not on the accepted e-mail address(es) list, then the operation of the apparatus 100 will proceed to step 1107. At step 1107, the communication device 20, or the CPU 20A, can ascertain whether or not the incoming e-mail address is a rejected e-mail address by comparing the incoming e-mail address with or against the list of e-mail addresses on the rejected e-mail address(es) list. At step 1107, the communication device 20, or the CPU 20A, can also, if so programmed, ascertain whether or not the incoming e-mail address is an unknown e-mail address, an unidentifiable e-mail address, a private e-mail address, or a concealed, hidden, or disguised, e-mail address, and can reject the incoming e-mail message.

If, at step 1107, the communication device 20, or the CPU 20A, determines that the incoming e-mail address is on the rejected e-mail address(es) list, or that the incoming e-mail message is sent from an unknown e-mail address, an unidentifiable e-mail address, a private e-mail address, or a concealed, hidden, or disguised, e-mail address, which should be rejected, then the operation of the apparatus 100 will proceed to step 1108 and the communication device 20 will reject the incoming e-mail message without allowing the communication device 20 to make any sound or provide any indication of the incoming e-mail message. In this regard, in a preferred embodiment, the apparatus 100 serves to not disturb the user, individual, or account holder, or any other person, with any sounds or other indications, visual, audible, or otherwise, which would otherwise be associated with a rejected e-mail message. Thereafter, the operation of the apparatus 100 will proceed to step 1108, and any information regarding the time and date of the rejected incoming e-mail message and the rejected incoming e-mail address, can be recorded and stored by the communication device 20, or the CPU 20A, in the database 20H, and/or the time and date of the rejected incoming e-mail message and the rejected incoming e-mail address can be added to and stored in a missed e-mail message list which can be provided to the user, individual, or account holder, or any other person, at any time until cleared or reset by the user, individual, or account holder, or other person.

At step 1108, any other data and/or information regarding the rejected incoming e-mail message, the rejected incoming e-mail address, and/or any other information regarding the rejected incoming e-mail messaging event, can be stored by the communication device 20, or the CPU 20A, in the database 20H. At step 1108, if applicable, any other data and/or information regarding the unknown e-mail address, the unidentifiable e-mail address, the private e-mail address, or the concealed, hidden, or disguised, e-mail address, can also be stored by the communication device 20, or the CPU 20A, in the database 20H. Thereafter, the operation of the apparatus 100 will cease at step 1106.

If, at step 1107, the communication device 20, or the CPU 20A, determines that the incoming e-mail address is not on the rejected e-mail address(es) list, then the operation of the apparatus 100 will proceed to step 1109. At step 1109, the communication device 20, or the CPU 20A, will record and store the incoming e-mail address, the time and date of same, the content of the e-mail message, any document(s), picture(s), video clip(s), or audio clip(s), included in, attached to, or associated with, same, or with the e-mail message, and/or can allow the e-mailing individual or party to record a message, a voice message, a voicemail message, an answering service message, an answering machine message, or voice message or a video and/or audio message, for the user, individual, or account holder, or other person, and/or can store information relating to the incoming e-mail address and/or the incoming e-mail message. At step 1109, the communication device 20, or the CPU 20A, can generate a screened e-mail message report and/or can store information relating to the incoming e-mail message, the incoming e-mail address, any information regarding same, and/or any document(s), picture(s), video clip(s), or audio clip(s), included in, attached to, or associated with the e-mail message, as well as any other information recorded and stored at step 1109, in the screened e-mail message report.

At step 1109, the communication device 20, or the CPU 20A, can also generate a screened e-mail message report notification message or alert message which can, but need not, contain information, a link, or a hyperlink, to the screened e-mail message report, and/or can transmit same, as an e-mail message and/or as an attachment(s) to an e-mail message, as a text message, or as an audio message, or in or as any other communication transmission, to any other communication device 20 used by or associated with the user, individual, or account holder.

At step 1109, the user, individual, or account holder, can thereafter, access the screened e-mail message report notification message or alert message and review the information, document(s), picture(s), video clip(s), or audio clip(s), or recordings, contained in or attached to the screened e-mail message report notification message or alert message, the screened e-mail message report, and/or any messages, voice messages, voicemail messages, answering service messages, answering machine messages, or video and/or audio messages, contained in the screened e-mail message report. At step 1109, the user, individual, or account holder, can also review the incoming e-mail addresses contained in the screened e-mail message report and, for each incoming e-mail address contained in the screened e-mail message report, can select or designate same to be either an allowed e-mail address or an accepted e-mail address to be added to the allowed e-mail address(es) list or the accepted e-mail address(es) list for future apparatus 100 use, or can select or designate same to be a rejected e-mail address to be added to the rejected e-mail address(es) list for future apparatus 100 use, or can simply ignore and/or delete the information regarding the incoming e-mail message.

At step 1109, any information entered into the communication device 20 regarding any selections or designations made by the user, individual, or account holder, can be stored in the communication device and can be transmitted to the central processing computer 10 and can be stored in the database 10H of same. Thereafter, at step 1109, the communication device 20, or the CPU 20A, can store any and/or all data and/or information regarding the use or operation of the apparatus 100. Thereafter, the operation of the apparatus 100 will cease at step 1106.

In another preferred embodiment, at step 1109, the communication device 20, or the CPU 20A, can generate a report containing the allowed e-mail address(es) list, or the accepted e-mail address(es) list, or the rejected e-mail address(es) list, and can transmit same to the central processing computer 10, and/or to any respective telephone service provider computer(s) 30, cellular/wireless service provider computer(s) 40, e-mail service provider computer(s) 50, or cable/satellite service provider computer(s) 60, which services the user's, the individual's, or the account holder's, account, or to a respective governmental agency computer(s) 70, for storage at or in same and/or for later use by same.

In another preferred embodiment, the communication device 20, or the CPU 20A, can also, at step 1109, for any and/or each incoming e-mail address contained in the screened e-mail message report, generate a Do Not E-Mail complaint reporting form or report, containing information regarding the respective incoming e-mail message, the e-mail address from which the e-mail message was sent or transmitted, the date and time of same, and/or information reporting same as a violation of any Do Not E-Mail List law or regulation, and can transmit same to the appropriate governmental agency computer 70 so as to report the Do Not E-Mail List violation, and/or can transmit same to the central processing computer(s) 10, and/or to any respective telephone service provider computer(s) 30, cellular/wireless service provider computer(s) 40, e-mail service provider computer(s) 50, or cable/satellite service provider computer(s) 60, for storage at or in same and/or for later use by same. In this regard, the apparatus 100 and/or the communication device 20 can automatically report Do Not E-Mail List violations and/or violators to the appropriate governmental agency or agencies, and/or to the operators of any of the herein-described central processing computer(s) 10, and/or to any respective telephone service provider computer(s) 30, cellular/wireless service provider computer(s) 40, e-mail service provider computer(s) 50, or cable/satellite service provider computer(s) 60.

Although a personal computer is described as being utilized in the preferred embodiment of FIGS. 11A and 11B as the communication device 20, it is important to note that the embodiment of FIGS. 11A and 11B can also be utilized in a same, a similar, and/or an analogous, manner using, or in connection with, a telephone, a line-connected telephone, a home telephone or residential telephone, an office telephone or a telephone used for business purposes or commercial purposes, a cordless telephone, or using, or in connection with, a cellular telephone, a wireless telephone, a smart phone, a Smartphone, a mobile telephone, a personal communications services (PCS) telephone, a personal digital assistant, a video telephone, a videophone, a digital telephone, a facsimile machine, a laptop computer, a notebook computer, a tablet, or a tablet computer, or a wearable communication device, a wearable computer, or any other type or kind of communication device, wireless communication device, cellular communication device, or mobile communication device, or any communication device 20 described herein and/or any equivalents of same, which can be adapted, configured, or programmed, to accept, receive, and/or be used for sending or receiving, e-mail messages in order to control, monitor, screen, identify, reject, or report, or prevent the receipt of, unwanted e-mail messages.

In any and/or all of the embodiments described herein, any of the central processing computer(s) 10, any telephone service provider computer(s) 30, any cellular/wireless service provider computer(s) 40, any e-mail service provider computer(s) 50, and/or any cable/satellite service provider computer(s) 60, can be equipped, programmed, configured, or adapted, to operate to process information regarding, and/or to perform, any of the herein-described functions and/or functionality for or regarding, telephone calls, cellular telephone calls, wireless telephone calls, cellular communications, wireless communications, fax transmissions, text messages, SMS messages, MMS messages, and/or e-mail messages or instant messages, and/or any other type or kind of messages or messaging or communications.

In another preferred embodiment, the central processing computer 10, and/or any respective telephone service provider computer(s) 30, cellular/wireless service provider computer(s) 40, e-mail service provider computer(s) 50, or cable/satellite service provider computer(s) 60, which provides any respective telephone service, Internet service provider service, cellular telephone or communications service, wireless telephone or communications service, Internet service, test messaging service, instant messaging service, SMS messaging service, e-mail service, cable communications service, or satellite communications service, can perform any of the herein-described functions or functionality described as being performed by the communication device 20 or telephone of FIGS. 8A and 8B, the communication device 20 or fax machine of FIGS. 9A and 9B, the communication device 20 or cellular telephone of FIGS. 10A and 10B, and/or the communication device 20 or personal computer of FIGS. 11A and 11B.

In another preferred embodiment, the central processing computer 10, or any respective telephone service provider computer(s) 30, cellular/wireless service provider computer(s) 40, e-mail service provider computer(s) 50, or cable/satellite service provider computer(s) 60, which provides any respective service or account for a user, individual, or account holder, can be programmed, by the user, the individual, the account holder, or any other authorized person, to allow telephone calls or cellular telephone calls from allowed or accepted telephone numbers or from allowed or accepted cellular telephone numbers, or can be programmed to reject telephone calls or cellular telephone calls from unaccepted or rejected telephone numbers or from unaccepted or rejected cellular telephone numbers, or from unknown telephone numbers or unknown cellular telephone numbers, from unidentifiable telephone numbers or unidentifiable cellular telephone numbers, from private telephone numbers or private cellular telephone numbers, or from concealed, hidden, or disguised, telephone numbers or cellular telephone numbers, or can be programmed to receive, screen, and/or record, telephone calls or cellular telephone calls and associated messages from certain telephone numbers or cellular telephone numbers while suppressing or preventing the telephone or the cellular telephone from ringing, or can be programmed to generate a screened telephone call message playback report which can be provided or played back to a user, individual, or account holder, or can be programmed to generate a screened telephone call playback report notification message or alert message which can, but need not, contain information, a link, or a hyperlink, to the screened telephone call playback report, and can transmit same to any communication device 20 used by or associated with the user, individual, or account holder, or can be programmed to allow a user, individual, or account holder, to select or designate certain of the telephone numbers or cellular telephone numbers from which messages are recorded which can or should be allowed or accepted or rejected in the future, or which can be programmed to allow a user, individual, or account holder, to revise, on the fly, and/or while listening to or reviewing the screened telephone call message playback report, the list of allowed or accepted telephone numbers or allowed or accepted cellular telephone number, or rejected telephone numbers or rejected cellular telephone numbers, from and via the screened telephone call message playback report.

In another preferred embodiment, the central processing computer 10, or any respective telephone service provider computer(s) 30, cellular/wireless service provider computer(s) 40, e-mail service provider computer(s) 50, or cable/satellite service provider computer(s) 60, which provides any respective service or account for a user, individual, or account holder, can be programmed, by the user, the individual, the account holder, or any other authorized person, to maintain and/or provide a listing of allowed or accepted telephone numbers or allowed or accepted cellular telephone numbers, and/or a list of rejected telephone numbers or rejected cellular telephone numbers, for and/or to any central processing computer 10, any communication device(s) 20 of the user, individual, or account holder, and/or to any respective telephone service provider computer(s) 30, cellular/wireless service provider computer(s) 40, e-mail service provider computer(s) 50, or cable/satellite service provider computer(s) 60, or governmental agency computer(s) 70.

The central processing computer 10, or any respective telephone service provider computer(s) 30, cellular/wireless service provider computer(s) 40, e-mail service provider computer(s) 50, or cable/satellite service provider computer(s) 60, which provides any respective service or account for a user, individual, or account holder, can also be programmed, by the user, the individual, the account holder, or any other authorized person, to generate respective complaint messages containing information for reporting Do Not Call List violations by calling parties and to transmit same to any central processing computer 10, and/or to any respective telephone service provider computer(s) 30, cellular/wireless service provider computer(s) 40, e-mail service provider computer(s) 50, or cable/satellite service provider computer(s) 60, or governmental agency computer(s) 70.

In another preferred embodiment, the central processing computer 10, or any respective telephone service provider computer(s) 30, cellular/wireless service provider computer(s) 40, e-mail service provider computer(s) 50, or cable/satellite service provider computer(s) 60, which provides any respective service or account for a user, individual, or account holder, can be programmed, by the user, the individual, the account holder, or any other authorized person, to allow fax calls and/or fax transmissions from allowed or accepted telephone numbers or allowed or accepted cellular telephone numbers, or can be programmed to reject fax calls and/or fax transmissions from unaccepted or rejected telephone numbers or from unaccepted or rejected cellular telephone numbers, from unknown fax telephone numbers, from unidentifiable fax telephone numbers, from private fax telephone numbers, or from concealed, hidden, or disguised, fax telephone numbers or cellular fax telephone numbers, or can be programmed to receive, screen, and/or record, fax calls and/or fax transmissions and associated fax messages from certain fax telephone numbers while suppressing the fax machine from ringing, or can be programmed to generate a screened fax transmission report which can be provided to a user, individual, or account holder, or can be programmed to generate a screened fax transmission report notification message or alert message which can, but need not, contain information, a link, or a hyperlink, to the screened fax transmission report, and can transmit same to any communication device 20 used by or associated with the user, individual, or account holder, or can be programmed to allow a user, individual, or account holder, to select or designate fax telephone numbers from which fax transmissions can or should be allowed or accepted or rejected in the future, or which can be programmed to allow a user, individual, or account holder, to revise, on the fly, and/or while reviewing the screened fax transmission message report, the list of allowed or accepted fax telephone numbers or rejected fax telephone numbers from and via the screened fax transmission message report.

In a preferred embodiment, the central processing computer 10, or any respective telephone service provider computer(s) 30, cellular/wireless service provider computer(s) 40, e-mail service provider computer(s) 50, or cable/satellite service provider computer(s) 60, which provides any respective service or account for a user, individual, or account holder, can be programmed, by the user, the individual, the account holder, or any other authorized person, to maintain or provide a listing of allowed or accepted fax telephone numbers, and/or a list of rejected fax telephone numbers, for and/or to the central processing computer 10, to any communication device(s) 20 of the user, individual, or account holder, and/or to any respective telephone service provider computer(s) 30, cellular/wireless service provider computer(s) 40, e-mail service provider computer(s) 50, or cable/satellite service provider computer(s) 60, or governmental agency computer(s) 70. The central processing computer 10, or any respective telephone service provider computer(s) 30, cellular/wireless service provider computer(s) 40, e-mail service provider computer(s) 50, or cable/satellite service provider computer(s) 60, which provides any respective service or account for a user, individual, or account holder, can also be programmed to generate respective complaint messages containing information for reporting any Do Not Fax List violations by fax transmitting parties and to transmit same to any central processing computer 10 and/or to any respective telephone service provider computer(s) 30, cellular/wireless service provider computer(s) 40, e-mail service provider computer(s) 50, or cable/satellite service provider computer(s) 60, or governmental agency computer(s) 70.

In another preferred embodiment, the central processing computer 10, or any respective telephone service provider computer(s) 30, cellular/wireless service provider computer(s) 40, e-mail service provider computer(s) 50, or cable/satellite service provider computer(s) 60, which provides any respective service or account for a user, individual, or account holder, can also be programmed to allow text messages, SMS messages, MMS messages, or any other types of messages, from allowed or accepted telephone numbers or allowed or accepted cellular telephone numbers, or can be programmed to reject text messages from unaccepted or rejected telephone numbers, from unknown telephone numbers, from unidentifiable telephone numbers, from private telephone numbers, or from concealed, hidden, or disguised, telephone numbers, or can be programmed to receive, screen, and/or record, text messages from certain telephone numbers while suppressing the cellular telephone, the wireless telephone, the smart phone, the Smartphone, the respective cellular communication device, wireless communication device, or personal digital assistant, from emitting a sound or from ringing, or can be programmed to generate a screened text message report which can be provided to a user, individual, or account holder, or can be programmed to generate a screened text message report notification message or alert message, which can, but need not, contain information, a link, or a hyperlink, to the screened text message report, and can transmit same to any communication device 20 used by or associated with the user, individual, or account holder, or can be programmed to allow a user, individual, or account holder, to select or designate telephone numbers from which text messages can or should be allowed or accepted or rejected in the future, or which can be programmed to allow a user, individual, or account holder, to revise, on the fly, and/or while reviewing the screened text message report, the list of allowed or accepted telephone numbers or rejected telephone numbers from and via the screened text message report.

In a preferred embodiment, the central processing computer 10, or any respective telephone service provider computer(s) 30, cellular/wireless service provider computer(s) 40, e-mail service provider computer(s) 50, or cable/satellite service provider computer(s) 60, which provides any respective service or account for a user, individual, or account holder, can also be programmed to provide a listing of allowed or accepted telephone numbers, and/or a list of rejected telephone numbers, to any central processing computer 10, to any other communication device(s) 20 of the user, individual, or account holder, and/or to any respective telephone service provider computer(s) 30, cellular/wireless service provider computer(s) 40, e-mail service provider computer(s) 50, or cable/satellite service provider computer(s) 60, or governmental agency computer(s) 70. The central processing computer 10, or any respective telephone service provider computer(s) 30, cellular/wireless service provider computer(s) 40, e-mail service provider computer(s) 50, or cable/satellite service provider computer(s) 60, can also be programmed to generate respective complaint messages containing information for reporting Do Not Text List violations by text message transmitting parties and to transmit same to any central processing computer 10 and/or to any respective telephone service provider computer(s) 30, cellular/wireless service provider computer(s) 40, e-mail service provider computer(s) 50, or cable/satellite service provider computer(s) 60, or governmental agency computer(s) 70.

In another preferred embodiment, the central processing computer 10, or any respective telephone service provider computer(s) 30, cellular/wireless service provider computer(s) 40, e-mail service provider computer(s) 50, or cable/satellite service provider computer(s) 60, which provides any respective service or account for a user, individual, or account holder, can also be programmed to allow e-mail messages or messages transmitted from an IP address from allowed or accepted e-mail addresses or IP addresses, or can be programmed to reject, or automatically delete, e-mail messages from unaccepted or rejected e-mail addresses, from unknown e-mail addresses, from unidentifiable e-mail addresses, from private e-mail addresses, or from concealed, hidden, or disguised, e-mail addresses, or can be programmed to receive, screen, and/or record, e-mail addresses from certain e-mail addresses while suppressing same from entering the user's, the individual's, or the account holder's, e-mail In Box or while suppressing any respective personal computer, the laptop computer, the notebook computer, the telephone, the cellular telephone, the wireless telephone, the smart phone, the Smartphone, the cellular communication device, the wireless communication device, or the personal digital assistant from emitting any sound or from proving any visual, audible, or other, indication, or can be programmed to generate a screened e-mail message report which can be provided to a user, individual, or account holder, or can be programmed to generate a screened e-mail message report notification message or alert message which can, but need not, contain information, a link, or a hyperlink, to the screened e-mail message report, and can transmit same to any communication device 20 used by or associated with the user, individual, or account holder, or can be programmed to allow a user, individual, or account holder, to select or designate e-mail addresses or IP addresses from which e-mail messages can or should be allowed or accepted or rejected in the future, or which can be programmed to allow a user, individual, or account holder, to revise, on the fly, and/or while reviewing the screened e-mail message report, the list of allowed or accepted e-mail addresses or rejected e-mail addresses from and via the screened e-mail message report.

In a preferred embodiment, the central processing computer 10, or any respective telephone service provider computer(s) 30, cellular/wireless service provider computer(s) 40, e-mail service provider computer(s) 50, or cable/satellite service provider computer(s) 60, which provides any respective service or account for a user, individual, or account holder, can also be programmed to provide a listing of allowed or accepted e-mail addresses and/or a list of rejected e-mail addresses, to any central processing computer 10, to any communication device(s) 20 of the user, individual, or account holder, and/or to any respective telephone service provider computer(s) 30, cellular/wireless service provider computer(s) 40, e-mail service provider computer(s) 50, or cable/satellite service provider computer(s) 60, or governmental agency computer(s) 70. The central processing computer 10, or any respective telephone service provider computer(s) 30, cellular/wireless service provider computer(s) 40, e-mail service provider computer(s) 50, or cable/satellite service provider computer(s) 60, can also be programmed to generate respective complaint messages containing information for reporting Do Not E-Mail List violations by e-mail transmitting parties and to transmit same to any central processing computer 10 and/or to any respective telephone service provider computer(s) 30, cellular/wireless service provider computer(s) 40, e-mail service provider computer(s) 50, or cable/satellite service provider computer(s) 60, or governmental agency computer(s) 70.

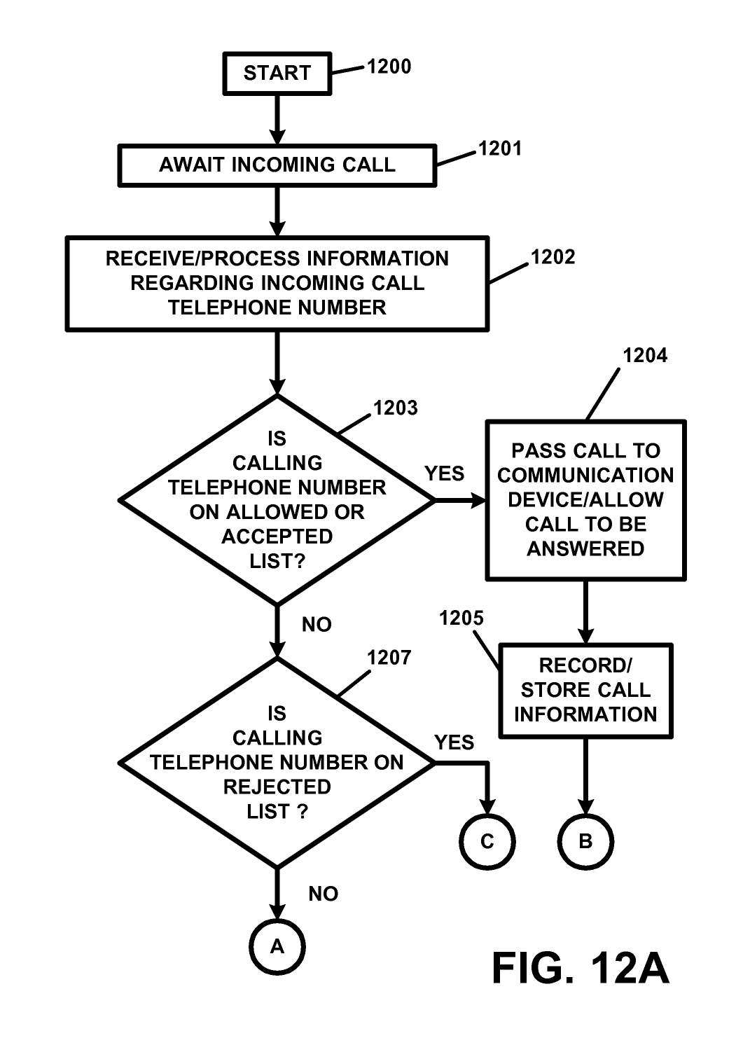

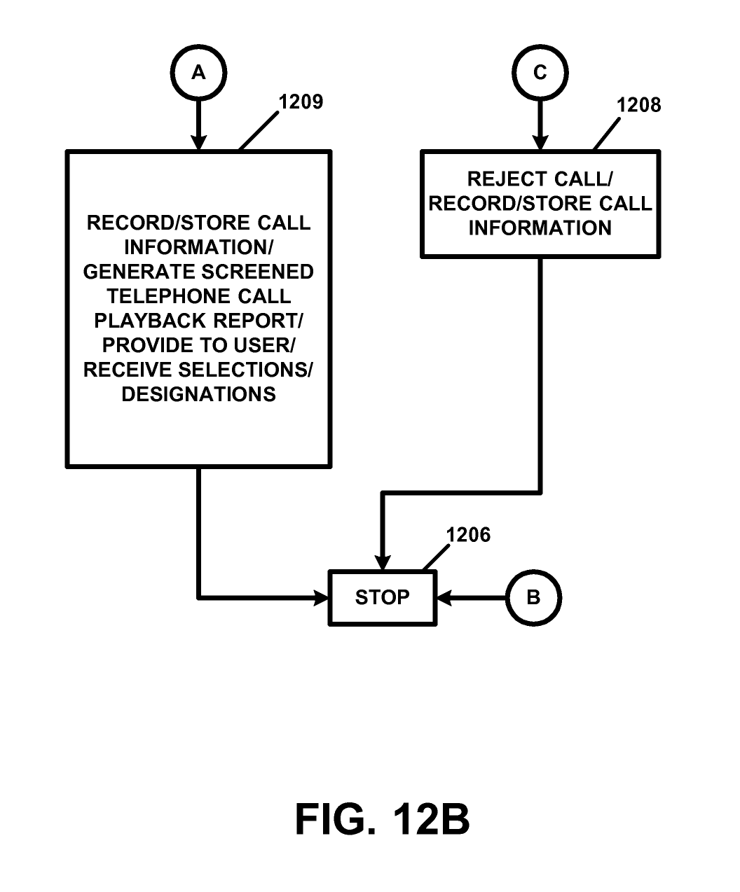

In another preferred embodiment, the apparatus 100 and method of the present invention can be utilized to provide, or can be, a central processing computer 10, or any respective telephone service provider computer(s) 30, cellular/wireless service provider computer(s) 40, e-mail service provider computer(s) 50, or cable/satellite service provider computer(s) 60, which can screen, identify, reject, and/or report, unwanted telephone calls. FIGS. 12A and 12B illustrates a preferred embodiment method for utilizing the apparatus 100 of the present invention, in flow diagram form, in connection with a central processing computer 10, or any respective telephone service provider computer(s) 30, cellular/wireless service provider computer(s) 40, e-mail service provider computer(s) 50, or cable/satellite service provider computer(s) 60, which can be programmed to screen, identify, reject, and/or report, unwanted telephone calls. Although a central processing computer 10 is described as being utilized in the preferred embodiment of FIGS. 12A and 12B, it is important to note that any respective telephone service provider computer(s) 30, cellular/wireless service provider computer(s) 40, e-mail service provider computer(s) 50, or cable/satellite service provider computer(s) 60, can be utilized in a same, a similar, or an analogous, manner, in order to perform the same functions and/or functionality, described herein as being performed by the central processing computer 10 in the embodiment of FIGS. 12A and 12B. In this regard, any respective telephone service provider computer(s) 30, cellular/wireless service provider computer(s) 40, e-mail service provider computer(s) 50, or cable/satellite service provider computer(s) 60 can perform any and/or all of the functions and/or functionality described as being performed by the central processing computer 10 in the embodiment of FIGS. 12A and 12B.

In a preferred embodiment, the central processing computer 10, or any respective telephone service provider computer(s) 30, cellular/wireless service provider computer(s) 40, e-mail service provider computer(s) 50, or cable/satellite service provider computer(s) 60, can be pre-programmed by the user, individual, or account holder, or any authorized person, with the telephone number(s) or cellular telephone number(s) from which calls can be received by the telephone or communication device 20 of the user, the individual, or the account holder. In this regard, the user, individual, or account holder, or other authorized person, can create an allowed telephone number(s) list or an accepted telephone number(s) list. In a preferred embodiment, the central processing computer 10, or any respective telephone service provider computer(s) 30, cellular/wireless service provider computer(s) 40, e-mail service provider computer(s) 50, or cable/satellite service provider computer(s) 60, can also be pre-programmed by the user, individual, or account holder, or other authorized person, with the telephone number(s) from which calls are to be, or should be, rejected by the telephone. In this regard, the user, individual or account holder, or other authorized person, can create a rejected telephone number(s) list.

In a preferred embodiment, the user, individual, or account holder, or other authorized person can also pre-program the central processing computer 10, or any respective telephone service provider computer(s) 30, cellular/wireless service provider computer(s) 40, e-mail service provider computer(s) 50, or cable/satellite service provider computer(s) 60, to reject telephone calls or cellular telephone calls from telephone numbers which have not been identified as being allowed telephone number(s) or accepted telephone number(s), or to reject telephone calls from rejected telephone numbers, or to reject telephone calls from unknown or unaccepted telephone numbers, or from unknown telephone numbers, from unidentifiable telephone numbers, from private telephone numbers or private number telephone numbers, or from concealed, hidden, or disguised, telephone numbers. In a preferred embodiment, the central processing computer 10, or any respective telephone service provider computer(s) 30, cellular/wireless service provider computer(s) 40, e-mail service provider computer(s) 50, or cable/satellite service provider computer(s) 60, can also be programmed to receive, screen, and/or record, telephone calls and associated messages or voice messages from certain telephone numbers, which have not yet been designated or identified as being allowed, accepted, or rejected, prior to transmitting, or passing along, the telephone call to the communication device 20 (or the telephone), so as to not disturb the user, individual, or account holder, or other persons.

In a preferred embodiment, the central processing computer 10, or any respective telephone service provider computer(s) 30, cellular/wireless service provider computer(s) 40, e-mail service provider computer(s) 50, or cable/satellite service provider computer(s) 60, can also be programmed to generate a screened telephone call message playback report which can provide, or play back, to the user, individual, or account holder, any telephone messages recorded by the central processing computer 10, or any respective telephone service provider computer(s) 30, cellular/wireless service provider computer(s) 40, e-mail service provider computer(s) 50, or cable/satellite service provider computer(s) 60, at the user's, individual's, or account holder's, convenience or at any other time. The user, individual, or account holder, or other authorized person, can also program the central processing computer 10, or any respective telephone service provider computer(s) 30, cellular/wireless service provider computer(s) 40, e-mail service provider computer(s) 50, or cable/satellite service provider computer(s) 60, with, or record, an answering message informing the caller that the message is a call screening message and of the user's, individual's, or account holder's, desire to only receive calls from certain allowed or accepted telephone numbers or from certain allowed or accepted callers.

The user, individual, or account holder, can also program the central processing computer 10, or any respective telephone service provider computer(s) 30, cellular/wireless service provider computer(s) 40, e-mail service provider computer(s) 50, or cable/satellite service provider computer(s) 60, so that the screened telephone call message playback report can be provided to the user, individual, or account holder, at any desired, and/or pre-selected, and/or pre-specified, time interval(s), or daily, weekly, or monthly, or when a pre-selected number of telephone messages have been received or recorded by the central processing computer 10, or any respective telephone service provider computer(s) 30, cellular/wireless service provider computer(s) 40, e-mail service provider computer(s) 50, or cable/satellite service provider computer(s) 60.

In a preferred embodiment, the central processing computer 10, or any respective telephone service provider computer(s) 30, cellular/wireless service provider computer(s) 40, e-mail service provider computer(s) 50, or cable/satellite service provider computer(s) 60, can also be pre-programmed to generate a screened telephone call playback report notification message or alert message which can, but need not, contain information, a link, or a hyperlink, to the screened telephone call playback report, and can transmit same to any communication device 20 used by or associated with the user, individual, or account holder. In a preferred embodiment, the user, individual, or account holder, can, upon or when reviewing or listening to the telephone messages, utilize the communication device 20 in order to select to add any telephone number associated with any message to the allowed telephone number(s) list or the accepted telephone number(s) list or can select to add any telephone number associated with any message to the rejected telephone number(s) list. In this regard, the user, individual, or account holder, can utilize the communication device 20 in order to select or designate certain of the telephone numbers from which messages are received and/or recorded which can or should be accepted or rejected in the future, or the user, individual, or account holder, can revise, on the fly, and/or while listening to or reviewing the screened telephone call message playback report, the list of allowed telephone numbers or accepted telephone numbers, or the list of rejected telephone numbers, from and via the screened telephone call message playback report.

In a preferred embodiment, the central processing computer 10, or any respective telephone service provider computer(s) 30, cellular/wireless service provider computer(s) 40, e-mail service provider computer(s) 50, or cable/satellite service provider computer(s) 60, can also be programmed to provide, or to generate and/or transmit a message containing, a list of allowed or accepted telephone numbers and/or a list of rejected telephone numbers to any or any other central processing computer 10, to any or any other communication device(s) 20 of the user, individual, or account holder, and/or to any or any other telephone service provider computer(s) 30, cellular/wireless service provider computer(s) 40, e-mail service provider computer(s) 50, or cable/satellite service provider computer(s) 60, or governmental agency computer(s) 70. The central processing computer 10, or any respective telephone service provider computer(s) 30, cellular/wireless service provider computer(s) 40, e-mail service provider computer(s) 50, or cable/satellite service provider computer(s) 60, can also be programmed to generate a complaint message containing information for reporting a Do Not Call List violation by a calling party and to transmit same to any central processing computer 10, and/or to any respective telephone service provider computer(s) 30, cellular/wireless service provider computer(s) 40, e-mail service provider computer(s) 50, or cable/satellite service provider computer(s) 60, or governmental agency computer(s) 70.

With reference to FIGS. 12A and 12B, the operation of the apparatus 100 commences at step 1200. At step 1201, the central processing computer 10, or the CPU 10A, will await the receiving of an incoming telephone call. At step 1202, the central processing computer 10, or the CPU 10A, will receive the incoming telephone call, for the user, individual, or account holder, prior to the incoming call being transmitted to and received by the communication device 20 (which is a telephone in this embodiment), and will receive and process information regarding the caller identification of same so as to identify or ascertain the incoming telephone number or the telephone number of the incoming telephone call. In a preferred embodiment, at step 1202, the central processing computer 10, or the CPU 10A, will process information regarding the incoming telephone call prior to the communication device 20 receiving same and starting to ring.

At step 1203, the central processing computer 10, or the CPU 10A, can ascertain whether or not the incoming telephone number is an allowed telephone number or an accepted telephone number by comparing the incoming telephone number with or against the list of telephone numbers on the allowed telephone number(s) list or on the accepted telephone number(s) list. If, at step 1203, the central processing computer 10, or the CPU 10A, determines that the incoming telephone number is on the allowed telephone number(s) list or on the accepted telephone number(s) list, then the operation of the apparatus 100 will proceed to step 1204 and the central processing computer 10 will transmit, or pass along, the incoming telephone call to the communication device 20 which will start ringing to allow for the signaling of the incoming telephone call.

At step 1204, the user, individual, or account holder, or any other person, can then answer and take the telephone call. After the call is completed, or if the call has not been answered, then the operation of the apparatus 100 will proceed to step 1205 and information regarding the time and date of the incoming telephone call, the incoming telephone number, the duration of the call, if answered, or the number of rings, if not answered, can be recorded and stored by the central processing computer 10, or the CPU 10A, in the database 10H, and/or the time and date of the incoming telephone call and the incoming telephone number can be added to and stored in a missed call list which can be provided to the user, individual, or account holder, or any other person, at any time until cleared or reset by the user, individual, or account holder, or other person. At step 1205, any other data and/or information regarding the incoming telephone call, the incoming telephone number, and/or any other information regarding the incoming calling event, can be stored by the central processing computer 10, or the CPU 10A, in the database 10H. Thereafter, the operation of the apparatus 100 will cease at step 1206.

If, at step 1203, the central processing computer 10, or the CPU 10A, determines that the incoming telephone number is not on the allowed telephone number(s) list or not on the accepted telephone number(s) list, then the operation of the apparatus 100 will proceed to step 1207. At step 1207, the central processing computer 10, or the CPU 10A, will ascertain whether or not the incoming telephone number is a rejected telephone number by comparing the incoming telephone number with or against the list of telephone numbers on the rejected telephone number(s) list. At step 1207, the central processing computer 10, or the CPU 10A, can also, if so programmed, ascertain whether or not the incoming telephone number is an unknown telephone number, an unidentifiable telephone number, a private telephone number or private number telephone number, or a concealed, hidden, or disguised, telephone number, and can reject the incoming call.

If, at step 1207, the central processing computer 10, or the CPU 10A, determines that the incoming telephone number is on the rejected telephone number(s) list, or that the incoming telephone call is an unknown telephone number, an unidentifiable telephone number, a private telephone number or private number telephone number, or a concealed, hidden, or disguised, telephone number, which should be rejected, then the operation of the apparatus 100 will proceed to step 1208 and the central processing computer 10 will reject the incoming call without transmitting, or passing along, same to the communication device 20. In this regard, in a preferred embodiment, the apparatus 100 serves to not disturb the user, individual, or account holder, or any other person, with any telephone ringing sound or noise which would otherwise be associated with a rejected telephone number. Thereafter, the operation of the apparatus 100 will proceed to step 1208, and any information regarding the time and date of the rejected incoming telephone call and the rejected incoming telephone number, can be recorded and stored by the central processing computer 10, or the CPU 10A, in the database 10H, and/or the time and date of the rejected incoming telephone call and the rejected incoming telephone number can be added to and stored in a missed call list which can be provided to the user, individual, or account holder, or any other person, at any time until cleared or reset by the user, individual, or account holder, or other person.

At step 1208, any other data and/or information regarding the rejected incoming telephone call, the rejected incoming telephone number, and/or any other information regarding the rejected incoming calling event, can be stored by the central processing computer 10, or the CPU 10A, in the database 10H. At step 1208, if applicable, any other data and/or information regarding the unknown telephone number, the unidentifiable telephone number, the private telephone number or private number telephone number, or the concealed, hidden, or disguised, telephone number can also be stored by the central processing computer 10, or the CPU 10A, in the database 10H. Thereafter, the operation of the apparatus 100 will cease at step 1206.

If, at step 1207, the central processing computer 10, or the CPU 10A, determines that the incoming telephone number is not on the rejected telephone number(s) list, then the operation of the apparatus 100 will proceed to step 1209. At step 1209, the central processing computer 10, or the CPU 10A, will record and store the incoming telephone number, the time and date of same, and can allow the caller or calling party to leave or record a message, a voice message, a voicemail message, an answering service message, an answering machine message, or voice message or a video and/or audio message, for the user, individual, or account holder, or other person, and/or can record and store any information relating to the incoming telephone number and/or the incoming telephone call. At step 1209, the central processing computer 10, or the CPU 10A, can generate a screened telephone call playback report and/or can store information relating to the incoming telephone call number, any information regarding same, and/or any message, as well as any other information recorded and stored at step 1209, in the screened telephone call playback report.

At step 1209, the central processing computer 10, or the CPU 10A, can also generate a screened telephone call playback report notification message or alert message which can, but need not, contain information, a link, or a hyperlink, to the screened telephone call playback report, and/or can transmit same, as an e-mail message and/or as an attachment(s) to an e-mail message, as a text message, or as an audio message, or in or as any other communication transmission, to any communication device 20 used by or associated with the user, individual, or account holder. At step 1209, the user, individual, or account holder, can thereafter, access the screened telephone call playback report notification message or alert message using or via the communication device 20 and can view or listen to the information or recordings contained in or attached to the screened telephone call playback report notification message or alert message, the screened telephone call playback report, and/or any messages, voice messages, voicemail messages, answering service messages, answering machine messages, or a video and/or audio messages, contained in the screened telephone call playback report.

At step 1209, the user, individual, or account holder, can also review the incoming telephone number(s) contained in the screened telephone call playback report and, for each incoming telephone number contained in the screened telephone call playback report, can, using or via the communication 20, select or designate same to be either an allowed telephone number or an accepted telephone number to be added to the allowed telephone number(s) list or the accepted telephone number(s) list for future apparatus 100 use, or can, using or via the communication 20, select or designate same to be a rejected telephone number to be added to the rejected telephone number(s) list for future apparatus 100 use, or can simply ignore and/or delete the information regarding the incoming telephone call.

At step 1209, any information entered into the communication device 20 regarding any selections or designations made by the user, individual, or account holder, can be stored in the communication device and can be transmitted to the central processing computer 10 and can be stored in the database 10H of same. Thereafter, at step 1209, the central processing computer 10, or the CPU 10A, can store any and/or all data and/or information regarding the use or operation of the apparatus 100. Thereafter, the operation of the apparatus 100 will cease at step 1206.

In another preferred embodiment, at step 1209, the central processing computer 10, or the CPU 10A, can generate a report containing the allowed telephone number(s) list, or the accepted telephone number(s) list, or the rejected telephone number(s) list, and can transmit same to any other central processing computer 10, to any communication device 20 associated with the user, the individual, or the account holder, and/or to any respective telephone service provider computer(s) 30, cellular/wireless service provider computer(s) 40, e-mail service provider computer(s) 50, or cable/satellite service provider computer(s) 60, which services the user's, the individual's, or the account holder's, account, or to a respective governmental agency computer(s) 70, for storage at or in same and/or for later use by same.

In another preferred embodiment, the central processing computer 10, or the CPU 10A, can also, at step 1209, for any and/or each incoming telephone number contained in the screened telephone call playback report, generate a Do Not Call complaint reporting form or report, containing information regarding the respective incoming telephone call, the telephone number from which the telephone call came, the date and time of same, and information reporting same as a violation of the Do Not Call List law or regulation, and can transmit same to the appropriate governmental agency computer 70 so as to report the Do Not Call List violation, and/or can transmit same to any other central processing computer(s) 10, to any communication device 20 associated with the user, the individual, or the account holder, and/or to any respective telephone service provider computer(s) 30, cellular/wireless service provider computer(s) 40, e-mail service provider computer(s) 50, or cable/satellite service provider computer(s) 60, for storage at or in same and/or for later use by same. In this regard, the apparatus 100 and/or the central processing computer 10 can automatically report Do Not Call List violations and/or violators to the appropriate governmental agency or agencies, and/or to the operators of any other of the herein-described central processing computer(s) 10, and/or to any respective telephone service provider computer(s) 30, cellular/wireless service provider computer(s) 40, e-mail service provider computer(s) 50, or cable/satellite service provider computer(s) 60.

Although the apparatus 100 of the preferred embodiment of FIGS. 12A and 12B is described as being utilized in connection with, or as being performed with or by, the central processing computer 10, in order to control, monitor, screen, identify, reject, or report, or prevent the receipt of, unwanted telephone calls, the apparatus 100 of the preferred embodiment of FIGS. 12A and 12B can also be utilized in a same, a similar, or an analogous, manner, in connection with, or as being performed with or by, any telephone service provider computer(s) 30, cellular/wireless service provider computer(s) 40, e-mail service provider computer(s) 50, or cable/satellite service provider computer(s) 60, described herein in order to control, monitor, screen, identify, reject, or report, or prevent the receipt of, unwanted telephone calls.

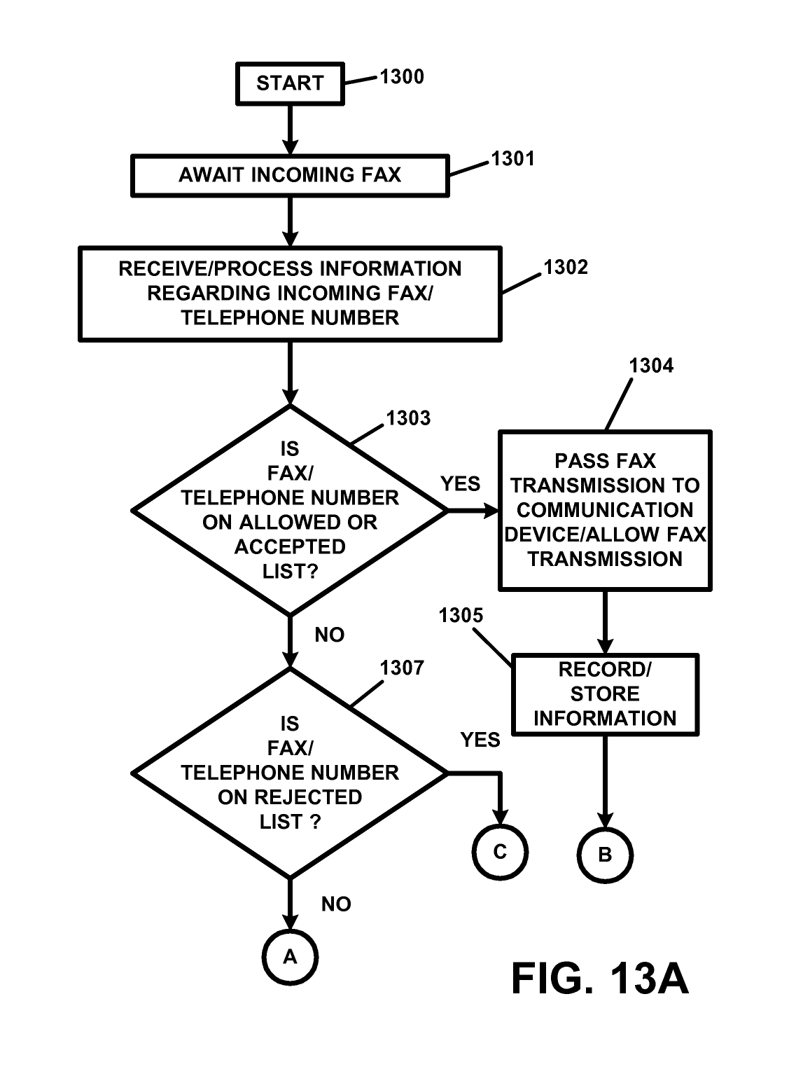

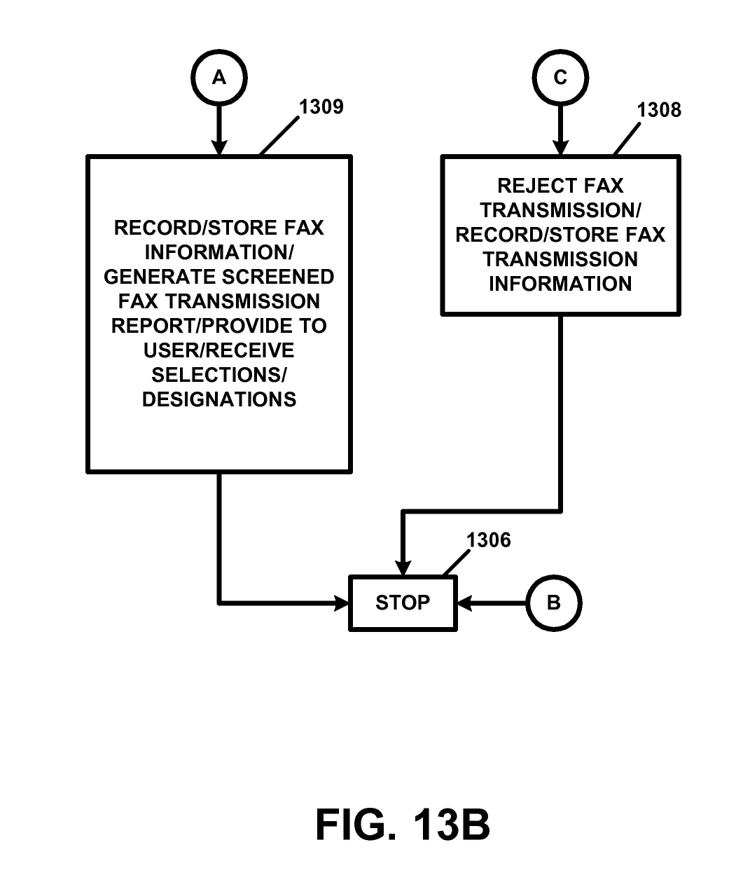

In another preferred embodiment, the apparatus 100 and method of the present invention can be utilized to provide, or can be, a central processing computer 10, or any respective telephone service provider computer(s) 30, cellular/wireless service provider computer(s) 40, e-mail service provider computer(s) 50, or cable/satellite service provider computer(s) 60, which can screen, identify, reject, and/or report, unwanted fax transmissions. FIGS. 13A and 13B illustrates a preferred embodiment method for utilizing the apparatus 100 of the present invention, in flow diagram form, in connection with a central processing computer 10, or any respective telephone service provider computer(s) 30, cellular/wireless service provider computer(s) 40, e-mail service provider computer(s) 50, or cable/satellite service provider computer(s) 60, which can be programmed can screen, identify, reject, and/or report, unwanted fax transmissions. Although a central processing computer 10 is described as being utilized in the preferred embodiment of FIGS. 13A and 13B, it is important to note that any respective telephone service provider computer(s) 30, cellular/wireless service provider computer(s) 40, e-mail service provider computer(s) 50, or cable/satellite service provider computer(s) 60, can be utilized in a same, a similar, or an analogous, manner, in order to perform the same functions and/or functionality, described herein as being performed by the central processing computer 10 in the embodiment of FIGS. 13A and 13B. In this regard, any respective telephone service provider computer(s) 30, cellular/wireless service provider computer(s) 40, e-mail service provider computer(s) 50, or cable/satellite service provider computer(s) 60, can perform any and/or all of the functions and/or functionality described as being performed by the central processing computer 10 in the embodiment of FIGS. 13A and 13B.

In a preferred embodiment, the central processing computer 10, or any respective telephone service provider computer(s) 30, cellular/wireless service provider computer(s) 40, e-mail service provider computer(s) 50, or cable/satellite service provider computer(s) 60, can be pre-programmed by the user, individual, or account holder, or any authorized person, with the telephone number(s) or fax number(s) (hereinafter “fax/telephone number(s)”) from which fax transmissions can be received by the user's, individual's, or account holder's, fax machine (the “allowed fax/telephone number(s)” or the “accepted fax/telephone number(s)”). In this regard, the user, individual, or account holder, can create an allowed fax/telephone number(s) list or an accepted fax/telephone number(s) list. In a preferred embodiment, the central processing computer 10, or any respective telephone service provider computer(s) 30, cellular/wireless service provider computer(s) 40, e-mail service provider computer(s) 50, or cable/satellite service provider computer(s) 60, can also be pre-programmed by the user, individual, or account holder, or any authorized person, with the fax/telephone number(s) from which fax transmissions are to be, or should be, rejected by the fax machine (the “rejected fax/telephone number(s)”). In this regard, the user, individual, or account holder, or other authorized person can create a rejected fax/telephone number(s) list.

In a preferred embodiment, the user, individual, or account holder, can also pre-program the user, individual, or account holder, or other authorized person can also pre-program the central processing computer 10, or any respective telephone service provider computer(s) 30, cellular/wireless service provider computer(s) 40, e-mail service provider computer(s) 50, or cable/satellite service provider computer(s) 60, to reject fax transmissions from fax/telephone numbers which have not been identified as being allowed fax/telephone number(s) or accepted fax/telephone number(s), or to reject fax transmissions from rejected fax/telephone numbers, or to reject fax transmissions from unknown or unaccepted fax/telephone numbers, or from unknown fax/telephone numbers, from unidentifiable fax/telephone numbers, from private fax/telephone numbers or private number fax/telephone numbers, or from concealed, hidden, or disguised, fax/telephone numbers.

In a preferred embodiment, the central processing computer 10, or any respective telephone service provider computer(s) 30, cellular/wireless service provider computer(s) 40, e-mail service provider computer(s) 50, or cable/satellite service provider computer(s) 60, can also be programmed to receive, screen, and/or record, fax transmissions and associated fax documents or messages from certain fax/telephone numbers, which have not yet been designated or identified as being allowed, accepted, or rejected, prior to transmitting, or passing along, the fax transmission to the communication device 20 (or the fax machine) so as to not disturb the user, individual, or account holder, or other persons.

In a preferred embodiment, the central processing computer 10, or any respective telephone service provider computer(s) 30, cellular/wireless service provider computer(s) 40, e-mail service provider computer(s) 50, or cable/satellite service provider computer(s) 60, can also be programmed to generate a screened fax transmission report which can provide, to the user, individual, or account holder, any fax transmission(s) received by the respective central processing computer 10, or any respective telephone service provider computer(s) 30, cellular/wireless service provider computer(s) 40, e-mail service provider computer(s) 50, or cable/satellite service provider computer(s) 60, at the user's, individual's, or account holder's, convenience or at any other time. The user, individual, or account holder, or other authorized person, can also program the central processing computer 10, or any respective telephone service provider computer(s) 30, cellular/wireless service provider computer(s) 40, e-mail service provider computer(s) 50, or cable/satellite service provider computer(s) 60, with, or record, an answering message informing the fax transmitter that the message is a fax transmission screening message and of the user's, individual's, or account holder's, desire to only receive fax transmissions from certain allowed or accepted fax/telephone numbers or from certain fax transmitters or transmitting individuals or parties.

The user, individual, or account holder, or other authorized person, can also program the central processing computer 10, or any respective telephone service provider computer(s) 30, cellular/wireless service provider computer(s) 40, e-mail service provider computer(s) 50, or cable/satellite service provider computer(s) 60, so that the screened fax transmission report can be provided to the user, individual, or account holder, at any desired, and/or pre-selected, and/or pre-specified, time interval(s), or daily, weekly, or monthly, or when a pre-selected number of fax transmissions have been received or recorded by the respective the central processing computer 10, or any respective telephone service provider computer(s) 30, cellular/wireless service provider computer(s) 40, e-mail service provider computer(s) 50, or cable/satellite service provider computer(s) 60.

In a preferred embodiment, the central processing computer 10, or any respective telephone service provider computer(s) 30, cellular/wireless service provider computer(s) 40, e-mail service provider computer(s) 50, or cable/satellite service provider computer(s) 60, can also be pre-programmed to generate a screened fax transmission report notification message or alert message which can, but need not, contain information, a link, or a hyperlink, to the screened fax transmission report, and can transmit same to any communication device 20 used by or associated with the user, individual, or account holder.

In a preferred embodiment, the user, individual, or account holder, can, upon or when reviewing the fax transmission(s), utilize the communication device 20 in order to select to add any fax/telephone number associated with any fax transmission to the allowed fax/telephone number(s) list or the accepted fax/telephone number(s) list or can select to add any fax/telephone number associated with any fax transmission to the rejected fax/telephone number(s) list. In this regard, the user, individual, or account holder, can utilize the communication device 20 in order to select or designate certain of the of the fax/telephone numbers from which fax transmissions are received and/or recorded which can or should be accepted or rejected in the future, or the user, individual, or account holder, can revise, on the fly, and/or while reviewing the screened fax transmission report, the list of allowed fax/telephone numbers or accepted fax/telephone numbers, or the list of rejected fax/telephone numbers, from and via the screened fax transmission report.

In a preferred embodiment, In a preferred embodiment, the central processing computer 10, or any respective telephone service provider computer(s) 30, cellular/wireless service provider computer(s) 40, e-mail service provider computer(s) 50, or cable/satellite service provider computer(s) 60, can also be programmed to provide, or to generate and/or transmit a message containing, a list of allowed or accepted fax/telephone numbers and/or a list of rejected fax/telephone numbers to any or any other central processing computer 10, to any or any other communication device(s) 20 of the user, individual, or account holder, and/or to any or any other telephone service provider computer(s) 30, cellular/wireless service provider computer(s) 40, e-mail service provider computer(s) 50, or cable/satellite service provider computer(s) 60, or governmental agency computer(s) 70. The central processing computer 10, or any respective telephone service provider computer(s) 30, cellular/wireless service provider computer(s) 40, e-mail service provider computer(s) 50, or cable/satellite service provider computer(s) 60, can also be programmed to generate a complaint message containing information for reporting a Do Not Fax List violation by a fax transmitting party and to transmit same to any central processing computer 10, and/or to any respective telephone service provider computer(s) 30, cellular/wireless service provider computer(s) 40, e-mail service provider computer(s) 50, or cable/satellite service provider computer(s) 60, or governmental agency computer(s) 70.

With reference to FIGS. 13A and 13B, the operation of the apparatus 100 commences at step 1300. At step 1301, the central processing computer 10, or the CPU 10A, will await the receiving of an incoming fax transmission. At step 1302, the central processing computer 10, or the CPU 10A, will receive the incoming fax transmission, for the user, individual, or account holder, prior to the fax transmission being transmitted to and received by the communication device 20 (which is a fax machine in this embodiment), and will receive and process information regarding the fax transmission transmitter identification of same so as to identify or ascertain the incoming fax/telephone number or the telephone number of the incoming fax transmission. In a preferred embodiment, at step 1302, the central processing computer 10, or the CPU 10A, will process information regarding the incoming fax transmission prior to the communication device 20 receiving same and starting to ring.

At step 1303, the central processing computer 10, or the CPU 10A, can ascertain whether or not the incoming fax/telephone number is an allowed fax/telephone number or an accepted fax/telephone number by comparing the incoming fax/telephone number with or against the list of fax/telephone numbers on the allowed fax/telephone number(s) list or on the accepted fax/telephone number(s) list. If, at step 1303, the central processing computer 10, or the CPU 10A, determines that the incoming fax/telephone number is on the allowed fax/telephone number(s) list or on the accepted fax/telephone number(s) list, then the operation of the apparatus 100 will proceed to step 1304 and the central processing computer 10 will transmit, or pass along, the incoming fax transmission to the communication device 20 which will start ringing or which will allow or provide any other suitable indication or signal to allow for the signaling of the incoming fax transmission.

At step 1304, the communication device 20 can then receive the fax transmission. After the fax transmission is completed, or if it has terminated unsuccessfully, the operation of the apparatus 100 will proceed to step 1305 and information regarding the time and date of the incoming fax transmission, the incoming fax/telephone number, the duration of the fax transmission, and the fax transmission document or message, can be recorded and stored by the central processing computer 10, or the CPU 10A, in the database 10H, and/or the time and date of the incoming fax transmission and the incoming fax/telephone number can be added to and stored in a fax transmission list which can be provided to the user, individual, or account holder, or any other person, at any time until cleared or reset by the user, individual, or account holder, or other person. At step 1305, any other data and/or information regarding the incoming fax transmission, the incoming fax/telephone number, and/or any other information regarding the incoming fax transmission event, can be stored by the central processing computer 10, or the CPU 10A, in the database 10H. Thereafter, the operation of the apparatus 100 will cease at step 1306.

If, at step 1303, the central processing computer 10, or the CPU 10A, determines that the incoming fax/telephone number is not on the allowed fax/telephone number(s) list or not on the accepted fax/telephone number(s) list, then the operation of the apparatus 100 will proceed to step 1307. At step 1307, the central processing computer 10, or the CPU 10A, can ascertain whether or not the incoming fax transmission is a rejected fax/telephone number by comparing the incoming fax/telephone number with or against the list of fax/telephone numbers on the rejected fax/telephone number(s) list. At step 1307, the central processing computer 10, or the CPU 10A, can also, if so programmed, ascertain whether or not the incoming fax/telephone number is an unknown fax/telephone number, an unidentifiable fax/telephone number, a private fax/telephone number or private number fax/telephone number, or a concealed, hidden, or disguised, fax/telephone number, and can reject the incoming fax transmission.

If, at step 1307, the central processing computer 10, or the CPU 10A, determines that the incoming fax/telephone number is on the rejected fax/telephone number(s) list, or that the incoming fax/telephone call is an unknown fax/telephone number, an unidentifiable fax/telephone number, a private fax/telephone number or private number fax/telephone number, or a concealed, hidden, or disguised, fax/telephone number, which should be rejected, then the operation of the apparatus 100 will proceed to step 1308 and the communication device 20 will reject the incoming fax transmission without transmitting, or passing along, same to the communication device 20. In this regard, in a preferred embodiment, the apparatus 100 serves to not disturb the user, individual, or account holder, or any other person, with any fax machine ringing sound or noise which would otherwise be associated with a rejected fax transmission. Thereafter, the operation of the apparatus 100 will proceed to step 1308, and any information regarding the time and date of the rejected incoming fax transmission and the rejected incoming fax/telephone number, can be recorded and stored by the central processing computer 10, or the CPU 10A, in the database 10H, and/or the time and date of the rejected incoming fax transmission and the rejected incoming fax/telephone number can be added to and stored in a fax transmission list which can be provided to the user, individual, or account holder, or any other person, at any time until cleared or reset by the user, individual, or account holder, or other person.

At step 1308, any other data and/or information regarding the rejected incoming fax transmission, the rejected incoming fax/telephone number, and/or any other information regarding the rejected incoming fax transmission event, can be stored by the central processing computer 10, or the CPU 10A, in the database 10H. At step 1308, if applicable, any other data and/or information regarding the unknown fax/telephone number, the unidentifiable fax/telephone number, the private fax/telephone number or private number fax/telephone number, or the concealed, hidden, or disguised, fax/telephone number can also be stored by the central processing computer 10, or the CPU 10A, in the database 10H. Thereafter, the operation of the apparatus 100 will cease at step 1306.

If, at step 1307, the central processing computer 10, or the CPU 10A, determines that the incoming fax/telephone number is not on the rejected fax/telephone number(s) list, then the operation of the apparatus 100 will proceed to step 1309. At step 1309, the central processing computer 10, or the CPU 10A, will record and store the incoming fax/telephone number, the time and date of same, any content, document(s), or message(s) included in the fax transmission, and/or can allow the fax transmission to be received and recorded. At step 1309, the communication device 20, or the CPU 20A, can also record and store any information relating to the incoming fax/telephone number and/or the incoming fax transmission. At step 1309, the central processing computer 10, or the CPU 10A, can generate a screened fax transmission report and can store information relating to the incoming fax/telephone number, the incoming fax transmission, any content, document(s), or message(s) included in the fax transmission, as well as any other information recorded and stored at step 1309, in the screened fax transmission report. At step 1309, the central processing computer 10, or the CPU 10A, can also generate a screened fax transmission report notification message or alert message which can, but need not, contain information, a link, or a hyperlink, to the screened fax transmission report, and/or can transmit same, as an e-mail message and/or as an attachment(s) to an e-mail message, as a text message, or in or as any other communication transmission, to any communication device 20 used by or associated with the user, individual, or account holder.

At step 1309, the user, individual, or account holder, can thereafter, access the screened fax transmission report notification message or alert message using or via the communication device and view the information or document(s) or message(s) contained in or attached to the screened fax transmission report notification message or alert message, the screened fax transmission report, and/or any document(s) or message(s) contained in the screened fax transmission report. At step 1309, the user, individual, or account holder, can also review the incoming fax/telephone number(s) contained in the screened fax transmission report and, for each incoming fax/telephone number contained in the screened fax transmission report, can, using or via the communication device 20, select or designate same to be either an allowed fax/telephone number or an accepted fax/telephone number to be added to the allowed fax/telephone number(s) list or the accepted fax/telephone number(s) list for future apparatus 100 use, or can, using or via the communication device 20, select or designate same to be a rejected fax/telephone number to be added to the rejected fax/telephone number(s) list for future apparatus 100 use, or can simply ignore and/or delete the information regarding the incoming fax transmission.

At step 1309, any information entered into the communication device 20 regarding any selections or designations made by the user, individual, or account holder, can be stored in the communication device and can be transmitted to the central processing computer 10 and can be stored in the database 10H of same. Thereafter, at step 1309, the central processing computer 10, or the CPU 10A, can store any and/or all data and/or information regarding the use or operation of the apparatus 100. Thereafter, the operation of the apparatus 100 will cease at step 1306.

In another preferred embodiment, at step 1309, the central processing computer 10, or the CPU 10A, can generate a report containing the allowed fax/telephone number(s) list, or the accepted fax/telephone number(s) list, or the rejected fax/telephone number(s) list, and can transmit same to any other central processing computer 10, to any communication device 20 associated with the user, the individual, or the account holder, and/or to any respective telephone service provider computer(s) 30, cellular/wireless service provider computer(s) 40, e-mail service provider computer(s) 50, or cable/satellite service provider computer(s) 60, which services the user's, the individual's, or the account holder's, account, or to a respective governmental agency computer(s) 70, for storage at or in same and/or for later use by same.

In another preferred embodiment, the central processing computer 10, or the CPU 10A, can also, at step 1309, for any and/or each incoming fax/telephone number contained in the screened fax transmission report, generate a Do Not Fax complaint reporting form or report, containing information regarding the respective incoming fax transmission, the fax/telephone number from which the fax transmission was sent or transmitted, the date and time of same, and information reporting same as a violation of any Do Not Fax List law or regulation, and can transmit same to the appropriate governmental agency computer 70 so as to report the Do Not Fax List violation, and/or can transmit same to any other central processing computer(s) 10, to any communication device 20 associated with the user, the individual, or the account holder, and/or to any respective telephone service provider computer(s) 30, cellular/wireless service provider computer(s) 40, e-mail service provider computer(s) 50, or cable/satellite service provider computer(s) 60, for storage at or in same and/or for later use by same. In this regard, the apparatus 100 and/or the central processing computer 10 can automatically report Do Not Fax List violations and/or violators to the appropriate governmental agency or agencies, and/or to the operators of any other of the herein-described central processing computer(s) 10, and/or to any respective telephone service provider computer(s) 30, cellular/wireless service provider computer(s) 40, e-mail service provider computer(s) 50, or cable/satellite service provider computer(s) 60.

Although the preferred embodiment of FIGS. 13A and 13B is described as being utilized in connection with, or as being performed with or by, the central processing computer 10, in order to control, monitor, screen, identify, reject, or report, or prevent the receipt of, unwanted fax transmissions, the preferred embodiment of FIGS. 13A and 13B can also be utilized in a same, a similar, or an analogous, manner, in connection with, or as being performed with or by, any telephone service provider computer(s) 30, cellular/wireless service provider computer(s) 40, e-mail service provider computer(s) 50, or cable/satellite service provider computer(s) 60, described herein in order to control, monitor, screen, identify, reject, or report, or prevent the receipt of, unwanted fax transmissions.

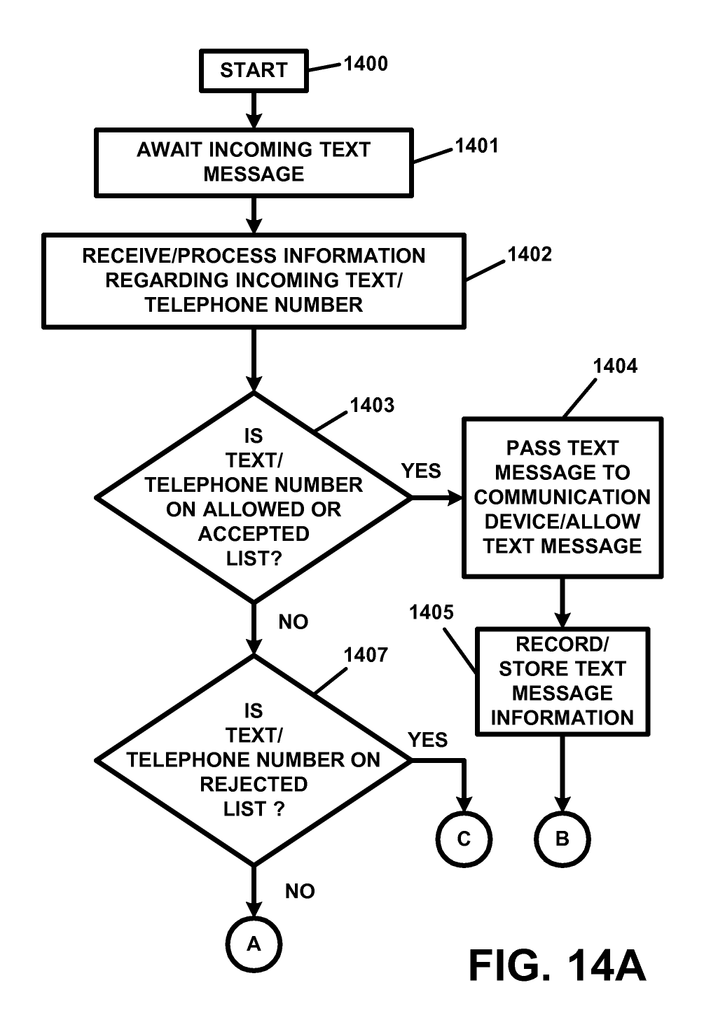

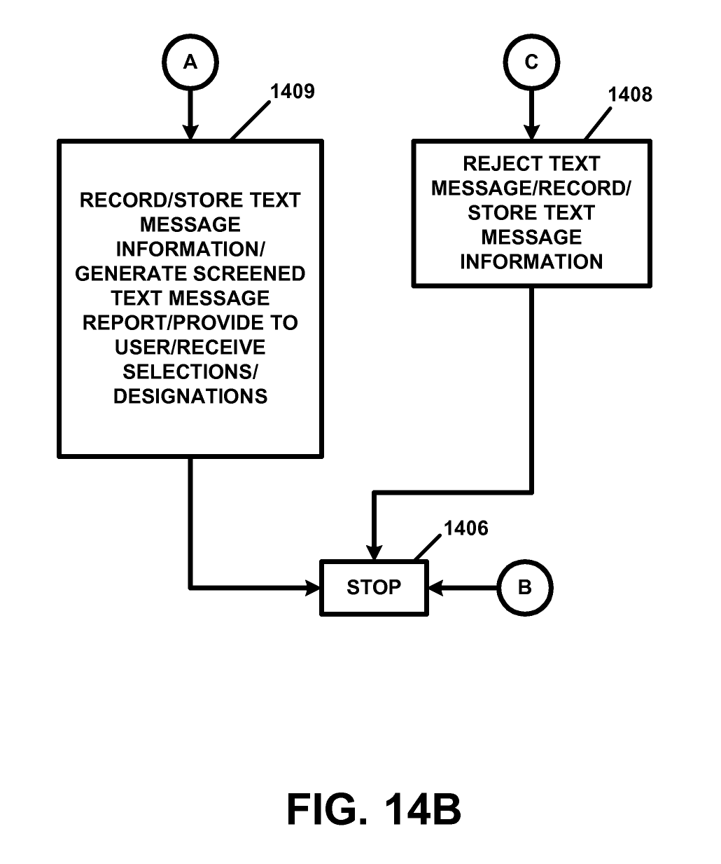

In another preferred embodiment, the apparatus 100 and method of the present invention can be utilized to provide, or can be, a central processing computer 10, or any respective telephone service provider computer(s) 30, cellular/wireless service provider computer(s) 40, e-mail service provider computer(s) 50, or cable/satellite service provider computer(s) 60, which can screen, identify, reject, and/or report, FIGS. 14A and 14B illustrates a preferred embodiment method for utilizing the apparatus 100 of the present invention, in flow diagram form, in connection with a central processing computer 10, or any respective telephone service provider computer(s) 30, cellular/wireless service provider computer(s) 40, e-mail service provider computer(s) 50, or cable/satellite service provider computer(s) 60, which can be programmed to screen, identify, reject, and/or report, unwanted text messages.

Although a central processing computer 10 is described as being utilized in the preferred embodiment of FIGS. 14A and 14B, it is important to note that any respective telephone service provider computer(s) 30, cellular/wireless service provider computer(s) 40, e-mail service provider computer(s) 50, or cable/satellite service provider computer(s) 60, can be utilized in a same, a similar, or an analogous, manner, in order to perform the same functions and/or functionality, described herein as being performed by the central processing computer 10 in the embodiment of FIGS. 14A and 14B. In this regard, any respective telephone service provider computer(s) 30, cellular/wireless service provider computer(s) 40, e-mail service provider computer(s) 50, or cable/satellite service provider computer(s) 60, can perform any and/or all of the functions and/or functionality described as being performed by the central processing computer 10 in the embodiment of FIGS. 14A and 14B.

Although the apparatus 100 of the preferred embodiment of FIGS. 14A and 14B is described as being used for screening, identifying, rejecting, and/or reporting, unwanted text messages, it is important to note that the apparatus 100 of the preferred embodiment of FIGS. 14A and 14B can also be utilized in a same, a similar, and/or an analogous, manner to screen, identify, reject, and/or report, unwanted SMS messages, or unwanted MMS messages, or any other unwanted messages or messaging data and/or information.

In a preferred embodiment, the central processing computer 10, or any respective telephone service provider computer(s) 30, cellular/wireless service provider computer(s) 40, e-mail service provider computer(s) 50, or cable/satellite service provider computer(s) 60, can be pre-programmed by the user, individual, or account holder, or any authorized person, with the telephone number(s) or cellular telephone number(s) (hereinafter “telephone number(s)”) from which text messages can be received by a cellular telephone or any other communication device 20, described herein or otherwise, (the “allowed text/telephone number(s)” or the “accepted text/telephone number(s)”). In this regard, the user, individual, or account holder, can create an allowed text/telephone number(s) list or an accepted text/telephone number(s) list.

In a preferred embodiment, the central processing computer 10, or any respective telephone service provider computer(s) 30, cellular/wireless service provider computer(s) 40, e-mail service provider computer(s) 50, or cable/satellite service provider computer(s) 60, can also be pre-programmed by the user, individual, or account holder, or other authorized person, with the text/telephone number(s) from which text messages are to be, or should be, rejected by the cellular telephone or other communication device 20 (the “rejected text/telephone number(s)”). In this regard, the user, individual or account holder, can create a rejected text telephone number(s) list.

In a preferred embodiment, the user, individual, or account holder, can also pre-program the central processing computer 10, or any respective telephone service provider computer(s) 30, cellular/wireless service provider computer(s) 40, e-mail service provider computer(s) 50, or cable/satellite service provider computer(s) 60, to reject text messages from text/telephone numbers which have not been identified as being allowed text/telephone number(s) or accepted text/telephone number(s), or to reject text messages from rejected text/telephone numbers, or to reject text messages from unknown or unaccepted text/telephone numbers, or from unknown text/telephone numbers, from unidentifiable text/telephone numbers, from private text/telephone numbers or private number text/telephone numbers, or from concealed, hidden, or disguised, text/telephone numbers. In a preferred embodiment, the central processing computer 10, or any respective telephone service provider computer(s) 30, cellular/wireless service provider computer(s) 40, e-mail service provider computer(s) 50, or cable/satellite service provider computer(s) 60, can also be programmed to receive, screen, and/or record, text messages and any associated pictures, video clips, or audio clips, from certain text/telephone numbers, which have not yet been designated or identified as being allowed, accepted, or rejected, prior to transmitting, or passing along, the text message to the cellular telephone or communication device 20, so as to not disturb the user, individual, or account holder, or other persons.

In a preferred embodiment, the central processing computer 10, or any respective telephone service provider computer(s) 30, cellular/wireless service provider computer(s) 40, e-mail service provider computer(s) 50, or cable/satellite service provider computer(s) 60, can also be programmed to generate a screened text message report which can provide the user, individual, or account holder, with any text messages, and/or any pictures, video clips, or audio clips associated therewith, recorded or stored by the central processing computer 10, or any respective telephone service provider computer(s) 30, cellular/wireless service provider computer(s) 40, e-mail service provider computer(s) 50, or cable/satellite service provider computer(s) 60, at the user's, individual's, or account holder's, convenience or at any other time.

The user, individual, or account holder, or other authorized person, can also program the central processing computer 10, or any respective telephone service provider computer(s) 30, cellular/wireless service provider computer(s) 40, e-mail service provider computer(s) 50, or cable/satellite service provider computer(s) 60, with, or record, a reply text message informing the texting individual or party that the reply text message is a text message screening message and of the user's, individual's, or account holder's, desire to only receive text messages from certain allowed or accepted text/telephone numbers or from certain allowed or accepted texting individuals or parties. The user, individual, or account holder, or other authorized person can also program the central processing computer 10, or any respective telephone service provider computer(s) 30, cellular/wireless service provider computer(s) 40, e-mail service provider computer(s) 50, or cable/satellite service provider computer(s) 60, so that the screened text message report can be provided to the user, individual, or account holder, at any desired, and/or pre-selected, and/or pre-specified, time interval(s), or daily, weekly, or monthly, or when a pre-selected number of text messages have been received or recorded by the central processing computer 10, or any respective telephone service provider computer(s) 30, cellular/wireless service provider computer(s) 40, e-mail service provider computer(s) 50, or cable/satellite service provider computer(s) 60.

In a preferred embodiment, the central processing computer 10, or any respective telephone service provider computer(s) 30, cellular/wireless service provider computer(s) 40, e-mail service provider computer(s) 50, or cable/satellite service provider computer(s) 60, can also be pre-programmed to generate a screened text message report notification message or alert message which can, but need not, contain information, a link, or a hyperlink, to the screened text message report, and can transmit same to any communication device 20 used by or associated with the user, individual, or account holder. In a preferred embodiment, the user, individual, or account holder, can, upon or when reviewing the text messages, utilize the communication device 20 in order to select to add any text/telephone number associated with any text message to the allowed text/telephone number(s) list or the accepted text/telephone number(s) list or can select to add any telephone number associated with any text message to the rejected text/telephone number(s) list. In this regard, the user, individual, or account holder, can utilize the communication device 20 in order to select or designate certain of the text/telephone numbers from which text messages are received and/or recorded which can or should be accepted or rejected in the future, or the user, individual, or account holder, can revise, on the fly, and/or while reviewing the screened text message report, the list of allowed text/telephone numbers or accepted text/telephone numbers, or the list of rejected text/telephone numbers, from and via the screened text message report.

In a preferred embodiment, the central processing computer 10, or any respective telephone service provider computer(s) 30, cellular/wireless service provider computer(s) 40, e-mail service provider computer(s) 50, or cable/satellite service provider computer(s) 60, can also be programmed to provide, or to generate and/or transmit a message containing, a list of allowed or accepted text/telephone numbers and/or a list of rejected text/telephone numbers to any or any other central processing computer 10, or to any communication device(s) 20 of the user, individual, or account holder, and/or to any other telephone service provider computer(s) 30, cellular/wireless service provider computer(s) 40, e-mail service provider computer(s) 50, or cable/satellite service provider computer(s) 60, or governmental agency computer(s) 70. The central processing computer 10, or any respective telephone service provider computer(s) 30, cellular/wireless service provider computer(s) 40, e-mail service provider computer(s) 50, or cable/satellite service provider computer(s) 60, can also be programmed to generate a complaint message containing information for reporting a Do Not Text List violation by a texting individual or party and to transmit same to any central processing computer 10, and/or to any respective telephone service provider computer(s) 30, cellular/wireless service provider computer(s) 40, e-mail service provider computer(s) 50, or cable/satellite service provider computer(s) 60, or governmental agency computer(s) 70.

With reference to FIGS. 14A and 14B, the operation of the apparatus 100 commences at step 1400. At step 1401, the central processing computer 10, or the CPU 10A, will await the receiving of an incoming text message. At step 1402, the central processing computer 10, or the CPU 10A, will receive the incoming text message prior to the incoming e-mail message being transmitted to and received by the communication device 20, and will receive and process information regarding the text/telephone number associated with same so as to identify or ascertain the incoming text/telephone number of the incoming text message. In a preferred embodiment, at step 1402, the central processing computer 10, or the CPU 10A, will process information regarding the incoming text message prior to the communication device 20 receiving same and starting to make any sound and/or providing any other indication signifying receipt of the incoming text message. At step 1403, the central processing computer 10, or the CPU 10A, can ascertain whether or not the text/telephone number associated with the incoming text message is an allowed text/telephone number or an accepted text/telephone number by comparing the incoming text/telephone number with or against the list of text/telephone numbers on the allowed text/telephone number(s) list or on the accepted text/telephone number(s) list.

If, at step 1403, the central processing computer 10, or the CPU 10A, determines that the incoming text/telephone number is on the allowed text/telephone number(s) list or on the accepted text/telephone number(s) list, then the operation of the apparatus 100 will proceed to step 1404 and the central processing computer will transmit, or pass along, the incoming text message to the communication device 20 which will commence making a sound and/or vibrating in order to allow for the signaling of the incoming text message.

At step 1404, the user, individual, or account holder, or any other person, can then retrieve and review the text message. After the text message has been read or reviewed, or has not been read or reviewed, then the operation of the apparatus 100 will proceed to step 1405 and information regarding the time and date of the incoming text message, and/or the incoming text/telephone number, and/or any picture(s), video clip(s), or audio clip(s) which was included in or with, or which accompanied, the text message, can be recorded and stored by the central processing computer 10, or the CPU 10A, in the database 10H, and/or the time and date of the incoming text message and the incoming text/telephone number can be added to and stored in a missed text message list which can be provided to the user, individual, or account holder, or any other person, at any time until cleared or reset by the user, individual, or account holder, or other person. At step 1405, any other data and/or information regarding the incoming text message, the incoming text/telephone number, and/or any other information regarding the incoming text messaging event, can be stored by the central processing computer 10, or the CPU 10A, in the database 10H. Thereafter, the operation of the apparatus 100 will cease at step 1406.

If, at step 1403, the central processing computer 10, or the CPU 10A, determines that the incoming text/telephone number is not on the allowed text/telephone number(s) list or not on the accepted text/telephone number(s) list, then the operation of the apparatus 100 will proceed to step 1407. At step 1407, the central processing computer 10, or the CPU 10A, can ascertain whether or not the incoming text/telephone number is a rejected text/telephone number by comparing the incoming text/telephone number with or against the list of text/telephone numbers on the rejected text/telephone number(s) list. At step 1407, the central processing computer 10, or the CPU 10A, can also, if so programmed, ascertain whether or not the incoming text/telephone number is an unknown text/telephone number, an unidentifiable text/telephone number, a private text/telephone number or private number text/telephone number, or a concealed, hidden, or disguised, text/telephone number, and can reject the incoming text message.

If, at step 1407, the central processing computer 10, or the CPU 10A, determines that the incoming text/telephone number is on the rejected text/telephone number(s) list, or that the incoming text message is sent from an unknown text/telephone number, an unidentifiable text/telephone number, a private text/telephone number or private number text/telephone number, or a concealed, hidden, or disguised, text/telephone number, which should be rejected, then the operation of the apparatus 100 will proceed to step 1408 and the central processing computer 10 will reject the incoming text message without transmitting, or passing along, same to the communication device 20. In this regard, in a preferred embodiment, the apparatus 100 serves to not disturb the user, individual, or account holder, or any other person, with any sounds or vibrations or other noise which would otherwise be associated with a rejected text message.

Thereafter, the operation of the apparatus 100 will proceed to step 1408, and any information regarding the time and date of the rejected incoming text message and the rejected incoming text/telephone number, can be recorded and stored by the central processing computer 10, or the CPU 10A, in the database 10H, and/or the time and date of the rejected incoming text message and the rejected incoming text/telephone number can be added to and stored in a missed text message list which can be provided to the user, individual, or account holder, or any other person, at any time until cleared or reset by the user, individual, or account holder, or other person. At step 1408, any other data and/or information regarding the rejected incoming text message, the rejected incoming text/telephone number, and/or any other information regarding the rejected incoming text messaging event, can be stored by the central processing computer 10, or the CPU 10A, in the database 10H. At step 1408, if applicable, any other data and/or information regarding the unknown text/telephone number, the unidentifiable text/telephone number, the private text/telephone number or private number text/telephone number, or the concealed, hidden, or disguised, text/telephone number can also be stored by the central processing computer 10, or the CPU 10A, in the database 10H. Thereafter, the operation of the apparatus 100 will cease at step 1406.

If, at step 1407, the central processing computer 10, or the CPU 10A, determines that the incoming text telephone number is not on the rejected text/telephone number(s) list, then the operation of the apparatus 100 will proceed to step 1409. At step 1409, the central processing computer 10, or the CPU 10A, will record and store the incoming text/telephone number, the time and date of same, the content of the incoming text message, any picture(s), video clip(s), or audio clip(s) included in or with the text message, and/or can allow the texting individual or party to record a message, a voice message, a voicemail message, an answering service message, an answering machine message, or voice message or a video and/or audio message, for the user, individual, or account holder, or other person, and/or can store information relating to the incoming text/telephone number or the incoming text message. At step 1409, the central processing computer 10, or the CPU 10A, can generate a screened text message report and/or can store information relating to the incoming text/telephone number, any information regarding same, and/or the incoming text message, or any other information contained in or with the incoming text message, as well as any other information recorded and stored at step 1409, in the screened text message report.

At step 1409, the central processing computer 10, or the CPU 10A, can also generate a screened text message report notification message or alert message which can, but need not, contain information, a link, or a hyperlink, to the screened text message report, and/or can transmit same, as an e-mail message and/or as an attachment(s) to an e-mail message, as a text message, or as an audio message, or in or as any other communication transmission, to any communication device 20 used by or associated with the user, individual, or account holder. At step 1409, the user, individual, or account holder, can thereafter, access the screened text message report notification message or alert message using or via the communication device 20 and can review the information, picture(s), video clip(s), or audio clip(s), or recordings, contained in or attached to the screened text message report notification message or alert message, the screened text message report, and/or any messages, voice messages, voicemail messages, answering service messages, answering machine messages, or video and/or audio messages, contained in the screened text message report.

At step 1409, the user, individual, or account holder, can also review the incoming text/telephone number(s) contained in the screened text message report and, for each incoming text/telephone number contained in the screened text message report, can using or via the communication device 20, select or designate same to be either an allowed text/telephone number or an accepted text/telephone number to be added to the allowed text/telephone number(s) list or the accepted text/telephone number(s) list for future apparatus 100 use, or can, using or via the communication device 20, select or designate same to be a rejected text/telephone number to be added to the rejected text/telephone number(s) list for future apparatus 100 use, or can simply ignore and/or delete the information regarding the incoming text message.

At step 1409, any information entered into the communication device 20 regarding any selections or designations made by the user, individual, or account holder, can be stored in the communication device and can be transmitted to the central processing computer 10 and can be stored in the database 10H of same. Thereafter, at step 1409, the central processing computer 10, or the CPU 10A, can store any and/or all data and/or information regarding the use or operation of the apparatus 100. Thereafter, the operation of the apparatus 100 will cease at step 1406.

In another preferred embodiment, at step 1409, the central processing computer 10, or the CPU 10A, can generate a report containing the allowed text/telephone number(s) list, or the accepted text/telephone number(s) list, or the rejected text/telephone number(s) list, and can transmit same to any other central processing computer 10, to any communication device 20 associated with the user, the individual, or the account holder, and/or to any respective telephone service provider computer(s) 30, cellular/wireless service provider computer(s) 40, e-mail service provider computer(s) 50, or cable/satellite service provider computer(s) 60, which services the user's, the individual's, or the account holder's, account, or to a respective governmental agency computer(s) 70, for storage at or in same and/or for later use by same.

In another preferred embodiment, the central processing computer 10, or the CPU 10A, can also, at step 1409, for any and/or each incoming text/telephone number contained in the screened text message report, generate a Do Not Text complaint reporting form or report, containing information regarding the respective incoming text message, the text/telephone number from which the text message was sent or transmitted, the date and time of same, and/or information reporting same as a violation of any Do Not Text List law or regulation, and can transmit same to the appropriate governmental agency computer 70 so as to report the Do Not Text List violation, and/or can transmit same to any other central processing computer(s) 10, to any communication device 20 associated with the user, the individual, or the account holder, and/or to any respective telephone service provider computer(s) 30, cellular/wireless service provider computer(s) 40, e-mail service provider computer(s) 50, or cable/satellite service provider computer(s) 60, for storage at or in same and/or for later use by same. In this regard, the apparatus 100 and/or the central processing computer 10 can automatically report Do Not Text List violations and/or violators to the appropriate governmental agency or agencies, and/or to the operators of any of the herein-described central processing computer(s) 10, and/or to any respective telephone service provider computer(s) 30, cellular/wireless service provider computer(s) 40, e-mail service provider computer(s) 50, or cable/satellite service provider computer(s) 60.

Although the preferred embodiment of FIGS. 14A and 14B is described as being utilized in connection with, or as being performed with or by, the central processing computer 10, in order to control, monitor, screen, identify, reject, or report, or prevent the receipt of, unwanted text messages, the preferred embodiment of FIGS. 14A and 14B can also be utilized in a same, a similar, or an analogous, manner, in connection with, or as being performed with or by, any telephone service provider computer(s) 30, cellular/wireless service provider computer(s) 40, e-mail service provider computer(s) 50, or cable/satellite service provider computer(s) 60, described herein in order to control, monitor, screen, identify, reject, or report, or prevent the receipt of, unwanted text messages.

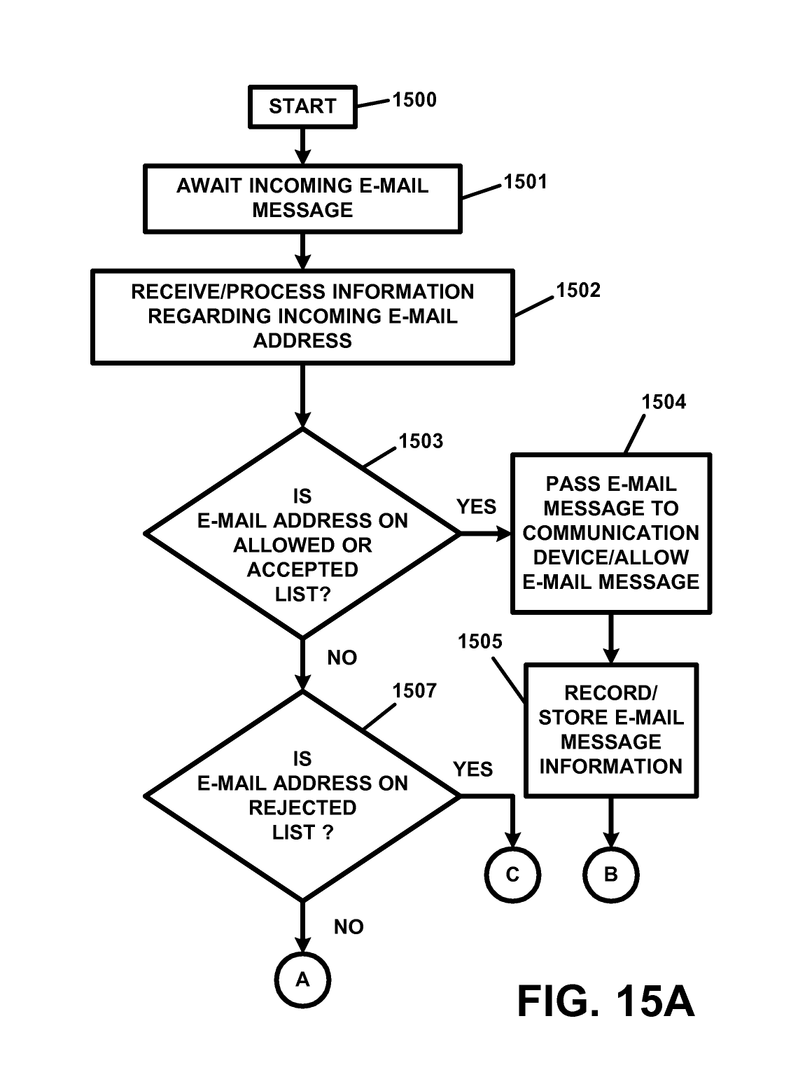

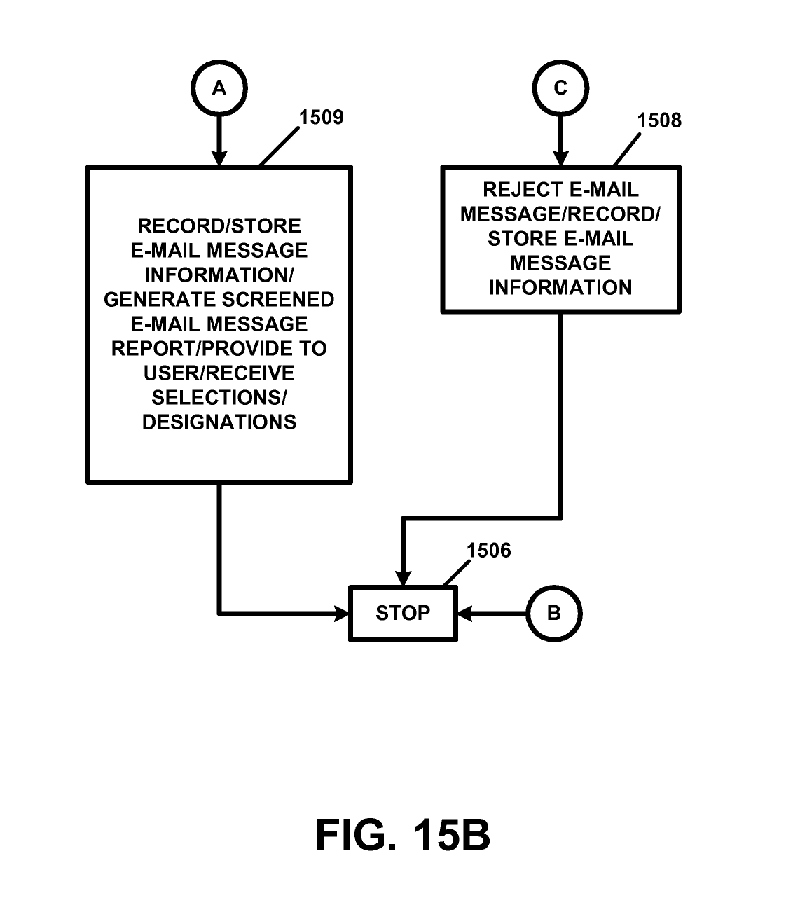

In another preferred embodiment, the apparatus 100 and method of the present invention can be utilized to provide, or can be, a central processing computer 10, or any respective telephone service provider computer(s) 30, cellular/wireless service provider computer(s) 40, e-mail service provider computer(s) 50, or cable/satellite service provider computer(s) 60, which can screen, identify, reject, and/or report, unwanted e-mail messages. FIGS. 15A and 15B illustrates a preferred embodiment method for utilizing the apparatus 100 of the present invention, in flow diagram form, in connection with a central processing computer 10, or any respective telephone service provider computer(s) 30, cellular/wireless service provider computer(s) 40, e-mail service provider computer(s) 50, or cable/satellite service provider computer(s) 60, which can be programmed to screen, identify, reject, and/or report, unwanted e-mail messages.

Although a central processing computer 10 is described as being utilized in the preferred embodiment of FIGS. 15A and 15B, it is important to note that any respective telephone service provider computer(s) 30, cellular/wireless service provider computer(s) 40, e-mail service provider computer(s) 50, or cable/satellite service provider computer(s) 60, can be utilized in a same, a similar, or an analogous, manner, in order to perform the same functions and/or functionality, described herein as being performed by the central processing computer 10 in the embodiment of FIGS. 15A and 15B. In this regard, any respective telephone service provider computer(s) 30, cellular/wireless service provider computer(s) 40, e-mail service provider computer(s) 50, or cable/satellite service provider computer(s) 60, can perform any and/or all of the functions and/or functionality described as being performed by the central processing computer 10 in the embodiment of FIGS. 15A and 15B.

Although the apparatus 100 of the preferred embodiment of FIGS. 15A and 15B is described as being used for screening, identifying, rejecting, and/or reporting, unwanted e-mail messages, it is important to note that the apparatus 100 of the preferred embodiment of FIGS. 15A and 15B can also be utilized in a same, a similar, and/or an analogous, manner to screen, identify, reject, and/or report, unwanted instant messages or any other unwanted communications which are, or can be, transmitted from any IP address.

In a preferred embodiment, the central processing computer 10, or any respective telephone service provider computer(s) 30, cellular/wireless service provider computer(s) 40, e-mail service provider computer(s) 50, or cable/satellite service provider computer(s) 60, can be pre-programmed by the user, individual, or account holder, or any authorized person, with the e-mail addresses from which e-mail messages can be received by the personal computer or communication device 20 of the user, the individual, or the account holder (the “allowed e-mail address(es)” or the “accepted e-mail address(es)”. In this regard, the user, individual, or account holder, or other authorized person, can create an allowed e-mail address(es) list or an accepted e-mail address(es) list. In a preferred embodiment, the central processing computer 10, or any respective telephone service provider computer(s) 30, cellular/wireless service provider computer(s) 40, e-mail service provider computer(s) 50, or cable/satellite service provider computer(s) 60, can also be pre-programmed by the user, individual, or account holder, or other authorized person, with the e-mail address(es) from which e-mail messages are to be, or should be, rejected by the personal computer (the “rejected e-mail address(es)”). In this regard, the user, individual or account holder, can create a rejected e-mail address(es) list.

In a preferred embodiment, the user, individual, or account holder, or other authorized person, can also pre-program the central processing computer 10, or any respective telephone service provider computer(s) 30, cellular/wireless service provider computer(s) 40, e-mail service provider computer(s) 50, or cable/satellite service provider computer(s) 60, to reject e-mail messages from e-mail addresses which have not been identified as being allowed e-mail addresses or accepted e-mail addresses, or to reject e-mail messages from rejected e-mail addresses, or to reject e-mail messages from unknown or unaccepted e-mail addresses, or from unknown e-mail addresses, from unidentifiable e-mail addresses, from private e-mail addresses, or from concealed, hidden, or disguised, e-mail addresses.

In a preferred embodiment, the central processing computer 10, or any respective telephone service provider computer(s) 30, cellular/wireless service provider computer(s) 40, e-mail service provider computer(s) 50, or cable/satellite service provider computer(s) 60, can also be programmed to receive, screen, and/or record, e-mail messages and any associated or attached documents, pictures, video clips, or audio clips, from certain e-mail addresses, which have not yet been designated or identified as being allowed, accepted, or rejected, prior to transmitting, or passing along, the e-mail message to the communication device 20 (or the personal computer), so as to not disturb the user, individual, or account holder, or other persons.

In a preferred embodiment, the central processing computer 10, or any respective telephone service provider computer(s) 30, cellular/wireless service provider computer(s) 40, e-mail service provider computer(s) 50, or cable/satellite service provider computer(s) 60, can also be programmed to generate a screened e-mail message report which can provide the user, individual, or account holder, with any e-mail messages, and/or any documents, pictures, video clips, or audio clips, attached thereto or associated therewith, at the user's, individual's, or account holder's, convenience or at any other time.

The user, individual, or account holder, can also program the central processing computer 10, or any respective telephone service provider computer(s) 30, cellular/wireless service provider computer(s) 40, e-mail service provider computer(s) 50, or cable/satellite service provider computer(s) 60, with, or record, a reply e-mail message informing the e-mail sending individual or party that the reply e-mail message is an e-mail message screening message and of the user's, individual's, or account holder's, desire to only receive e-mail messages from certain allowed or accepted e-mail addresses or from certain e-mailing individuals or parties. The user, individual, or account holder, can also program the central processing computer 10, or any respective telephone service provider computer(s) 30, cellular/wireless service provider computer(s) 40, e-mail service provider computer(s) 50, or cable/satellite service provider computer(s) 60, so that the screened e-mail message report can be provided to the user, individual, or account holder, at any desired, and/or pre-selected, and/or pre-specified, time interval(s), or daily, weekly, or monthly, or when a pre-selected number of e-mail messages have been received or recorded by the central processing computer 10, or any respective telephone service provider computer(s) 30, cellular/wireless service provider computer(s) 40, e-mail service provider computer(s) 50, or cable/satellite service provider computer(s) 60.

In a preferred embodiment, the central processing computer 10, or any respective telephone service provider computer(s) 30, cellular/wireless service provider computer(s) 40, e-mail service provider computer(s) 50, or cable/satellite service provider computer(s) 60, can also be pre-programmed to generate a screened e-mail message report notification message or alert message which can, but need not, contain information, a link, or a hyperlink, to the screened e-mail message report, and can transmit same to any communication device 20 used by or associated with the user, individual, or account holder. In a preferred embodiment, the user, individual, or account holder, can, upon or when reviewing the e-mail messages, utilize the communication device 20 in order to select to add any e-mail address associated with any e-mail message to the allowed e-mail address(es) list or the accepted e-mail address(es) list or can select to add any e-mail address associated with any e-mail message to the rejected e-mail address(es) list. In this regard, the user, individual, or account holder, can utilize the communication device 20 in order to select or designate certain of the e-mail addresses from which e-mail messages are received and/or recorded which can or should be accepted or rejected in the future, or the user, individual, or account holder, can revise, on the fly, and/or while reviewing the screened e-mail message report, the list of allowed e-mail addresses or accepted e-mail addresses, or the list of rejected e-mail addresses, from and via the screened e-mail message report.

In a preferred embodiment, the central processing computer 10, or any respective telephone service provider computer(s) 30, cellular/wireless service provider computer(s) 40, e-mail service provider computer(s) 50, or cable/satellite service provider computer(s) 60, can also be programmed to provide, or to generate and/or transmit a message containing, a list of allowed or accepted e-mail addresses and/or a list of rejected e-mail addresses to any or any other central processing computer 10, or to any communication device(s) 20 of the user, individual, or account holder, and/or to any respective telephone service provider computer(s) 30, cellular/wireless service provider computer(s) 40, e-mail service provider computer(s) 50, or cable/satellite service provider computer(s) 60, or governmental agency computer(s) 70. The central processing computer 10, or any respective telephone service provider computer(s) 30, cellular/wireless service provider computer(s) 40, e-mail service provider computer(s) 50, or cable/satellite service provider computer(s) 60, can also be programmed to generate a complaint message containing information for reporting a Do Not E-Mail List violation by an e-mailing individual or party and to transmit same to any other central processing computer 10, to any communication device 20 associated with the user, individual, or account holder, and/or to any respective telephone service provider computer(s) 30, cellular/wireless service provider computer(s) 40, e-mail service provider computer(s) 50, or cable/satellite service provider computer(s) 60, or governmental agency computer(s) 70.

With reference to FIGS. 15A and 15B, the operation of the apparatus 100 commences at step 1500. At step 1501, the central processing computer 10, or the CPU 10A, will await the receiving of an incoming e-mail message. At step 1502, the central processing computer 10, or the CPU 10A, will receive the incoming e-mail message, for the user, individual, or account holder, prior to the incoming e-mail message being transmitted to and received by the communication device 20, and will receive and process information regarding the e-mail address associated with same so as to identify or ascertain the incoming e-mail address of the incoming e-mail message. In a preferred embodiment, at step 1502, the central processing computer 10, or the CPU 10A, will process information regarding the incoming e-mail message prior to the communication device 20 receiving same and starting to make any sound and/or providing any other e-mail message receipt indication signifying receipt of the incoming e-mail message. At step 1503, the central processing computer 10, or the CPU 10A, can ascertain whether or not the e-mail address associated with the incoming e-mail message is an allowed e-mail address or an accepted e-mail address by comparing the incoming e-mail address with or against the list of e-mail address on the allowed e-mail address(es) list or on the accepted e-mail address(es) list.

If, at step 1503, the central processing computer 10, or the CPU 10A, determines that the incoming e-mail address is on the allowed e-mail address(es) list or on the accepted e-mail address(es) list, then the operation of the apparatus 100 will proceed to step 1504 and the central processing computer 10 will transmit, or pass along, the incoming e-mail message to the communication device 20 which will commence making a sound and/or providing any other indication to allow for the signaling of the incoming e-mail message.

At step 1504, the user, individual, or account holder, or any other person, can then retrieve and review the e-mail message. After the e-mail message has been read or reviewed, or has not been read or reviewed, then the operation of the apparatus 100 will proceed to step 1505 and information regarding the time and date of the incoming e-mail message, and/or the incoming e-mail address, and/or any document(s), picture(s), video clip(s), or audio clip(s), which was included in same, attached to same, or associated with same, or which accompanied, the e-mail message, can be recorded and stored by the central processing computer 10, or the CPU 10A, in the database 10H, and/or the time and date of the incoming e-mail message and the incoming e-mail address can be added to and stored in a missed e-mail message list which can be provided to the user, individual, or account holder, or any other person, at any time until cleared or reset by the user, individual, or account holder, or other person. At step 1505, any other data and/or information regarding the incoming e-mail message, the incoming e-mail address from which it was sent or transmitted, and/or any other information regarding the incoming e-mail messaging event, can be stored by the central processing computer 10, or the CPU 10A, in the database 10H. Thereafter, the operation of the apparatus 100 will cease at step 1506.

If, at step 1503, the central processing computer 10, or the CPU 10A, determines that the incoming e-mail address is not on the allowed e-mail address(es) list or not on the accepted e-mail address(es) list, then the operation of the apparatus 100 will proceed to step 1507. At step 1507, the central processing computer 10, or the CPU 10A, can ascertain whether or not the incoming e-mail address is a rejected e-mail address by comparing the incoming e-mail address with or against the list of e-mail addresses on the rejected e-mail address(es) list. At step 1507, the central processing computer 10, or the CPU 10A, can also, if so programmed, ascertain whether or not the incoming e-mail address is an unknown e-mail address, an unidentifiable e-mail address, a private e-mail address, or a concealed, hidden, or disguised, e-mail address, and can reject the incoming e-mail message.

If, at step 1507, the central processing computer 10, or the CPU 10A, determines that the incoming e-mail address is on the rejected e-mail address(es) list, or that the incoming e-mail message is sent from an unknown e-mail address, an unidentifiable e-mail address, a private e-mail address, or a concealed, hidden, or disguised, e-mail address, which should be rejected, then the operation of the apparatus 100 will proceed to step 1508 and the communication device 20 will reject the incoming e-mail message without transmitting, or passing along, same to the communication device 20. In this regard, in a preferred embodiment, the apparatus 100 serves to not disturb the user, individual, or account holder, or any other person, with any sounds or other indications, visual, audible, or otherwise, which would otherwise be associated with a rejected e-mail message. Thereafter, the operation of the apparatus 100 will proceed to step 1508, and any information regarding the time and date of the rejected incoming e-mail message and the rejected incoming e-mail address, can be recorded and stored by the central processing computer 10, or the CPU 10A, in the database 10H, and/or the time and date of the rejected incoming e-mail message and the rejected incoming e-mail address can be added to and stored in a missed e-mail message list which can be provided to the user, individual, or account holder, or any other person, at any time until cleared or reset by the user, individual, or account holder, or other person.

At step 1508, any other data and/or information regarding the rejected incoming e-mail message, the rejected incoming e-mail address, and/or any other information regarding the rejected incoming e-mail messaging event, can be stored by the central processing computer 10, or the CPU 10A, in the database 10H. At step 1508, if applicable, any other data and/or information regarding the unknown e-mail address, the unidentifiable e-mail address, the private e-mail address, or the concealed, hidden, or disguised, e-mail address, can also be stored by the central processing computer 10, or the CPU 10A, in the database 10H. Thereafter, the operation of the apparatus 100 will cease at step 1506.

If, at step 1507, the central processing computer 10, or the CPU 10A, determines that the incoming e-mail address is not on the rejected e-mail address(es) list, then the operation of the apparatus 100 will proceed to step 1509. At step 1509, the central processing computer 10, or the CPU 10A, will record and store the incoming e-mail address, the time and date of same, the content of the e-mail message, any document(s), picture(s), video clip(s), or audio clip(s), included in, attached to, or associated with, same, or with the e-mail message, and/or can allow the e-mailing individual or party to record a message, a voice message, a voicemail message, an answering service message, an answering machine message, or voice message or a video and/or audio message, for the user, individual, or account holder, or other person, and/or can store information relating to the incoming e-mail address and/or the incoming e-mail message. At step 1509, the central processing computer 10, or the CPU 10A, can generate a screened e-mail message report and/or can store information relating to the incoming e-mail message, the incoming e-mail address, any information regarding same, and/or any document(s), picture(s), video clip(s), or audio clip(s), included in, attached to, or associated with the e-mail message, as well as any other information recorded and stored at step 1509, in the screened e-mail message report.

At step 1509, the central processing computer 10, or the CPU 10A, can also generate a screened e-mail message report notification message or alert message which can, but need not, contain information, a link, or a hyperlink, to the screened e-mail message report, and/or can transmit same, as an e-mail message and/or as an attachment(s) to an e-mail message, as a text message, or as an audio message, or in or as any other communication transmission, to any communication device 20 used by or associated with the user, individual, or account holder. At step 1509, the user, individual, or account holder, can thereafter, access the screened e-mail message report notification message or alert message and review the information, document(s), picture(s), video clip(s), or audio clip(s), or recordings, contained in or attached to the screened e-mail message report notification message or alert message, the screened e-mail message report, and/or any messages, voice messages, voicemail messages, answering service messages, answering machine messages, or video and/or audio messages, contained in the screened e-mail message report.

At step 1509, the user, individual, or account holder, can also review the incoming e-mail addresses contained in the screened e-mail message report and, for each incoming e-mail address contained in the screened e-mail message report, can, using or via the communication device 20, select or designate same to be either an allowed e-mail address or an accepted e-mail address to be added to the allowed e-mail address(es) list or the accepted e-mail address(es) list for future apparatus 100 use, or can, using or via the communication device 20, select or designate same to be a rejected e-mail address to be added to the rejected e-mail address(es) list for future apparatus 100 use, or can simply ignore and/or delete the information regarding the incoming e-mail message.

At step 1509, any information entered into the communication device 20 regarding any selections or designations made by the user, individual, or account holder, can be stored in the communication device and can be transmitted to the central processing computer 10 and can be stored in the database 10H of same. Thereafter, at step 1509, the central processing computer 10, or the CPU 10A, can store any and/or all data and/or information regarding the use or operation of the apparatus 100. Thereafter, the operation of the apparatus 100 will cease at step 1506.

In another preferred embodiment, at step 1509, the central processing computer 10, or the CPU 10A, can generate a report containing the allowed e-mail address(es) list, or the accepted e-mail address(es) list, or the rejected e-mail address(es) list, and can transmit same to any other central processing computer 10, to any communication device 20 associated with the user, the individual, or the account holder, and/or to any respective telephone service provider computer(s) 30, cellular/wireless service provider computer(s) 40, e-mail service provider computer(s) 50, or cable/satellite service provider computer(s) 60, which services the user's, the individual's, or the account holder's, account, or to a respective governmental agency computer(s) 70, for storage at or in same and/or for later use by same.

In another preferred embodiment, the central processing computer 10, or the CPU 10A, can also, at step 1509, for any and/or each incoming e-mail address contained in the screened e-mail message report, generate a Do Not E-Mail complaint reporting form or report, containing information regarding the respective incoming e-mail message, the e-mail address from which the e-mail message was sent or transmitted, the date and time of same, and/or information reporting same as a violation of any Do Not E-Mail List law or regulation, and can transmit same to the appropriate governmental agency computer 70 so as to report the Do Not E-Mail List violation, and/or can transmit same to any other central processing computer(s) 10, to any communication device 20 associated with the user, the individual, or the account holder, and/or to any respective telephone service provider computer(s) 30, cellular/wireless service provider computer(s) 40, e-mail service provider computer(s) 50, or cable/satellite service provider computer(s) 60, for storage at or in same and/or for later use by same. In this regard, the apparatus 100 and/or the central processing computer 10 can automatically report Do Not E-Mail List violations and/or violators to the appropriate governmental agency or agencies, and/or to the operators of any of the herein-described central processing computer(s) 10, and/or to any respective telephone service provider computer(s) 30, cellular/wireless service provider computer(s) 40, e-mail service provider computer(s) 50, or cable/satellite service provider computer(s) 60.

Although the preferred embodiment of FIGS. 15A and 15B is described as being utilized in connection with, or as being performed with or by, the central processing computer 10, in order to control, monitor, screen, identify, reject, or report, or prevent the receipt of, unwanted e-mail messages, the preferred embodiment of FIGS. 15A and 15B can also be utilized in a same, a similar, or an analogous, manner, in connection with, or as being performed with or by, any telephone service provider computer(s) 30, cellular/wireless service provider computer(s) 40, e-mail service provider computer(s) 50, or cable/satellite service provider computer(s) 60, described herein in order to control, monitor, screen, identify, reject, or report, or prevent the receipt of, unwanted e-mail messages.

In any and/or all of the embodiments described herein, and of the various messages, reports, notification messages, or alert messages, or any of the messages or reports described herein as being generated by the apparatus 100 of the present invention, or the central processing computer(s) 10, or any of the telephone service provider computer(s) 30, cellular/wireless service provider computer(s) 40, e-mail service provider computer(s) 50, or cable/satellite service provider computer(s) 60, can contain or include marketing information, marketing materials, or advertisements.

In any and/or all of the embodiments described herein, any user, individual, or account holder, can select or designate any telephone number, cellular telephone number, e-mail address, or IP address, or any other source of any communication, as being an allowed telephone number, cellular telephone number, e-mail address, or IP address, or any other source of any communication, or as being an accepted allowed telephone number, cellular telephone number, e-mail address, or IP address, or any other source of any communication. In any and/or all of the embodiments described herein, any an allowed telephone number, cellular telephone number, e-mail address, or IP address, or any other source of any communication, or any accepted allowed telephone number, cellular telephone number, e-mail address, or IP address, or any other source of any communication can also be of, from, or associated with, an individual, an entity, a company, an advertiser, a marketing entity, any merchant or provider of any goods, products, or services, who or which agrees to pay compensation of any type or kind to the user, the individual, or the account holder, in exchange for the user, individual, or account holder, agreeing to receive any of the herein-described communications, to telephone calls, cellular telephone calls, wireless telephone calls, facsimile (fax) transmissions, text messages, SMS messages, MMS messages, electronic mail (e-mail) messages, instant messages or any other conveyances of data or information, from same. In a preferred embodiment, the compensation can be a cash compensation, a monetary compensation, a credit amount, a debit amount, a coupon, or a discount, or any amount, type, or kind.

In another preferred embodiment, the apparatus 100 and method of the present invention can be utilized as a personal communication screening service or as a personal communication answering or communication receiving service which an perform any of the herein-described functions and functionality, described herein as being provided by the apparatus 100 of the present invention, for any of the herein-described users, individuals, or account holders.

In another preferred embodiment, as well as any and/or all of the embodiments described herein, any of the herein-described communication device(s) 20, central processing computer(s) 10, telephone service provider computer(s) 30, cellular/wireless service provider computer(s) 40, e-mail service provider computer(s) 50, or cable/satellite service provider computer(s) 60, can be programmed and/or adapted to perform any and/or all of the functions and/or functionality described herein as being performed by the central processing computer 10.

In another preferred embodiment, as well as any and/or all of the embodiments described herein, any of the herein-described communication device(s) 20, central processing computer(s) 10, telephone service provider computer(s) 30, cellular/wireless service provider computer(s) 40, e-mail service provider computer(s) 50, or cable/satellite service provider computer(s) 60, which store e-mail messages or which store e-mail In Boxes for any of the herein-described users, individuals, or account holders, can be programmed to automatically delete e-mail messages from e-mail addresses which have been designated as rejected e-mail addresses at pre-selected time intervals or upon the e-mail memory storage usage reaching a pre-selected level.

In any and/or all of the embodiments described herein, any of the herein-described communication devices can be programmed with software programs, software algorithms, software applications, or software “apps”, for enabling the respective communication device to perform any and/or all of the functions or functionality described herein as being performed by the communications devices 20 described herein.

In any and/or all of the embodiments described herein, any of the herein-described central processing computer(s) 10, or any of the telephone service provider computer(s) 30, cellular/wireless service provider computer(s) 40, e-mail service provider computer(s) 50, or cable/satellite service provider computer(s) 60, can be programmed with software programs, software algorithms, software applications, or software “apps”, for enabling the respective central processing computer(s) 10, telephone service provider computer(s) 30, cellular/wireless service provider computer(s) 40, e-mail service provider computer(s) 50, or cable/satellite service provider computer(s) 60, to perform any and/or all of the functions or functionality described herein as being performed by the respective central processing computer(s) 10, telephone service provider computer(s) 30, cellular/wireless service provider computer(s) 40, e-mail service provider computer(s) 50, or cable/satellite service provider computer(s) 60, described herein.

While the present invention has been described and illustrated in various preferred and alternate embodiments, such descriptions are merely illustrative of the present invention and are not to be construed to be limitations thereof. In this regard, the present invention encompasses all modifications, variations, and/or alternate embodiments, with the scope of the present invention being limited only by the claims which follow.

What is claimed is:

1. An apparatus, comprising:
a receiver, wherein the receiver receives information regarding an incoming telephone call, an incoming cellular telephone call, an incoming fax transmission, an incoming text message, or an incoming e-mail message; and
a processing device, wherein the processing device processes the information regarding the incoming telephone call, the incoming cellular telephone call, the incoming fax transmission, the incoming text message, or the incoming e-mail message, wherein the processing device processes information for identifying a telephone number or a cellular telephone number associated with the incoming telephone call, the incoming cellular telephone call, the incoming fax transmission, or the incoming text message, or the processing device processes information for identifying an e-mail address associated with the incoming e-mail message, and further wherein the processing determines whether the telephone number or the cellular telephone number associated with the incoming telephone call, the incoming cellular telephone call, the incoming fax transmission, or the incoming text message, is an allowed telephone number or an allowed cellular telephone number or is a rejected telephone number or a rejected cellular telephone number, or the processing device determines whether the e-mail address is an allowed e-mail address or is a rejected e-mail address;
wherein the apparatus allows the incoming telephone call, the incoming cellular telephone call, the incoming fax transmission, or the incoming text message, if the telephone number or the cellular telephone number is an allowed telephone number or an allowed cellular telephone number, or the apparatus rejects the incoming telephone call, the incoming cellular telephone call, the incoming fax transmission, or the incoming text message, if the telephone number or the cellular telephone number is a rejected telephone number or a rejected cellular telephone number, or the apparatus allows the e-mail message if the e-mail address is an allowed e-mail address, or the apparatus rejects the e-mail message if the e-mail address is a rejected e-mail address, and further wherein the apparatus records or stores information regarding, provided in, or contained in, the incoming telephone call, the incoming cellular telephone call, the incoming fax transmission, or the incoming text message, or the incoming e-mail message.

2. The apparatus of claim 1, wherein the apparatus records information regarding an incoming telephone call, an incoming cellular telephone call, an incoming fax transmission, an incoming text message, or an incoming e-mail message, which is neither allowed nor rejected, and further wherein the apparatus generates a report regarding the incoming telephone call, the incoming cellular telephone call, the incoming fax transmission, the incoming text message, or the incoming e-mail message, and further wherein the apparatus provides the information contained in the report.

3. The apparatus of claim 2, wherein the apparatus processes information regarding a selection or a designation, obtained in response to information contained in the report, of a telephone number, a cellular telephone number, or an e-mail address, as an allowed telephone number, an allowed cellular telephone number, or an allowed e-mail address, or as a rejected telephone number, a rejected cellular telephone number, or a rejected e-mail address, and further wherein the apparatus updates a listing of allowed telephone numbers, a listing of allowed cellular telephone numbers, or a listing of allowed e-mail addresses, or the apparatus updates a listing of rejected telephone numbers, a listing of rejected cellular telephone numbers, or a listing of rejected e-mail addresses.

4. The apparatus of claim 1, further comprising:
a memory device or a database, wherein the memory device or the database contains a listing of allowed telephone numbers, a listing of allowed cellular telephone numbers, a listing of allowed e-mail addresses, a listing of rejected telephone numbers, a listing of rejected cellular telephone numbers, or a listing of rejected e-mail addresses.

5. The apparatus of claim 1, wherein the apparatus is a telephone.

6. The apparatus of claim 1, wherein the apparatus is a cellular telephone.

7. The apparatus of claim 1, wherein the apparatus is a fax machine.

8. The apparatus of claim 1, wherein the apparatus is a personal computer.

9. The apparatus of claim 1, wherein the apparatus is programmed to not make any sound or noise, or provide any visual indication, audible indication, or any other indication, regarding the incoming telephone call, the incoming cellular telephone call, the incoming fax transmission, the incoming text message, or the incoming e-mail message, until the incoming telephone call, the incoming cellular telephone call, the incoming fax transmission, the incoming text message, or the incoming e-mail message, is determined to be allowed.

10. A computer-implemented method, comprising:
receiving, with a receiver, information regarding an incoming telephone call, an incoming cellular telephone call, an incoming fax transmission, an incoming text message, or an incoming e-mail message;
processing, with or using a processing device or a computer, information regarding the incoming telephone call, the incoming cellular telephone call, the incoming fax transmission, the incoming text message, or the incoming e-mail message;
processing, with or using the processing device or the computer, information for identifying the telephone number or the cellular telephone number associated with the incoming telephone call, the incoming cellular telephone call, the incoming fax transmission, or the incoming text message, or processing information for identifying the e-mail address associated with the incoming e-mail message;
determining, with or using the processing device or the computer, whether the telephone number or the cellular telephone number associated with the incoming telephone call, the incoming cellular telephone call, the incoming fax transmission, or the incoming text message, is an allowed telephone number or an allowed cellular telephone number or is a rejected telephone number or a rejected cellular telephone number, or determining whether the e-mail address is an allowed e-mail address or is a rejected e-mail address;
allowing, with or using the processing device or the computer, the incoming telephone call, the incoming cellular telephone call, the incoming fax transmission, or the incoming text message, if the telephone number or the cellular telephone number is an allowed telephone number or an allowed cellular telephone number, rejecting, with or using the processing device or the computer, the incoming telephone call, the incoming cellular telephone call, the incoming fax transmission, or the incoming text message, if the telephone number or the cellular telephone number is a rejected telephone number or a rejected cellular telephone number, allowing, with or using the processing device or the computer, the incoming e-mail message if the e-mail address is an allowed e-mail address or rejecting, with or using the processing device or the computer, the e-mail message if the e-mail address is a rejected e-mail address; and
storing, in a memory device or a database, information regarding, provided in, or contained in, the incoming telephone call, the incoming cellular telephone call, the incoming fax transmission, or the incoming text message, or the incoming e-mail message.

11. An apparatus, comprising:
a receiver, wherein the receiver receives information regarding an incoming telephone call, an incoming cellular telephone call, an incoming fax transmission, an incoming text message, or an incoming e-mail message; and
a processing device, wherein the processing device processes the information regarding the incoming telephone call, the incoming cellular telephone call, the incoming fax transmission, the incoming text message, or the incoming e-mail message, wherein the processing device processes information for identifying a telephone number or a cellular telephone number associated with the incoming telephone call, the incoming cellular telephone call, the incoming fax transmission, or the incoming text message, or the processing device processes information for identifying an e-mail address associated with the incoming e-mail message, and further wherein the processing determines whether the telephone number or the cellular telephone number associated with the incoming telephone call, the incoming cellular telephone call, the incoming fax transmission, or the incoming text message, is an allowed telephone number or an allowed cellular telephone number or is a rejected telephone number or a rejected cellular telephone number, or the processing device determines whether the e-mail address is an allowed e-mail address or is a rejected e-mail address;
wherein the apparatus transmits, or passes along, the incoming telephone call, the incoming cellular telephone call, the incoming fax transmission, or the incoming text message, to a communication device if the telephone number or the cellular telephone number is an allowed telephone number or an allowed cellular telephone number, or the apparatus rejects the incoming telephone call, the incoming cellular telephone call, the incoming fax transmission, or the incoming text message, if the telephone number or the cellular telephone number is a rejected telephone number or a rejected cellular telephone number, or the apparatus transmits, or passes along, the e-mail message to a communication device if the e-mail address is an allowed e-mail address, or the apparatus rejects the e-mail message if the e-mail address is a rejected e-mail address, and further wherein the apparatus records or stores information regarding, provided in, or contained in, the incoming telephone call, the incoming cellular telephone call, the incoming fax transmission, or the incoming text message, or the incoming e-mail message.

12. The apparatus of claim 11, wherein the apparatus records information regarding an incoming telephone call, an incoming cellular telephone call, an incoming fax transmission, an incoming text message, or an incoming e-mail message, which is neither allowed nor rejected, and further wherein the apparatus generates a report regarding the incoming telephone call, the incoming cellular telephone call, the incoming fax transmission, the incoming text message, or the incoming e-mail message, and further wherein the apparatus transmits the report to the communication device or to a second communication device.

13. The apparatus of claim 12, wherein the apparatus receives information, transmitted from the communication device or from the second communication device, regarding a selection or a designation, obtained in response to information contained in the report, of a telephone number, a cellular telephone number, or an e-mail address, as an allowed telephone number, an allowed cellular telephone number, or an allowed e-mail address, or as a rejected telephone number, a rejected cellular telephone number, or a rejected e-mail address, and further wherein the apparatus updates a listing of allowed telephone numbers, a listing of allowed cellular telephone numbers, or a listing of allowed e-mail addresses, or the apparatus updates a listing of rejected telephone numbers, a listing of rejected cellular telephone numbers, or a listing of rejected e-mail addresses.

14. The apparatus of claim 11, further comprising:
a memory device or a database, wherein the memory device or the database contains a listing of allowed telephone numbers, a listing of allowed cellular telephone numbers, a listing of allowed e-mail addresses, a listing of rejected telephone numbers, a listing of rejected cellular telephone numbers, or a listing of rejected e-mail addresses.

15. The apparatus of claim 11, wherein the communication device is a telephone.

16. The apparatus of claim 11, wherein the communication device is a cellular telephone.

17. The apparatus of claim 11, wherein the communication device is a fax machine.

18. The apparatus of claim 11, wherein the communication device is a fax machine.

19. The apparatus of claim 11, wherein the communication device is an interactive television.

20. The apparatus of claim 11, wherein the apparatus is programmed to automatically delete e-mail messages from rejected e-mail addresses.
